(19) United States
(12) Patent Application Publication
(10) Pub. No.: US 2020/0162735 A1
(43) Pub. Date: May 21, 2020

(54) IMAGE PROCESSING APPARATUS AND METHOD

(71) Applicant: SONY SEMICONDUCTOR SOLUTIONS CORPORATION, KANAGAWA (JP)

(72) Inventor: HIROMICHI UENO, KANAGAWA (JP)

(21) Appl. No.: 16/631,921

(22) PCT Filed: Jul. 13, 2018
(86) PCT No.: PCT/JP2018/026428

§ 371 Date: Jan. 17, 2020

(30) Foreign Application Priority Data
Jul. 28, 2017 (JP) 2017-146514

(51) Int. Cl. H04N 19/124; H04N 19/139; H04N 19/20

(52) U.S. Cl. CPC H04N 19/124; H04N 19/20; H04N 19/139

(57) ABSTRACT

The present disclosure relates to image processing apparatus and method that make it possible to suppress a reduction in image quality. An encoding target image is quantized, and an image of a moving object included in the encoding target image is quantized with use of a quantization parameter corresponding to an encoding difficulty level varying by a motion direction of the moving object in the encoding target image, and the quantized encoding target image is encoded to generate a bit stream. The present disclosure is applicable to, for example, an image processing apparatus, an image encoding apparatus, an information processing apparatus, and the like.

### TECHNICAL FIELD

The present disclosure relates to image processing apparatus and method, and specifically, to image processing apparatus and method that make it possible to suppress a reduction in image quality.

### BACKGROUND ART

In existing image encoding using quantization, a quantization parameter (QP) is generally adjusted on the basis of properties (luminance and color information) as a still image. In addition, the quantization parameter (QP) for an image of a moving object is adjusted on the basis of indices indicating magnitude of motion of the moving object and a degree of correlation with a reference image.

For example, there has been proposed a method of improving subjective image quality by performing motion detection on a moving image, dividing a frame image of the moving image into a still portion and a portion where motion is included on the basis of a result of the motion detection, and decreasing a quantization parameter for a portion of higher interest where large motion is included.

Incidentally, in an encoding system, which is frequently used for encoding a moving image, of generating a predicted image with use of motion prediction and encoding a residual image between an encoding target image and the predicted image, a size of the reference image changes in accordance with a direction of motion of a moving object included in an image; therefore, an encoding difficulty level of the image changes in accordance with the direction of motion of the moving object.

### CITATION LIST

### Patent Literature

PTL 1: Japanese Unexamined Patent Application Publication No. 2010-130558

### SUMMARY OF THE INVENTION

### Problems to be Solved by the Invention

However, in quantization described in PTL 1, such a direction of motion of the moving object is not taken into consideration, and a uniform quantization parameter is set for an image of the moving object regardless of the direction of motion of the moving object. Accordingly, subjective image quality of the image may be unnecessarily reduced depending on the direction of motion of the moving object.

The present disclosure has been made in light of such a situation, and makes it possible to suppress a reduction in image quality.

### Means for Solving the Problem

An image processing apparatus according to one aspect of the present technology is an image processing apparatus including: a quantizer that quantizes an encoding target image, and quantizes an image of a moving object included in the encoding target image with use of a quantization parameter corresponding to an encoding difficulty level varying by a motion direction of the moving object in the encoding target image; and an encoding unit that encodes the encoding target image quantized by the quantizer to generate a bit stream.

An image processing method according to one aspect of the present technology is an image processing method including: quantizing an encoding target image, and quantizing an image of a moving object included in the encoding target image with use of a quantization parameter corresponding to an encoding difficulty level varying by a motion direction of the moving object in the encoding target image; and encoding the quantized encoding target image to generate a bit stream.

In the image processing apparatus and method according to the aspects of the present technology, the encoding target image is quantized, the image of the moving object included in the encoding target image is quantized with use of the quantization parameter corresponding to the encoding difficulty level varying by the motion direction of the moving object in the encoding target image, and the quantized encoding target image is encoded to generate a bit stream.

### Effect of the Invention

According to the present disclosure, it is possible to process an image. In particular, it is possible to suppress a reduction in image quality.

### BRIEF DESCRIPTION OF THE DRAWINGS

FIG. 1 is a diagram for describing an example of a difference in encoding difficulty level varying by a motion direction of a moving object.

FIG. 2 is a diagram for describing an example of a difference in encoding difficulty level varying by a direction of a motion vector.

FIG. 3 is a block diagram illustrating a main configuration example of an image processing apparatus.

FIG. 4 is a block diagram illustrating a main configuration example of an image encoding unit.

FIG. 5 is a block diagram illustrating a main configuration example of an inter-predicting unit.

FIG. 6 is a flow chart for describing an example of a flow of image processing.

FIG. 7 is a flow chart for describing an example of a flow of image encoding processing.

FIG. 8 is a flow chart for describing an example of a flow of inter-prediction processing.

FIG. 9 is a flow chart for describing an example of a flow of quantization control processing.

FIG. 10 is a diagram illustrating an example of motion detection of a moving object.

FIG. 11 is a block diagram illustrating a main configuration example of an image processing apparatus.

FIG. 12 is a block diagram illustrating a main configuration example of a moving object motion direction detector.

FIG. 13 is a block diagram illustrating a main configuration example of an image encoding unit.

FIG. 14 is a flow chart for describing an example of a flow of image processing.

FIG. 15 is a flow chart for describing an example of a flow of motion direction detection processing.

FIG. 16 is a flow chart for describing an example of image encoding processing.

FIG. 17 is a flow chart for describing an example of a flow of quantization control processing.

FIG. 18 is a block diagram illustrating a main configuration example of an image processing apparatus.

FIG. 19 is a block diagram illustrating a main configuration example of an image processing apparatus.

FIG. 20 is a block diagram illustrating an example of a schematic configuration of a television apparatus.

FIG. 21 is a block diagram illustrating an example of a schematic configuration of a mobile phone.

FIG. 22 is a block diagram illustrating an example of a schematic configuration of a recording/reproducing apparatus.

FIG. 23 is a block diagram illustrating an example of a schematic configuration of an imaging apparatus.

FIG. 24 is a block diagram illustrating an example of a schematic configuration of a video set.

FIG. 25 is a schematic diagram illustrating a schematic configuration of a video processor.

FIG. 26 is a block diagram illustrating another example of the schematic configuration of the video processor.

FIG. 27 is a block diagram illustrating an example of a schematic configuration of a network system.

FIG. 28 is a block diagram illustrating a main configuration example of a computer.

### MODES FOR CARRYING OUT THE INVENTION

In the following, some modes for carrying out the present disclosure (hereinafter referred to as embodiments) are described with reference to the drawings. It is to be noted that description is given in the following order.

1. Control of Quantization

2. First Embodiment (quantization control in accordance with a direction of a motion vector)

3. Second Embodiment (image analysis for detection of a motion direction of a moving object)

4. Third Embodiment (configuration for detection of a motion direction of a moving object)

5. Fourth Embodiment (application examples of the present technology)

6. Others

### 1. Control of Quantization

### <Change in Coding Difficulty Level Varying by Motion Direction>

In existing image encoding using quantization, a quantization parameter (QP) is generally adjusted on the basis of properties (luminance and color information) as a still image. In addition, the quantization parameter (QP) for an image of a moving object is adjusted on the basis of indices indicating magnitude of motion of the moving object and a degree of correlation with a reference image.

For example, in a moving image, generally, a portion where motion is included is of higher interest than a portion where no motion is included. Accordingly, there has been devised a method of improving subjective image quality by performing motion detection on a moving image, dividing a frame image of the moving image into a still portion and a portion where motion is included on the basis of a result of the motion detection, and decreasing a quantization parameter for a portion of higher interest where large motion is included.

Incidentally, in an encoding system, which is frequently used for encoding a moving image, of generating a predicted image with use of motion prediction and encoding a residual image between an encoding target image and the predicted image, a size of the reference image changes in accordance with a direction of motion of a moving object included in an image; therefore, an encoding difficulty level of the image changes in accordance with the direction of motion of the moving object.

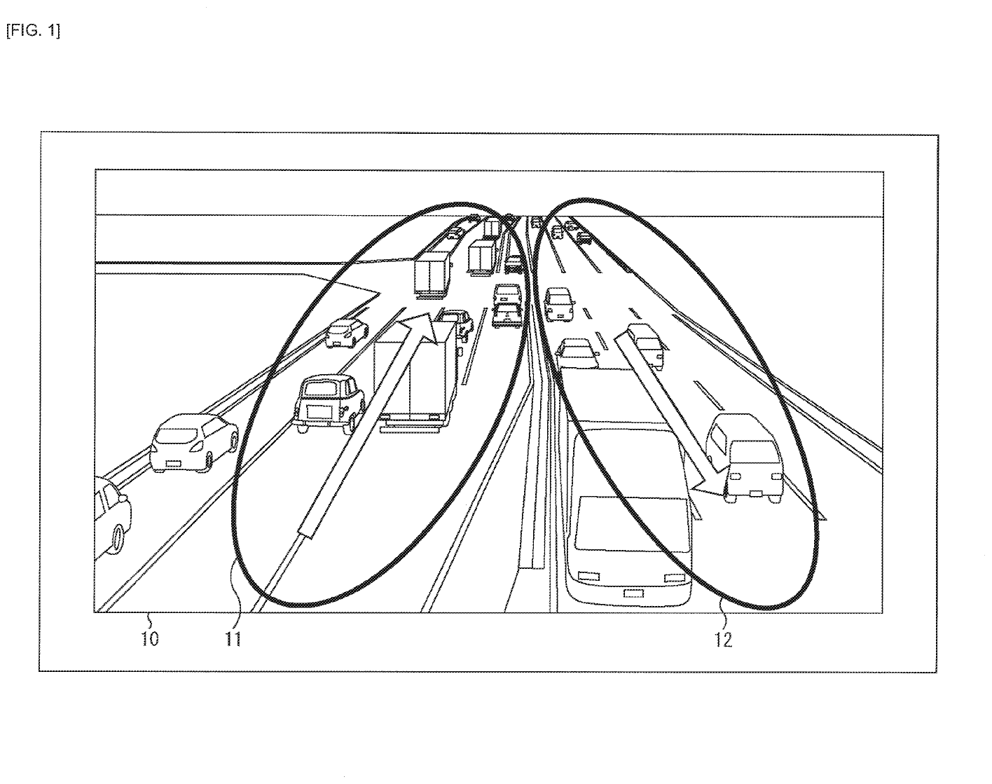

For example, an image 10 in FIG. 1 is an example of a moving image (a frame image of the moving image) obtained by capturing an image of a road. In a left portion of the image 10 (for example, a region surrounded by an elliptical frame 11), a vehicle (a moving object) moves from the front to the back, as indicated by an arrow in the diagram. In a right portion of the image 10 (for example, a region surrounded by an elliptical frame 12), a vehicle (a moving object) moves from the back to the front, as indicated by an arrow in the diagram.

In a case where a certain moving object included in the moving image moves from the front to the back like the vehicle in the region surrounded by the frame 11, a reference image generated from a past frame image is larger than an image of the moving object in the current frame image. That is, it is possible to use a high-resolution reference image; therefore, prediction accuracy is high, and an encoding difficulty level of the reference image becomes relatively low. In contrast, in a case where the moving object moves from the back to the front like the vehicle in the region surrounded by the frame 12, the reference image generated from the past frame image is smaller than the image of the moving object of the current frame image. That is, a low-resolution reference image is used; therefore, prediction accuracy is low, and the encoding difficulty level of the reference image is relatively high. That is, if other conditions are the same, the image of the moving object that moves from the back to the front is higher in encoding difficulty level than the image of the moving object that moves from the front to the back.

However, in existing quantization as described in PTL 1, such a direction of motion of the moving object is not taken into consideration, and a uniform quantization parameter is set for the image of the moving object regardless of the direction of motion of the moving object. Accordingly, image quality of an image of an object (a moving object) that moves in a direction in which the encoding difficulty level is high (for example, from the back to the front) may be unnecessarily reduced.

As described above, in a moving image, generally, a portion where motion is included is of higher interest than a still portion. Unless there is some special reason, a degree of interest is independent of a motion direction. However, in a case where the image of the moving object is quantized with a uniform quantization parameter as described above, for example, image quality of the image of the moving object that moves in the direction in which the encoding difficulty level is high may be reduced to become lower than image quality corresponding to the degree of interest. That is, subjective image quality of the entire image may be dependent on the motion direction of the moving object.

It is to be noted that, generally, for encoding of a moving image, a target bit rate is set, and encoding is controlled to cause a bit stream to become the target bit rate. Accordingly, unnecessarily reducing image quality of the image of the moving object that moves in a direction in which the encoding difficulty level is high means that assignment of a bit rate to that portion is unnecessarily small and assignment of the bit rate to another portion is unnecessarily large. That is, in a case where the image of the moving object is quantized with a uniform quantization parameter as described above, the bit rate of the entire image may be inappropriately assigned, and subjective image quality of the entire image may be reduced with respect to the target bit rate. In other words, encoding efficiency may be reduced with respect to the subjective image quality of the entire image.

In addition, the direction of motion of the moving object are not taken into consideration in existing quantization as described above; therefore, quantization is performed with a uniform quantization parameter regardless of the encoding difficulty level varying by the motion direction of the moving object, which may cause image quality of the image to differ depending on the motion direction of the moving object. Accordingly, for example, in a case where an image includes a plurality of moving objects that move in direction different from each other, variations in image quality in the image increase, resulting in an unnatural image, which may reduce subjective image quality of the entire image.

It is to be noted that, there has been a control method in which a portion of an image is set to a region of interest, and in order to intensively cause the region of interest to have high image quality, a quantization parameter for the region of interest is decreased to increase a code amount, but it is not possible for this method to cope with a difference in encoding difficulty level caused by a difference in the motion direction of the moving object. Accordingly, as in the above-described case, image quality of the image of the moving object that moves in a direction in which the encoding difficulty level is high may be unnecessarily reduced, and subjective image quality of the entire image may be reduced.

### <Quantization Control Corresponding to Motion Direction>

Accordingly, an encoding target image is quantized, and with use of a quantization parameter corresponding to an encoding difficulty level varying by a motion direction of a moving object in the encoding target image, the image of the moving object included in the encoding target image is quantized, and the quantized encoding target image is encoded, thereby generating a bit stream.

For example, a quantizer and an encoding unit are provided in an image processing apparatus. The quantizer quantizes an encoding target image, and quantizes an image of a moving object included in the encoding target image with use of a quantization parameter corresponding to an encoding difficulty level varying by a motion direction of the moving object in the encoding target image. The encoding unit encodes the encoding target image quantized by the quantizer to generate a bit stream.

Doing so makes it possible to set a value of the quantization parameter in accordance with the encoding difficulty level varying by the motion direction of the moving object, which makes it possible to make image quality of the image of the moving object independent of the motion direction of the moving object. Thus, it is possible to suppress an unnecessary reduction in image quality of an image of a moving object that moves in a direction in which the encoding difficulty level is high (for example, from the back to the front). In addition, it is possible to suppress dependence of subjective image quality of the entire image on the motion direction of the moving object. Further, assignment of a bit rate is made more appropriate, which makes it possible to suppress a reduction in the subjective image quality of the entire image with respect to the target bit rate (a reduction in encoding efficiency with respect to the subjective image quality of the entire image). In addition, in a case where an image includes a plurality of moving objects that move in directions different from each other, it is possible to suppress variations in image quality in the image, suppress a sense of discomfort caused by the variations in image quality, and suppress a reduction in subjective image quality of the entire image.

### <Quantization Parameter Control in Difficult Encoding Direction>

For example, the quantizer may quantize an image of a moving object that moves in a direction in which the encoding difficulty level is high with use of a smaller quantization parameter than that in a case where the moving object moves in another direction. Doing so makes it possible to suppress a reduction in image quality of the image of the moving object that moves in the direction in which the encoding difficulty level is high.

<Moving Object Moving in Direction from Back to Front>

The direction in which the encoding difficulty level is high may be, for example, a direction from the back to the front of the image. In an image of a moving object that moves from the back to the front of the image, a reference image of the image is generally smaller than the current image of the moving object; therefore, the encoding difficulty level is increased. Accordingly, the quantizer quantizes the image of the moving object that moves in the direction from the back to the front of the image with use of a smaller quantization parameter than that in a case where the moving object moves in another direction, which makes it possible to suppress a reduction in image quality of the image of the moving object.

### <Setting of Quantization Parameter>

It is to be noted that a quantization parameter setting unit may be further provided. The quantization parameter setting unit sets the quantization parameter in accordance with the encoding difficulty level varying by the motion direction of the moving object as described above. The quantizer may quantize the image of the moving object with use of the quantization parameter set by the quantization parameter setting unit.

Doing so makes it possible to set the quantization parameter to a value corresponding to the encoding difficulty level varying by the motion direction of the moving object. This makes it possible to suppress a reduction in image quality of the entire image as described above.

### <Decrease Quantization Parameter in Difficult Encoding Direction>

For example, in a case where the motion direction of the moving object is in a direction in which the encoding difficulty level is high, the above-described quantization parameter setting unit may decrease the quantization parameter to a smaller value than that in a case where the moving object moves in another direction (may set the quantization parameter to a smaller value). Doing so makes it possible to improve image quality of the image of the moving object that moves in the direction in which the encoding difficulty level is high.

It is to be noted that, instead of decreasing the quantization parameter for the image of the moving object that moves in the direction in which the encoding difficulty level is high, a quantization parameter for another image may be increased (the quantization parameter may be set to a larger value). Alternatively, the quantization parameter for another image may be increased while decreasing the quantization parameter for the image of the moving object that moves in the direction in which the encoding difficulty level is high. Even in these cases, it is possible to achieve effects similar to those in a case where the quantization parameter for the image of the moving object that moves in the direction in which the encoding difficulty level is high is decreased. In addition, control of the quantization parameter for another image makes it possible to suppress a difficulty in rate control using the target bit rate by such control of the quantization parameter.

### <Increase Quantization Parameter in Easy Encoding Direction>

In addition, for example, in a case where the motion direction of the moving object is in a direction in which the encoding difficulty level is low, the quantization parameter setting unit may increase the quantization parameter to a larger value in a case where the moving object moves in another direction (may set the quantization parameter to a larger value). Doing so makes it possible to reduce image quality of the image of the moving object that moves in the direction in which the encoding difficulty level is low. Accordingly, in a case where an image includes a plurality of moving objects that move in directions different from each other, it is possible to suppress variations in image quality in the image, suppress a sense of discomfort caused by the variations in image quality, and suppress a reduction in subjective image quality of the entire image. In addition, it is possible to suppress an increase in the bit rate by setting of the quantization parameter.

It is to be noted that, instead of increasing the quantization parameter for the image of the moving object that moves in the direction in which the encoding difficulty level is low, a quantization parameter for another image may be decreased (the quantization parameter may be set to a smaller value). Alternatively, the quantization parameter for another image may be decreased while increasing the quantization parameter for the image of the moving object that moves in the direction in which the encoding difficulty level is low. Even in these cases, it is possible to achieve effect similar to those in a case where the quantization parameter for the image of the moving object that moves in the direction in which the encoding difficulty level is low is increased. In addition, control of the quantization parameter for another image makes it possible to more easily suppress a reduction in subjective image quality of the entire image by such control of the quantization parameter.

### <Setting of Quantization Parameter for Moving Object in Difficult Encoding and Easy Encoding Directions>

Further, for example, the above-described quantization parameter setting unit may decrease the quantization parameter for the image of the moving object that moves in the direction in which the encoding difficulty level is high (set the quantization parameter to a smaller value) and increase the quantization parameter for the image of the moving object that moves in the direction in which the encoding difficulty level is low (set the quantization parameter to a larger value). Doing so makes it possible to suppress variations in image quality in the image, suppress a sense of discomfort by the variations in image quality, and suppress a reduction in subjective image quality of the entire image. In addition, it is possible to assign, to the image of the moving object that moves in the direction in which the encoding difficulty level is high, a bit rate assigned to the image of the moving object that moves in the direction in which the encoding difficulty level is low. This makes it possible to suppress a difficulty in rate control using the target bit rate by such control of the quantization parameter.

### <Setting of Quantization Parameter Corresponding to Magnitude of Motion>

For example, the quantization parameter setting unit may further increase an adjustment amount of the quantization parameter with an increase in magnitude of motion of the moving object. For example, the quantization parameter for the image of the moving object that moves in the direction in which the encoding difficulty level is high may be greatly decreased with an increase in magnitude of motion of that moving object. In addition, the quantization parameter for the image of the moving object that moves into the direction in which the encoding difficulty level is low may be increased with an increase in magnitude of motion of that moving object.

For example, in a case where a moving object moves from the back to the front, generally, a reference image becomes smaller than the current image of the moving object with an increase in a motion amount of the moving object. That is, in a case of such motion, it can be said that the larger the motion amount of the moving object, the higher the encoding difficulty level becomes. Accordingly, the quantization parameter for the image of the moving object that moves in the direction in which the encoding difficulty level is high is greatly decreased with an increase in magnitude of motion of that moving object (the quantization parameter is set to a smaller value), which makes it possible to suppress a reduction in image quality of the image of the moving object regardless of the motion amount. In particular, doing so in a case where an image includes a plurality of moving objects having motion amounts different from each other makes it possible to further suppress variations in image quality by a difference between the motion amounts. Accordingly, it is possible to further suppress a reduction in subjective image quality of the entire image.

It is to be noted that decreasing the quantization in such a manner increases a code amount. Accordingly, in order to achieve a target bit rate, the quantization parameter for the image of the moving object that moves in the direction in which the encoding difficulty level is low may be greatly increased (the quantization parameter may be set to a larger value) with an increase in the motion amount of that moving object. Doing so makes it possible to suppress a difficulty in rate control using the target bit rate.

### 2. First Embodiment

### <Quantization Control Corresponding to Direction of Motion Vector>

It is to be noted that the quantization parameter setting unit described above may set the quantization parameter on the basis of a motion direction of a moving object specified on the basis of a direction of a motion vector of an image of the moving object in an encoding target image. That is, the quantization parameter may be set on the basis of the direction of the motion vector obtained as a result of motion detection performed on the encoding target image.

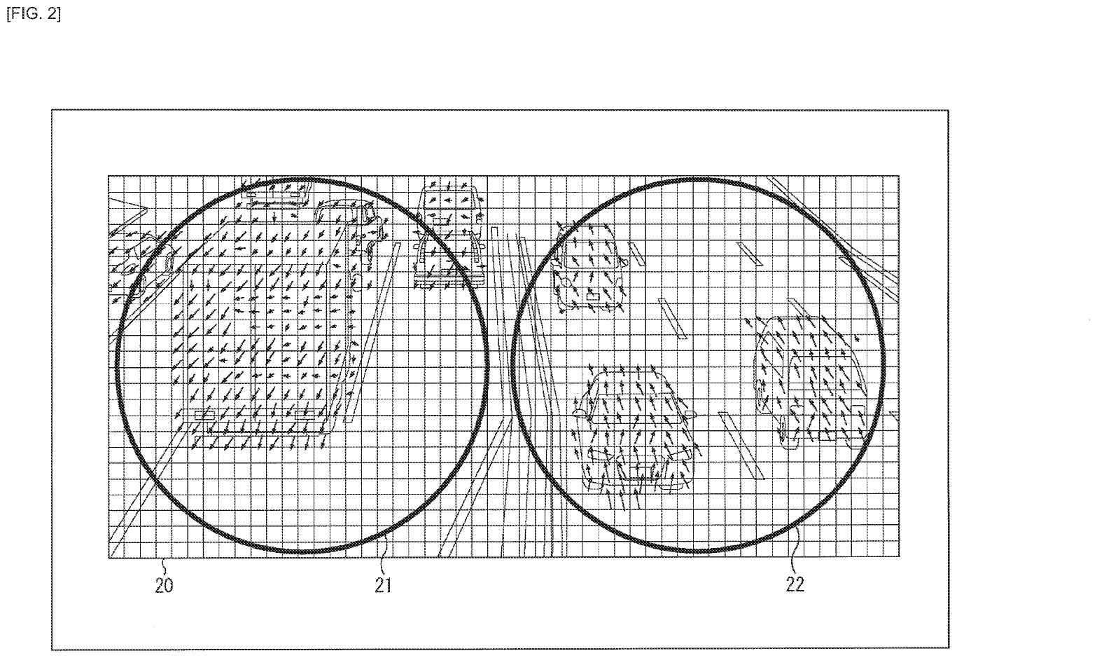

For example, as in the image 10 in FIG. 1, an image 20 in FIG. 2 is an example of a moving image (a frame image of the moving image) obtained by capturing an image of a road. In a left portion of the image 20 (for example, a region surrounded by a circular frame 21), a vehicle (a moving object) moves from the front to the back. In addition, in a right portion of the image 20 (for example, a region surrounded by a circular frame 22), a vehicle (a moving object) moves from the back to the front, as indicated by an arrow in the diagram.

Each of small squares in the image 20 represents a block (a partial region) serving as a unit of motion prediction of encoding. In addition, an arrow indicates a motion vector detected in the block. A block with no arrow is a block in which no motion vector is detected. It is needless to say that the motion vector is easily detected in a portion of the moving object. Further, in many cases, a direction of the motion vector corresponds to a direction of motion of the moving object.

For example, in a case of the image 20, in the region surrounded by the frame 21 in which the vehicle moves from the front to the back, a large number of motion vectors indicate a downward direction of a screen. In addition, in the region surrounded by the frame 22 in which the vehicle moves from the back to the front, a large number of motion vectors indicate an upward direction of the screen.

As described above, it is possible to estimate the motion direction of the moving object by the direction of the motion vector. Accordingly, setting the quantization parameter on the basis of the direction of the motion vector (the motion direction of the moving object specified on the basis of the direction of the motion vector) makes it possible to quantize the image of the moving object with use of the quantization parameter corresponding to the encoding difficulty level varying by the motion direction. This makes it possible to make image quality of the moving object independent of the motion direction of that moving object, and to suppress a reduction in image quality.

### <Image Processing Apparatus>

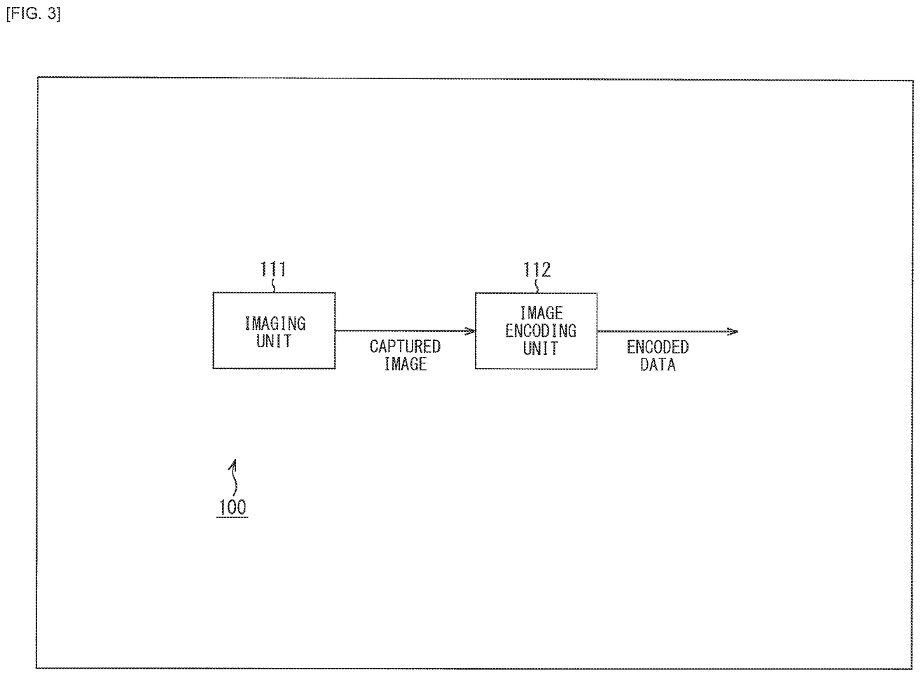

FIG. 3 is a diagram illustrating a main configuration example of an embodiment of an image processing apparatus to which the present technology is applied. An image processing apparatus 100 illustrated in FIG. 3 is an apparatus that captures an image of a subject, and encodes and outputs the obtained captured image. In encoding, the image processing apparatus 100 performs quantization to which the present technology as described above in <1. Control of Quantization> is applied. The image processing apparatus 100 includes an imaging unit 111 and an image encoding unit 112, as illustrated in FIG. 3.

The imaging unit 111 performs processing relating to imaging. The imaging unit 111 includes, for example, a CMOS (Complementary Metal Oxide Semiconductor) image sensor and the like, receives light from a subject, performs photoelectric conversion, and performs A/D conversion, demosaicing processing, and the like, thereby generating a captured image. The imaging unit 111 supplies the obtained captured image (data of the captured image) to the image encoding unit 112. It is to be noted that the imaging unit 111 repeats imaging as described above to generate a moving image including respective captured images as frame images, and supplies the moving image to the image encoding unit 112.

The image encoding unit 112 performs processing relating to encoding of the captured image. For example, the image encoding unit 112 encodes the captured image of the moving image to generate encoded data (a bit stream), and outputs the encoded data. A system of this encoding may be any system using motion prediction and quantization. Examples of the system may include AVC (Advanced Video Coding), HEVC (High Efficiency Video Coding), and the like. Hereinafter, description is given with use of HEVC as an example. The image encoding unit 112 performs, as quantization in this encoding of the captured image, quantization to which the present technology as described above in <1. Control of Quantization> is applied.

The image encoding unit 112 may have any configuration. For example, the image encoding unit 112 may include a CPU (Central Processing Unit), a ROM (Read Only Memory), a RAM (Random Access Memory), and the like, and the CPU may load a program or data stored in the ROM and the like into the RAM and execute the program or data, thereby performing processing.

### <Image Encoding Unit>

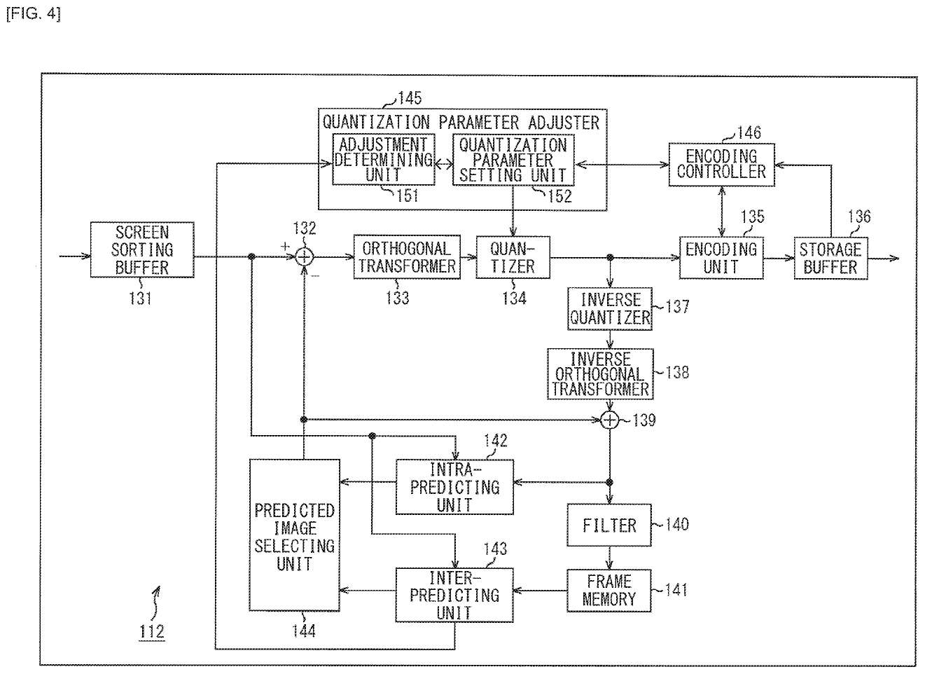

FIG. 4 is a block diagram illustrating a main configuration example of the image encoding unit 112 illustrated in FIG. 3. As illustrated in FIG. 4, the image encoding unit 112 includes a screen sorting buffer 131, an operating unit 132, an orthogonal transformer 133, a quantizer 134, an encoding unit 135, and a storage buffer 136. The image encoding unit 112 further includes an inverse quantizer 137, an inverse orthogonal transformer 138, an operating unit 139, a filter 140, a frame memory 141, an intra-predicting unit 142, an inter-predicting unit 143, and a predicted image selecting unit 144. In addition, the image encoding unit 112 includes a quantization parameter adjuster 145 and an encoding controller 146.

The screen sorting buffer 131 stores images of respective frames of the inputted image data in display order, sorts the images of the frames, which are stored in the display order, in order of frames for encoding according to GOP (Group Of Picture), and supplies the images sorted in the order of frames to the operating unit 132. It is to be noted that, at this time, the screen sorting buffer 131 sets processing units (blocks). The processing units (blocks) will be described later. For example, the screen sorting buffer 131 calculates a cost function for each of candidates of division patterns of the processing units (that is a size of each of the blocks), and sets the division pattern (the size of each of the blocks) on the basis of a value of the cost function. The screen sorting buffer 131 supplies the images of the respective frames to the operating unit 132 in accordance with the set processing units. In addition, the screen sorting buffer 131 also supplies the images of the respective frames to the intra-predicting unit 142 and the inter-predicting unit 143 in a similar manner.

The operating unit 132 subtracts, from the inputted images read from the screen sorting buffer 131 in decoding order, a predicted image supplied from the intra-predicting unit 142 or the inter-predicting unit 143 through the predicted image selecting unit 144. For example, in a case of an image to be subjected to intra-encoding, the operating unit 132 subtracts the predicted image supplied from the intra-predicting unit 142 from the image read from the screen sorting buffer 131. In addition, for example, in a case of an image to be subjected to inter-encoding, the operating unit 132 subtracts the predicted image supplied from the inter-predicting unit 143 from the image read from the screen sorting buffer 131. The operating unit 132 supplies difference information (residual data) obtained by such subtraction to the orthogonal transformer 133.

The orthogonal transformer 133 performs orthogonal transformation on the residual data supplied from the operating unit 132. For example, the orthogonal transformer 133 performs a discrete cosine transform, a Karhunen-Leebe transform, or the like as the orthogonal transformation. This orthogonal transformation is performed by any method, and is not limited to the above-described examples. For example, in a case where the encoding system is not HEVC, another orthogonal transformation system may be used. The orthogonal transformer 133 supplies an orthogonal transformation coefficient obtained by the orthogonal transformation (residual data having been subjected to the orthogonal transformation) to the quantizer 134. It is to be noted that in a mode where the orthogonal transformation is skipped, the orthogonal transformer 133 supplies, to the quantizer 134, the residual data supplied from the operating unit 132.

The quantizer 134 quantizes the orthogonal transformation coefficient or the residual data supplied from the orthogonal transformer 133. At this time, the quantizer 134 performs quantization with use of a quantization parameter (QP) set by the quantization parameter adjuster 145.

For example, the quantizer 134 determines a quantization step (Qstep) with use of a quantization scale (Qscale) determined from the quantization parameter or the like, and quantizes the orthogonal transformation coefficient by dividing the orthogonal transformation coefficient by the quantization step to calculate a quantization coefficient.

The quantization is performed by any method as long as the quantization is performed with use of the quantization parameter. For example, in a case where the encoding system is not HEVC, any system other than a system defined in HEVC may be used. The quantizer 134 supplies, to the encoding unit 135, the quantized orthogonal transformation coefficient or residual data (also referred to as a quantization coefficient) obtained by the quantization.

The encoding unit 135 losslessly encodes the quantization coefficient supplied from the quantizer 134 by arithmetic encoding (for example, CABAC (Context-Adaptive Binary Arithmetic Coding) and the like) to generate encoded data. It is to be noted that this encoding system is optional, and is not limited to the above-described examples. For example, in a case where the encoding system is not HEVC, variable length encoding such as CAVLC (Context-Adaptive Variable Length Coding) may be used.

In addition, the encoding unit 135 associates metadata supplied from the encoding controller 146 with the encoded data. For example, the encoding unit 135 incorporates (multiplexes) this metadata as a portion of header information of the encoded data (also referred to as encoded stream).

The term “associate” here means, for example, that in a case where one piece of data is processed, another piece of data is made usable (made linkable). That is, pieces of data associated with each other may be brought together as one piece of data, or may be individual pieces of data. For example, the information associated with the encoded data (an image) may be transmitted through a transmission path other than a transmission path of the encoded data (the image). In addition, for example, the information associated with the encoded data (the image) may be recorded on a recording medium different from a recording medium on which the encoded data (the image) is recorded (or in a different recording region of the same recording medium). It is to be noted that the “association” may be performed on a portion of data instead of the entirety of the data. For example, data may be associated with each other in any unit such as a plurality of frames, one frame, or a portion in a frame.

In addition, in this specification, the terms such as “synthesize,” “multiplex,” “add,” “integrate,” “include,” “store,” “enter,” “put into,” “insert,” “embed,” “bury”, and “incorporate,” mean that a plurality of objects is combined into one; for example, encoded data and metadata are combined into one piece of data. These terms mean one of methods for the above-described “association.”

In addition, the encoding unit 135 supplies, to the encoding controller 146, any information such as, for example, information necessary for generation of the metadata and information necessary for selection of the encoding method such as a prediction mode and a block size. Further, the encoding unit 135 supplies the encoded data associated with the metadata to the storage buffer 136.

The storage buffer 136 temporarily holds the encoded data supplied from the encoding unit 135 and metadata thereof. The storage buffer 136 outputs the held encoded data and the held metadata thereof to outside of the image encoding unit 112 (the image processing apparatus 100) at a predetermined timing. For example, the storage buffer 136 outputs the encoded data to which the held metadata is added as a bit stream. That is, the storage buffer 136 is an output unit that outputs the encoded data and a transmitting unit that transmits the encoded data. It is to be noted that it is possible for the storage buffer 136 to provide the encoding controller 146 with information relating to an amount of held data (a buffering amount).

In addition, the quantization coefficient obtained in the quantizer 134 is also supplied to the inverse quantizer 137. The inverse quantizer 137 inversely quantizes the quantization coefficient by a method corresponding to the quantization by the quantizer 134. The inverse quantizer 137 obtains information (for example, the quantization parameter, or the like) necessary for inverse quantization from the quantizer 134 through the encoding controller 146 or from the quantizer 134 or the quantization parameter adjuster 145.

It is to be noted that the inverse quantization is performed by any method corresponding to the quantization by the quantizer 134. For example, in a case where the encoding system is not HEVC, any method other than the method defined in HEVC may be used. The inverse quantizer 137 supplies an orthogonal transformation coefficient obtained by the inverse quantization to the inverse orthogonal transformer 138.

The inverse orthogonal transformer 138 performs inverse orthogonal transformation on the orthogonal transformation coefficient supplied from the inverse quantizer 137 by a method corresponding to orthogonal transformation processing by the orthogonal transformer 133. The inverse orthogonal transformer 138 obtains information necessary for inverse orthogonal transformation from the orthogonal transformer 133 through the encoding controller 146 or from the orthogonal transformer 133.

It is to be noted that the inverse orthogonal transformation is performed by any method corresponding to the orthogonal transformation by the orthogonal transformer 133. For example, in a case where the encoding system is not HEVC, any method other than the method defined in HEVC may be used. The inverse orthogonal transformer 138 supplies residual data (restored residual data) obtained by the inverse orthogonal transformation to the operating unit 139.

The operating unit 139 adds a predicted image supplied from the intra-predicting unit 142 or the inter-predicting unit 143 through the predicted image selecting unit 144 to the restored residual data supplied from the inverse orthogonal transformer 138 to obtain a locally reconstructed image (hereinafter referred to as reconstructed image). The reconstructed image is supplied to the filter 140.

The filter 140 performs filtering processing such as deblocking filtering and sample adaptive offset SAO (Sample Adaptive Offset) on the reconstructed image supplied from the operating unit 139 as appropriate. This makes it possible to remove block distortion of the reconstructed image and to reduce ringing and correct deviation of a pixel value.

This filtering processing has any contents, and is not limited to the above-described examples. For example, in a case where the encoding system is not HEVC, another filtering processing such as Wiener filter may be performed. The filter 140 supplies a result of the filtering processing (hereinafter, referred to as a decoded image) (including a result obtained without performing the filtering processing) to the frame memory 141.

The frame memory 141 has a storage region in which information is stored, and stores the decoded image supplied from the filter 140 in the storage region. In addition, the frame memory 141 supplies the stored decoded image to the inter-predicting unit 143 as a reference image at a predetermined timing.

The reconstructed image obtained in the operating unit 139 is also supplied to the intra-predicting unit 142. The intra-predicting unit 142 performs intra-prediction (in-screen prediction). In the intra-prediction, a predicted image is generated with use of a pixel value in a processing target picture that is the reconstructed image supplied from the operating unit 139 as a reference image, a pixel value of an input image supplied from the screen sorting buffer 131, and the like. For example, the intra-predicting unit 142 performs intra-prediction in a plurality of intra-prediction modes (for example, Angular prediction, DC prediction, Planer prediction, and the like) prepared in advance, and generates a predicted image by intra-prediction.

This intra-prediction modes are optional, and are not limited to the above-described examples. Any mode may be used, and intra-prediction may be performed in any number of modes. For example, in a case where the coding system is not HEVC, intra-prediction may be performed in another mode.

The intra-predicting unit 142 generates predicted images in all candidates of the intra-prediction modes, and supplies the predicted images generated in the respective intra-prediction modes to the predicted image selecting unit 144.

The inter-predicting unit 143 performs inter-prediction processing (motion prediction processing and compensation processing) with use of the input image supplied from the screen sorting buffer 131 and the reference image supplied from the frame memory 141. More specifically, as the inter-prediction processing, the inter-predicting unit 143 performs motion compensation processing in accordance with a motion vector detected by performing motion prediction, and generates a predicted image by inter-prediction. For example, the inter-predicting unit 143 generates predicted images by inter-prediction in a plurality of inter-prediction modes (for example, an inter mode, a merge mode, and the like) prepared in advance. That is, the inter-predicting unit 143 is a motion detector that detects motion of a moving object in the image (input image) of the encoding target and calculates a motion vector of an image of the moving object.

It is to be noted that it is also possible for the inter-predicting unit 143 to reuse a surrounding complementary motion compensation prediction parameter and select a skip mode in which the predicted image is used as it is as a decoded image, and description thereof is omitted. The inter-prediction modes are optional, and are not limited to the above-described examples. Any mode may be used, and inter-prediction may be performed in any number of modes. For example, in a case where the coding system is not HEVC, intra-prediction may be performed in another mode.

The inter-predicting unit 143 generates predicted images in all candidates of the inter-prediction modes, and supplies the predicted images generated in the respective inter-prediction modes to the predicted image selecting unit 144. In addition, the inter-predicting unit 143 supplies information indicating the motion vector obtained by the motion prediction to the quantization parameter adjuster 145.

The predicted image selecting unit 144 selects a prediction mode by selecting an optimal predicted image from the predicted images in the respective prediction modes supplied from the intra-predicting unit 142 and the inter-predicting unit 143. For example, the predicted image selecting unit 144 calculates a cost function for each of the predicted images in the prediction modes, and selects a predicted image (that is, a prediction mode) of which the cost function has the smallest value. The predicted image selecting unit 144 supplies the predicted image in the intra-prediction mode or the inter-prediction mode selected as an optimal prediction mode to the operating unit 132 and the operating unit 139.

The quantization parameter adjuster 145 performs processing relating to adjustment (setting) of the quantization parameter used by the quantizer 134 and the inverse quantizer 137. For example, the quantization parameter adjuster 145 sets the quantization parameter on the basis of a motion direction of the moving object specified on the basis of the direction of the motion vector of the image of the moving object in the encoding target image.

It is to be noted that it is also possible for the quantization parameter adjuster 145 to obtain information relating to a buffering amount of the storage buffer 136, and the like through the encoding controller 146 and adjust (set) the quantization parameter on the basis of the information, thereby performing rate control of a bit stream outputted from the image encoding unit 112. In addition, the quantization parameter adjuster 145 supplies information relating to the set quantization parameter to the encoding controller 146.

As illustrated in FIG. 4, the quantization parameter adjuster 145 includes an adjustment determining unit 151 and a quantization parameter setting unit 152. The adjustment determining unit 151 determines whether or not to adjust the quantization parameter on the basis of information indicating the motion vector (the direction of the motion vector) supplied from the inter-predicting unit 143. The adjustment determining unit 151 supplies, to the quantization parameter setting unit 152, information indicating a result of such determination and information indicating the motion vector supplied from the inter-predicting unit 143.

In a case where the adjustment determining unit 151 determines to adjust the quantization parameter, the quantization parameter setting unit 152 adjusts (sets) the quantization parameter in accordance with the direction of the motion vector. For example, the quantization parameter setting unit 152 adjusts an initial quantization parameter set for each picture or each slice in accordance with the direction of the motion vector (an encoding difficulty level varying by the motion direction of the moving object specified on the basis of the direction of the motion vector). In addition, for example, in accordance with the encoding difficulty level varying by the motion direction of the moving object specified on the basis of the direction of the motion vector, the quantization parameter setting unit 152 further adjusts the quantization parameter having been adjusted in accordance with the rate control and the like.

In a case where the adjustment determining unit 151 determines not to adjust the quantization parameter, the quantization parameter setting unit 152 omits (skips) such adjustment (setting) of the quantization parameter in accordance with the direction of the motion vector. That is, a value of the quantization parameter in this case is an initial value set for each picture or each slice, or a value adjusted in accordance with the rate control and the like.

The quantization parameter setting unit 152 supplies the set quantization parameter to the quantizer 134. The quantizer 134 performs quantization with use of the quantization parameter. That is, the quantizer 134 quantizes the image of the moving object included in the encoding target image with use of the quantization parameter corresponding to the encoding difficulty level varying by the motion direction of the moving object specified on the basis of the direction of the motion vector of the image of the moving object in the encoding target image. It is to be noted that it is also possible for the quantization parameter setting unit 152 to obtain information relating to the buffering amount of the storage buffer 136, and the like through the encoding controller 146 and adjust (set) the quantization parameter as the rate control of the bit stream on the basis of the information. In addition, the quantization parameter setting unit 152 supplies information relating to the set quantization parameter to the encoding controller 146.

The encoding controller 146 performs processing relating to control of encoding. For example, the encoding controller 146 performs processing relating to generation of the metadata to be added to the encoded data generated by the encoding unit 135. It is to be noted that, although arrows are not illustrated in FIG. 4, the encoding controller 146 obtains information to be included in the metadata or information necessary to generate the information to be included in the metadata from respective processing units from the screen sorting buffer 131 to the quantization parameter adjuster 145.

For example, the encoding controller 146 obtains information relating to setting of processing units (blocks) from the screen sorting buffer 131. In addition, for example, the encoding controller 146 obtains control information, a parameter, and the like relating to the orthogonal transformation from the orthogonal transformer 133. In addition, for example, the encoding controller 146 obtains control information and the like relating to quantization from the quantizer 134. In addition, for example, the encoding controller 146 obtains control information, a parameter, and the like relating to encoding from the encoding unit 135. In addition, for example, the encoding controller 146 obtains information and the like relating to an encoding amount (buffering amount) of the encoded data, the metadata, and the like stored in the storage buffer 136.

In addition, for example, the encoding controller 146 obtains control information and the like relating to inverse quantization from the inverse quantizer 137. In addition, for example, the encoding controller 146 obtains control information, a parameter, and the like relating to inverse orthogonal transformation from the inverse orthogonal transformer 138. In addition, for example, the encoding controller 146 obtains control information, a parameter, and the like relating to filtering processing from the filter 140. In addition, for example, the encoding controller 146 obtains control information, a parameter, and the like relating to inverse orthogonal transformation from the frame memory 141.

In addition, for example, the encoding controller 146 obtains control information, a parameter, and the like relating to the optimal prediction mode from the intra-predicting unit 142 or the inter-predicting unit 143. In addition, for example, the encoding controller 146 obtains the quantization parameter and the like from the quantization parameter adjuster 145.

The encoding controller 146 performs processing relating to control of encoding. For example, the encoding controller 146 generates metadata with use of these information. The encoding controller 146 supplies the generated metadata to the encoding unit 135.

In addition, the encoding controller 146 obtains information indicating the amount of data (the buffering amount) stored in the storage buffer 136 from the storage buffer 136. The encoding controller 146 supplies the information indicating the buffering amount to the quantization parameter adjuster 145.

### <Operation Relating to Quantization Processing>

In the image encoding unit 112 having a configuration as described above, it is possible for the quantization parameter adjuster 145 and the quantizer 134 to basically perform processing similar to processing described above in <1. Control of Quantization>. Note that the quantization parameter adjuster 145 sets the quantization parameter on the basis of the motion direction of the moving object specified on the basis of the direction of the motion vector of the image of the moving object in the encoding target image. In addition, the quantizer 134 quantizes the image of the moving object with use of the quantization parameter set by the quantization parameter adjuster 145.

More specifically, the quantization parameter adjuster 145 obtains, from the inter-predicting unit 143, information indicating the motion vector obtained by the inter-predicting unit 143, and sets the quantization parameter on the basis of the information. This motion vector is information indicating the motion of the image of the moving object in the image (input image) of the encoding target. That is, the quantization parameter adjuster 145 sets the quantization parameter on the basis of the motion direction of the moving object specified on the basis of the direction of the motion vector of the image of the moving object in the encoding target image, which is calculated by the inter-predicting unit 143.

For example, in a case where the direction of the motion vector of the image of the moving object is a predetermined direction corresponding to the motion direction of the moving object that moves in a direction in which the encoding difficulty level is high, the quantization parameter adjuster 145 decreases the quantization parameter (sets the quantization parameter to a smaller value than a value in a case other than the case).

For example, in a case of the image 20 (FIG. 2), the vehicle (the moving object) in the region surrounded by the frame 22 moves from the back to the front as described above, and the encoding difficulty level of the vehicle is higher than the encoding difficulty level of the vehicle (the moving object that moves from the front to the back) in the region surrounded by the frame 21. As illustrated in FIG. 2, many motion vectors of blocks in such a region are directed upward in the diagram. In other words, in a case of the example of FIG. 2, an upward motion vector in the diagram indicates motion of the moving object that moves from the back to the front. Further, an image of such a block has a high encoding difficulty level. Accordingly, the quantization parameter adjuster 145 decreases the quantization parameter for a block of the upward motion vector in the diagram (sets the quantization parameter to a smaller value).

Doing so makes it possible for the quantization parameter adjuster 145 to suppress a reduction in image quality of the image of the moving object that moves in the direction in which the encoding difficulty level is high, on the basis of the motion vector. In particular, it is possible to adjust (set) the quantization parameter as described above on the basis of the motion vector obtained by the inter-prediction; therefore, it is not necessary for the quantization parameter adjuster 145 to detect the motion of the moving object separately from encoding, and it is possible to easily suppress a reduction in image quality of the image of the moving object that moves in the direction in which the encoding difficulty level is high on the basis of information obtained by encoding such as HEVC.

It is to be noted that the direction of the motion vector is determined by any method. For example, in a case where a vertical direction component of the motion vector is positive (upward in the diagram) and sufficiently large as compared with a horizontal direction component, the direction of the motion vector may be determined to be upward in the diagram.

In addition, the direction of the motion vector indicating that the moving object is moving in the direction in which the encoding difficulty level is high (that is, in a predetermined direction corresponding to the motion direction of the moving object that moves in the direction in which the encoding difficulty level is high) differs depending on an angle of view (angle) and the like of the image. That is, the direction of the motion vector for decreasing the quantization parameter (the predetermined direction described above) may be any direction corresponding to the direction in which the encoding difficulty level is high (the direction is not limited to the example in FIG. 2).

Further, instead of decreasing the quantization parameter of the motion vector for the block of the motion vector in this “predetermined direction”, the quantization parameter for images of other blocks may be increased. Alternatively, the quantization parameter for the images of the other blocks may be increased while decreasing the quantization parameter for the block of the motion vector in the “predetermined direction”. Even in these cases, it is possible to achieve effects similar to those in a case where the quantization parameter for the image of the moving object that moves in the direction in which the encoding difficulty level is high is decreased. In addition, controlling the quantization parameter for the images of the other blocks makes it possible to suppress a difficulty in rate control using the target bit rate by such control of the quantization parameter.

In addition, for example, in a case where the direction of the motion vector of the image of the moving object is a predetermined direction corresponding to the motion direction of the moving object that moves in the direction in which the encoding difficulty level is low, the quantization parameter adjuster 145 may increase the quantization parameter (set the quantization parameter to a larger value than a value in a case other than the case).

For example, in the case of the image 20 (FIG. 2), the vehicle (the moving object) in the region surrounded by the frame 21 moves from the front to the back as described above, and the encoding difficulty level of the vehicle is lower than the encoding difficulty level of the vehicle (the moving object that moves from the front to the back) in the region surrounded by the frame 22. As illustrated in FIG. 2, many motion vectors of blocks in such a region are directed downward in the diagram. In other words, in the case of the example of FIG. 2, a downward motion vector in the diagram indicates motion of the moving object that moves from the front to the back. Further, an image of such a block has a low encoding difficulty level. Accordingly, the quantization parameter adjuster 145 increases the quantization parameter for a block of the downward motion vector in the diagram (sets the quantization parameter to a larger value).

Doing so makes it possible for the quantization parameter adjuster 145 to reduce the image quality of the image of the moving object that moves in the direction in which the encoding difficulty level is low, on the basis of the motion vector. Thus, for example, in a case where an image includes a plurality of moving objects that move in directions different from each other, it is possible to suppress variations in image quality in the image, suppress a sense of discomfort caused by the variations in image quality, and suppress a reduction in subjective image quality of the entire image. In addition, it is possible to suppress an increase in the bit rate by setting of the quantization parameter. In particular, it is possible to adjust (set) the quantization parameter as described above on the basis of the motion vector obtained by the inter-prediction; therefore, it is not necessary for the quantization parameter adjuster 145 to detect the motion of the moving object separately from encoding, and it is possible to easily reduce the image quality of the image of the moving object that moves in the direction in which the encoding difficulty level is low on the basis of information obtained by encoding such as the HEVC.

It is to be noted that the direction of the motion vector is determined by any method. For example, in a case where a vertical direction component of the motion vector is negative (downward in the diagram) and sufficiently large as compared with a horizontal direction component, the direction of the motion vector may be determined to be downward in the diagram.

In addition, the direction of the motion vector indicating that the moving object is moving in the direction in which the encoding difficulty level is low (that is, in a predetermined direction corresponding to the motion direction of the moving object that moves in the direction in which the encoding difficulty level is low) differs depending on an angle of view (angle) and the like of the image. That is, the direction of the motion vector for increasing the quantization parameter (the predetermined direction described above) may be any direction corresponding to the direction in which the encoding difficulty level is low (the direction is not limited to the example in FIG. 2).

Further, instead of increasing the quantization parameter of the motion vector for the block of the motion vector in this “predetermined direction”, the quantization parameter for images of other blocks may be decreased. Alternatively, the quantization parameter for the images of the other blocks may be decreased while increasing the quantization parameter for the block of the motion vector in the “predetermined direction”. Even in these cases, it is possible to achieve effects similar to those in a case where the quantization parameter for the image of the moving object that moves in the direction in which the encoding difficulty level is low is increased. In addition, controlling the quantization parameter for the images of the other blocks makes it possible to suppress a difficulty in rate control using the target bit rate by such control of the quantization parameter.

In addition, for example, in a case where the direction of the motion vector of the image of the moving object is a predetermined direction corresponding to the motion direction of the moving object that moves in the direction in which the encoding difficulty level is high, the quantization parameter adjuster 145 may decrease the quantization parameter, and in a case where the direction of the motion vector of the image of the moving object is a predetermined direction corresponding to the motion direction of the moving object that moves in the direction in which the encoding difficulty level is low, the quantization parameter adjuster 145 may increase the quantization parameter.

Doing so makes it possible to suppress variations in image quality in the image, suppress a sense of discomfort caused by the variations in image quality, and suppress a reduction in subjective image quality of the entire image. In addition, it is possible to assign, to the image of the moving object that moves in the direction in which the encoding difficulty level is high, a bit rate assigned to the image of the moving object that moves in the direction in which the encoding difficulty level is low. This makes it possible to suppress a difficulty in rate control using the target bit rate by such control of the quantization parameter.

It is needless to say that, even in this case, the quantization parameter adjuster 145 may increase the adjustment amount of the quantization parameter with an increase in magnitude of motion of the moving object. For example, the quantization parameter adjuster 145 may increase the adjustment amount of the quantization parameter with an increase in a length of the motion vector. Doing so makes it possible to further suppress a reduction in subjective image quality of the entire image.

The quantization parameter setting unit 152 performs each processing described above as processing by the quantization parameter adjuster 145, which makes it possible to set the quantization parameter in accordance with the encoding difficulty level varying by the motion direction of the moving object specified on the basis of the direction of the motion vector of the image of the moving object, and to achieve effects similar to those described above in a case of the quantization parameter adjuster 145.

### <Adjustment Control of Encoding Parameter>

In addition, for example, the quantization parameter adjuster 145 may determine whether to adjust the quantization parameter in accordance with the direction of the motion vector of the image of the moving object. Such determination may be performed under any condition. For example, the quantization parameter adjuster 145 may determine to perform (or permit) adjustment of the quantization parameter with use of the motion vector in a case where each of the number of (blocks of) motion vectors in the direction in which the encoding difficulty level is high (also referred to as a difficult encoding direction) and the number of (blocks of) motion vectors in the direction in which the encoding difficulty level is low (also referred to as an easy encoding direction) is equal to or greater than a predetermined number.

Doing so makes it possible to perform adjustment of the quantization parameter for an image only in a case where a sufficient effect is achieved by adjusting the quantization parameter, and to suppress an increase in load on unnecessary processing.

In addition, in other words, for example, the quantization parameter adjuster 145 may determine to prohibit adjustment of the quantization parameter with use of the motion vector in a case where the number of (blocks of) motion vectors in the direction in which the encoding difficulty level is high (also referred to as difficult encoding direction) or the number of (blocks of) motion vectors in the direction in which the encoding difficulty level is low (also referred to as easy encoding direction) is smaller than the predetermined number.

Doing so makes it possible to prevent adjustment of the quantization parameter for an image from being performed in a case where a sufficient effect is not achieved by adjusting the quantization parameter, and to suppress an increase in load on unnecessary processing.

The adjustment determining unit 151 performs processing described above as processing by the quantization parameter adjuster 145, which makes it possible to suppress an increase in load on unnecessary processing by adjustment of the quantization parameter corresponding to the encoding difficulty level varying by the motion direction of the moving object specified on the basis of the direction of the motion vector of the image of the moving object.

### <Block Division>

In existing image encoding systems such as MPEG2 (Moving Picture Experts Group 2 (ISO/IEC 13818-2)) and AVC, encoding processing is executed per unit of processing called a macroblock. The macroblock is a block having a uniform size of 16×16 pixels. In contrast, in HEVC, encoding is executed per unit of processing (encoding unit) called a CU (Coding Units). The CU is a block having a variable size that is formed by recursively dividing an LCU (Largest Coding Unit), that is the largest encoding unit. The largest size of a selectable CU is 64×64 pixels. The smallest size of the selectable CU is 8×8 pixels. The CU having the minimum size is called a SCU (Smallest Coding Unit).

As a result of adopting the CU having a variable size in such a manner, in HEVC, it is possible to adaptively adjust the image quality and encoding efficiency in accordance with contents of the image. Prediction processing for predictive encoding is executed per unit of processing (unit of prediction) called a PU (Prediction Unit). The PU is formed by dividing a CU with one of several division patterns. In addition, the PU includes units of processing (prediction blocks) called PBs (Prediction Blocks) for each of luminance (Y) and color difference (Cb, Cr). Further, orthogonal transformation processing is executed per unit of processing (unit of transform) called a TU (Transform Unit). The TU is formed by dividing a CU or a PU to a certain depth. In addition, the TU includes units of processing (transform blocks) called TBs (Transform Blocks) for each of luminance (Y) and color difference (Cb, Cr).

### <Recursive Block Division>

Block division of a CU is performed by recursively repeating division of one block into four (=2×2) sub-blocks, resulting in formation of a tree structure in a quad-tree (Quad-Tree) form. One entire quad-tree is called a CTB (Coding Tree Block), and a logical unit corresponding to the CTB is called a CTU (Coding Tree Unit).

It is possible to specify the size of the LCU by a parameter encoded in a SPS (Sequence Parameter Se) or a PPS (Picture Parameter Set). The CU is formed by recursively dividing an LCU. A depth of division is variable. For example, for a flat image region such as blue sky, a CU having a larger size (that is, a smaller depth) may be set. In contrast, for a steep image region including many edges, a CU having a smaller size (that is, a greater depth) may be set. Then, each of the set CUs serves as a unit of processing in encoding processing.

### <Setting PU to CU>

The PU is a unit of processing for prediction processing including intra-prediction and inter-prediction. The PU is formed by dividing a CU using one of several division patterns. For the PU, eight division patterns are given. The eight division patterns include 2N×2N, 2N×N, N×2N, N×N, 2N×nU, 2N×nD, nL×2N, and nR×2N. Of these division patterns, two patterns, 2N×2N and N×N, are selectable for the intra-prediction (N×N is selectable only in the SCU). In contrast, for the inter-prediction, all the eight division patterns are selectable in a case where asymmetric motion partition is enabled.

### <Setting TU to CU>

The TU is a unit of processing for the orthogonal transformation processing. The TU is formed by dividing a CU (each PU in the CU for an intra CU) to a certain depth.

Typically, what block division is performed to set the above-described blocks such as CUs, PUs, and TUs to an image is determined on the basis of comparison of costs that affect encoding efficiency. For example, an encoder compares costs between one CU having 2M×2M pixels and four CUs each having M×M pixels. In a case where encoding efficiency is higher in setting the four CUs each having MM pixels, the encoder determines to divide the CU having 2M×2M pixels into the four CUs each having M×M pixels.

### <Scan Order of CUs and PUs>

Upon encoding an image, CTBs (or LCUs) set in a lattice pattern in the image (or a slice or a tile) are scanned in raster scan order. In one CTB, CUs are scanned in such a manner that the quad-tree from is traced from left to right and from top to bottom. Upon processing the current block, information of adjacent blocks above and on the left the current block is used as input information. The PUs are also scanned to be traced from left to right and from top to bottom.

### <Selection of TU Size>

The size of the TU is selected on the basis of a cost function. For example, encoding is performed on a trial basis, and an encoding error (Distortion) and an encoding rate (Rate) are used to calculate a cost (Cost) as indicated by the following equation (1).

Cost=Dstortion+λ·Rate (1)

The Cost for the size of each TU is determined, and the size of the TU for which the cost is the smallest is selected. In general, a value of a variable X varies on the basis of the quantization parameter QP used in encoding, and in a case where the quantization number is large, the value of the variable λ becomes large. Accordingly, in low-rate encoding, there is a tendency that higher priority is given to decreasing the encoding bit than to decreasing encoding noise of the image.

In general, in a case where the target bit rate is a high rate, the size of the TU that allows a large number of orthogonal transformation coefficients to be outputted tends to be accepted because of the nature of the cost function. Accordingly, a TU having a large size (Large TUs) is set for a region in which a distribution of textures is uniform. For example, in a case where the target bite rate is a high rate, the TU having a large size (Large TU) is set for a flat portion in which variations in pixel value are small, or a predetermined texture portion.

In contrast, in a case where the target bit rate is a low rate, in order to minimize a transmission cost of the orthogonal transformation coefficient, a CU having a small size (Small CU) or a TU having a small size (Small TU) is set for a uniform texture portion, and an image is formed only by a predicted image in many cases. That is, in this case, a TU having a large size (Large TU) is set only for a flat portion in which variations in pixel value are small.

Hereinafter, in some cases, description is given with use of a “block” as a partial region and a processing unit of an image (picture) (not a block of a processing unit). The “block” in this case indicates any partial region in a picture, and a size, a shape, characteristics, and the like of the block are not limited. That is, the “block” in this case includes, for example, any partial region (processing unit) such as a TB, a TU, a PB, a PU, a SCU, a CU, an LCU (CTB), a sub-block, a macroblock, a tile, or a slice.

### <Processing Unit of Each Processing>

In the image encoding unit 112, processing is performed using various blocks as processing units as described above. For example, processing such as subtraction of an input image and a predicted image in the operating unit 132 and encoding by the encoding unit 135 is performed using CUs as processing units. In addition, for example, processing such as orthogonal transformation by the orthogonal transformer 133, quantization by the quantizer 134, inverse quantization by the inverse quantizer 137, and inverse orthogonal transformation by the inverse orthogonal transformer 138 is performed using TUs as processing units. Further, for example, intra-prediction by the intra-predicting unit 142 and inter-prediction by the inter-predicting unit 143 are performed using PUs as processing units.

### <Processing Unit and Motion Vector for Quantization Parameter Setting>

Accordingly, the quantization parameter adjuster 145 (the quantization parameter setting unit 152) sets the quantization parameter for each TU. Note that, as described above, the PU and the TU do not necessarily coincide with each other. It is also conceivable that one PU coincides with a plurality of TUs. Conversely, it is also conceivable that one TU coincides with a plurality of PUs. Further, it is also conceivable that a ratio of PU and TU is not a ratio of 1:N (N is a natural number) or N:1. For example, a portion of the PU may coincide with a portion of the TU.

That is, in a case where all the motion vectors of the PUs overlapping the TU are used for setting the quantization parameter for the TU, it is conceivable that a plurality of motion vectors is assigned to one TU. In such a case, the quantization parameter adjuster 145 (the quantization parameter setting unit 152) may adjust (set) the quantization parameter using the plurality of motion vectors. For example, the quantization parameter adjuster 145 (the quantization parameter setting unit 152) may synthesize the plurality of motion vectors, and adjust (set) the quantization parameter on the basis of a direction of the thus-obtained synthesized motion vector.

In addition, for example, the quantization parameter adjuster 145 (the quantization parameter setting unit 152) may select one of the plurality of motion vectors and adjust (set) the quantization parameter on the basis of the direction of the selected motion vector. The motion vector is selected by any method. For example, a motion vector having the longest length may be selected, or a motion vector closest to the direction in which the encoding difficulty level is high may be selected. It is needless to say that any other method may be used.

It is to be noted that in a case where one PU overlaps the TU, the motion vector of the PU may be assigned to the TU irrespective of whether or not the TU and the PU coincide with each other. The motion vector is assigned to the TU (a method of selecting the motion vector used for setting of the quantization parameter) by any method, and the method is not limited to the examples described above. For example, the motion vector of a PU around the TU (a PU that does not overlap the TU), may also be usable.

It is to be noted that it is possible for the processing unit for quantization by the quantizer 134 to have any size. For example, in a case of an encoding system other than HEVC, a block other than the TU may be used as a processing unit. Accordingly, it is also possible for the processing unit for adjusting the quantization parameter by the quantization parameter adjuster 145 (the quantization parameter setting unit 152) to have any size. For example, in the case of an encoding system other than HEVC, a block other than the TU may be used as a processing unit.

### <Transmission of Quantization Parameter>

Incidentally, the quantization parameter set by the quantization parameter adjuster 145 is added to encoded data in the encoding unit 135 by control of the encoding controller 146. That is, the quantization parameter adjusted as described above is added to a bit stream and supplied to a decoding side (a decoding device or the like). Thus, it is possible for a device on the decoding side (such as the decoding device) to decode the bit stream with use of the quantization parameter.

It is to be noted that, as described above, in a case where the quantization parameter adjuster 145 adjusts the quantization parameter for each TU, the adjusted quantization parameter is added to the bit stream for each TU. That is, in this case, the adjusted quantization parameter is added to the bit stream and supplied to the decoding side (the decoding device or the like) similarly to a case of a normal quantization parameter conforming to the HEVC standard. Accordingly, it is possible for the device on the decoding side (the decoding device or the like) to decode the encoded data (the bit stream) generated with use of the quantization parameter transmitted for each TU (it is possible to inversely quantize the quantization coefficient obtained from the bit stream) by a decoding method conforming to HEVC. That is, it is possible to perform decoding by a more general-purpose decoder; therefore, it is not necessary to prepare a dedicated decoder, and it is possible to implement application of the present technology more easily.

It is to be noted that, actually, an initial value of the quantization parameter is added to a picture parameter set, a slice header, or the like, and a difference value from the initial value is added for each TU. However, the quantization parameter is substantially equal as information; therefore, for convenience of explanation, description is given assuming that the quantization parameter set by applying the present technology is added to the TU.

In addition, the quantization parameter may be added to an optional position of the encoded data. For example, in a case where encoding is performed by a method that does not conform to HEVC, it is possible to store the quantization parameter in an optional position of the encoded data (or metadata).

### <Inter-Prediction>

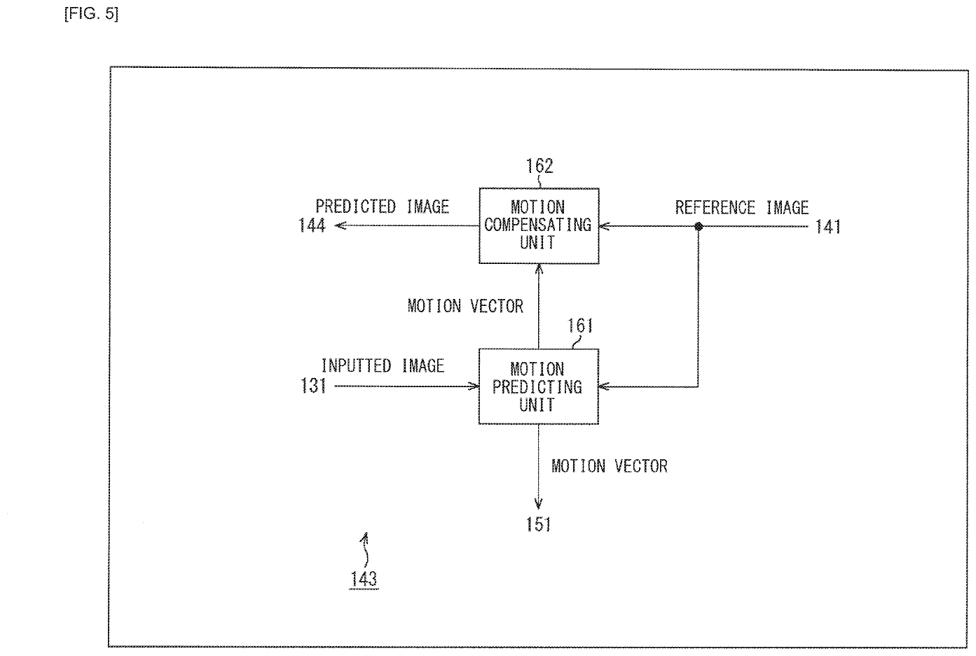

FIG. 5 is a block diagram illustrating a main configuration example of the inter-predicting unit 143. As illustrated in FIG. 5, the inter-predicting unit 143 includes a motion predicting unit 161 and a motion compensating unit 162.

The motion predicting unit 161 performs processing relating to motion prediction. In a case where the motion predicting unit 161 obtains an input image from the screen sorting buffer 131, the motion predicting unit 161 obtains a reference image from the frame memory 141, and performs motion prediction with use of these images. Then, the motion predicting unit 161 supplies a motion vector obtained by the motion prediction to the motion compensating unit 162. In addition, the motion predicting unit 161 supplies the motion vector to the quantization parameter adjuster 145 (the adjustment determining unit 151). The quantization parameter adjuster 145 determines whether or not to adjust the quantization parameter as described above, or performs adjustment with use of the motion vector.

The motion compensating unit 162 obtains, from the frame memory 141, a reference image at a position corresponding to the motion vector supplied from the motion predicting unit 161, and supplies the reference image as a predicted image in the intra-prediction mode to the predicted image selecting unit 144.

It is to be noted that the motion predicting unit 161 and the motion compensating unit 162 perform these processing for each PU.

### <Flow of Image Processing>

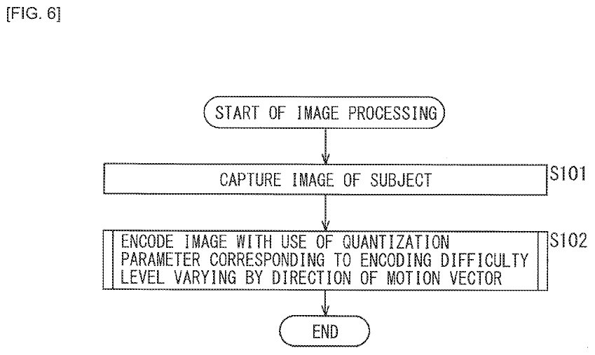

Next, description is given of processing executed by the image processing apparatus 100 as described above. An example of a flow of image processing executed by the image processing apparatus 100 is described with reference to a flow chart in FIG. 6.

When the image processing starts, the imaging unit 111 (FIG. 3) of the image processing apparatus 100 captures an image of a subject to obtain a captured image in step S101.

In step S102, the image encoding unit 112 performs image encoding processing, and encodes the captured image obtained by processing in the step S101 with use of the quantization parameter corresponding to the encoding difficulty level varying by the direction of the motion vector to generate encoded data (a bit stream). The image encoding unit 112 outputs the generated bit stream to outside of the image processing apparatus 100. The bit stream outputted from the image processing apparatus 100 is transmitted to a decoder through, for example, an optional transmission path. In addition, the bit stream may be stored in an optional storage medium, for example.

When processing in the step S102 ends, the image processing ends.

### <Flow of Image Encoding Processing>

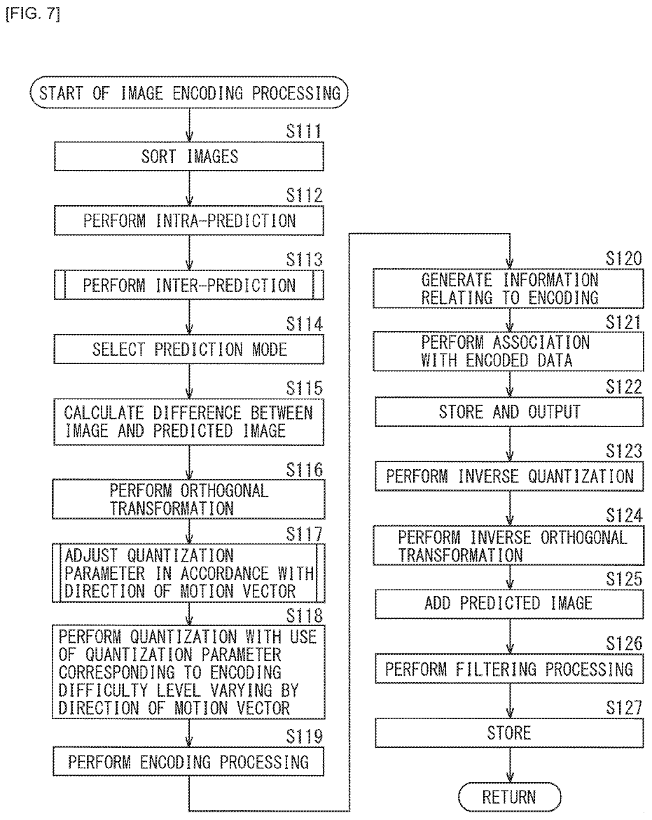

Next, an example of a flow of the image encoding processing executed in the step S102 of FIG. 6 is described with reference to a flow chart in FIG. 7.

When the image encoding processing starts, the screen sorting buffer 131 (FIG. 4) of the image encoding unit 112 sorts the order of the frame images from display order to encoding order in step S111. In addition, at this time, the screen sorting buffer 131 also performs processing such as block division setting.

In step S112, the intra-predicting unit 142 performs intra-prediction to generate a predicted image in the intra-prediction mode. In addition, in step S113, the inter-predicting unit 143 performs inter-prediction processing to generate a predicted image in the inter-prediction mode. At this time, the inter-predicting unit 143 also generates the motion vector for each PU by motion prediction. In step S114, the predicted image selecting unit 144 calculates a cost function for the precited image in each of the prediction modes, and selects an optimal prediction mode (the predicted image in the optimal prediction mode) on the basis of the cost function.

In step S115, the operating unit 132 calculates a difference between the input image obtained by the processing in the step S111 and the predicted image selected by the processing in the step S114. In step S116, the orthogonal transformer 133 performs orthogonal transformation on residual data obtained by processing in the step S115. In step S117, the quantization parameter adjuster 145 performs quantization control processing, and adjusts the quantization parameter in accordance with the direction of the motion vector obtained by processing in the step S113.

In step S118, the quantizer 134 quantizes an orthogonal transformation coefficient obtained by processing in the step S116 with use of the quantization parameter, obtained by processing in step S117, corresponding to the encoding difficulty level varying by the direction of the motion vector. In step S119, the encoding unit 135 encodes a quantization coefficient obtained by processing in the step S118 to generate encoded data.

In step S120, the encoding controller 146 obtains necessary information from respective processing units and uses the information to generate information relating to encoding as metadata. In step S121, the encoding unit 135 associates the metadata (the information relating to encoding) obtained by processing in the step S120 with the encoded data obtained by processing in the step S119. In step S122, the storage buffer 136 stores the encoded data (the bit stream) with which the metadata is associated by processing in the step S121, and outputs the encoded data at a predetermined timing.

In step S123, the inverse quantizer 137 inversely quantizes the quantization coefficient obtained by processing in the step S118 by a method corresponding to quantization in the step S118. In step S124, the inverse orthogonal transformer 138 performs inverse orthogonal transformation on the orthogonal transformation coefficient obtained by processing in the step S123 by a method corresponding to orthogonal transformation in the step S116. In step S125, the operating unit 139 adds residual data obtained by processing in the step S124 and the predicted image selected by processing in the step S114.

In step S126, the filter 140 performs predetermined filtering processing (for example, deblocking filtering, sample adaptive offset, and the like) on a reconstructed image obtained by processing in the step S125. In step S127, the frame memory 141 stores a decoded image obtained by processing in the step S126. This decoded image may be usable for intra-prediction or inter-prediction as a reference image in encoding of other blocks.

When processing in the step S127 ends, the image encoding processing ends, and the processing returns to FIG. 6.

### <Flow of Inter-Prediction Processing>

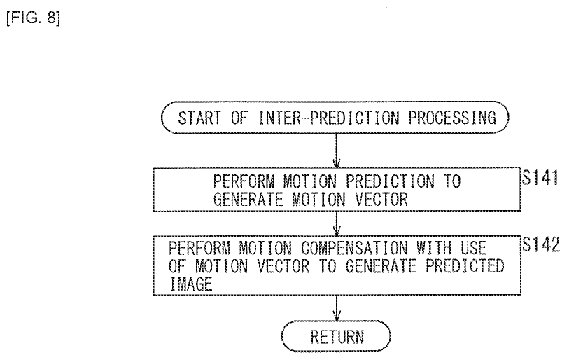

Next, referring to the flow chart of FIG. 8, an exemplary flow of the executed in the step S113 of FIG. 7 will be described.

When the inter-prediction processing starts, in step S141, the motion predicting unit 161 (FIG. 5) of the inter-predicting unit 143 performs motion prediction on the current blocks (TUs of the processing target) with use of the input image and the reference image to generate a motion vector. The motion predicting unit 161 performs similar processing for each of the TUs.

In step S142, the motion compensating unit 162 performs motion compensation with use of the motion vector obtained in step S161 to generate a predicted image by inter-prediction. The motion compensating unit 162 performs similar processing for each of the TUs.

When the processing in the step S142 ends, the inter-prediction processing ends, and the processing returns to FIG. 7.

### <Flow of Quantization Control Processing>

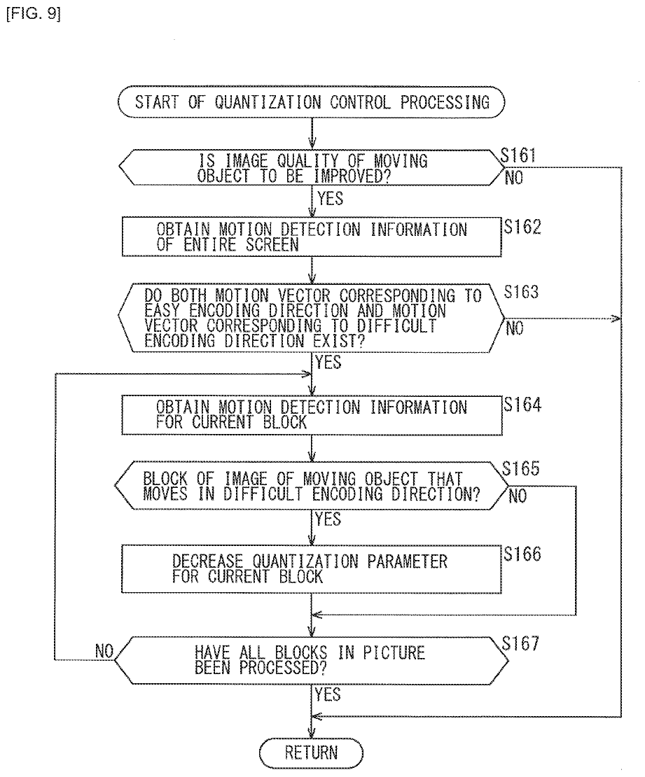

Next, an example of a flow of quantization control processing executed in the step S117 of FIG. 7 is described with reference to a flow chart in FIG. 9.

When the quantization control processing starts, the adjustment determining unit 151 (FIG. 4) of the quantization parameter adjuster 145 determines whether or not to improve image quality of the moving object in step S161. For example, in a case of a mode in which adjustment of the quantization parameter is performed (for example, in a case where adjustment of the quantization parameter is permitted (or specified) by a control flag or the like), the image quality of the moving object is determined to be improved, and the processing proceeds to step S162.

In the step S162, the adjustment determining unit 151 obtains motion detection information (the motion vector) of an entire screen from the inter-predicting unit 143.

In step S163, the adjustment determining unit 151 determines, on the basis of the obtained motion detection information (the motion vector) of the entire screen, whether or not both a motion vector corresponding to the easy encoding direction and a motion vector corresponding to the difficult encoding direction (a predetermined number or more of motion vectors) exist. In a case where it is determined that both the motion vector corresponding to the easy encoding direction and the motion vector corresponding to the difficult encoding direction (the predetermined number or more of motion vectors) exist, the processing proceeds to step S164. That is, in this case, it is determined to perform adjustment of the quantization parameter.

In the step S164, the quantization parameter setting unit 152 obtains motion detection information (a motion vector) for a current block (a processing target TU).

In step S165, the quantization parameter setting unit 152 determines, with use of the motion vector obtained in the step S164, whether or not the current block is a block of an image of a moving object that moves in the difficult encoding direction. In a case where it is determined from the motion vector that the current block is the block of the image of the moving object that moves in the difficult encoding direction, the processing proceeds to step S166.

In step S166, the quantization parameter setting unit 152 decreases the quantization parameter for the current block (sets the quantization parameter for the current block to a lower value). When processing in the step S166 ends, the processing proceeds to step S167. In addition, in the step S165, in a case where it is determined from the direction of the motion vector that the current block is not the block of the image of the moving object that moves in the difficult encoding direction, the processing proceeds to step S167.

In the step S167, the quantization parameter setting unit 152 determines whether or not all blocks in the picture have been processed. In a case where it is determined that an unprocessed block for which the quantization parameter has not been adjusted exists, the processing returns to the step S164, and subsequent processing is repeated.

In addition, in the step S167, in a case where it is determined that all the blocks in the picture have been processed, the quantization control processing ends, and the processing returns to FIG. 7.

In addition, in the step S161, in a case where it is determined that the mode is not the mode in which adjustment of the quantization parameter is performed (for example, in a case where adjustment of the quantization parameter is prohibited by the control flag or the like), the image quality of the moving object is determined not to be improved, and the quantization control processing ends. The processing returns to FIG. 7.

In addition, in the step S163, in a case where it is determined that both the motion vector in the easy encoding direction and the motion vector in the difficult encoding direction (the predetermined number or more of motion vectors) do not exist, the quantization control processing ends, and the processing returns to FIG. 7.

Executing each processing as described above makes it possible for the image processing apparatus 100 to quantize the image of the moving object included in the encoding target image with use of the quantization parameter corresponding to the encoding difficulty level varying by the motion direction of the moving object specified on the basis of the direction of the motion vector of the image of the moving object in the encoding target image.

Doing so makes it possible to make the image quality of the moving object independent of the motion direction of the moving object. This makes it possible to more appropriately assign the bit rate, and suppress a reduction in the subjective image quality of the entire image with respect to the target bit rate (a reduction in encoding efficiency with respect to the subjective image quality of the entire image). In addition, in a case where the image includes a plurality of moving objects that move in directions different from each other, it is possible to suppress variations in image quality in the image, suppress a sense of discomfort caused by the variations in image quality, and suppress a reduction in subjective image quality of the entire image.

### 3. Second Embodiment

### <Image Analysis for Motion Direction Detection>

In the description given in first embodiment, the motion direction of the moving object is detected on the basis of the motion vector, but this is not limitative, and the motion direction of the moving object may be detected without using the motion vector.

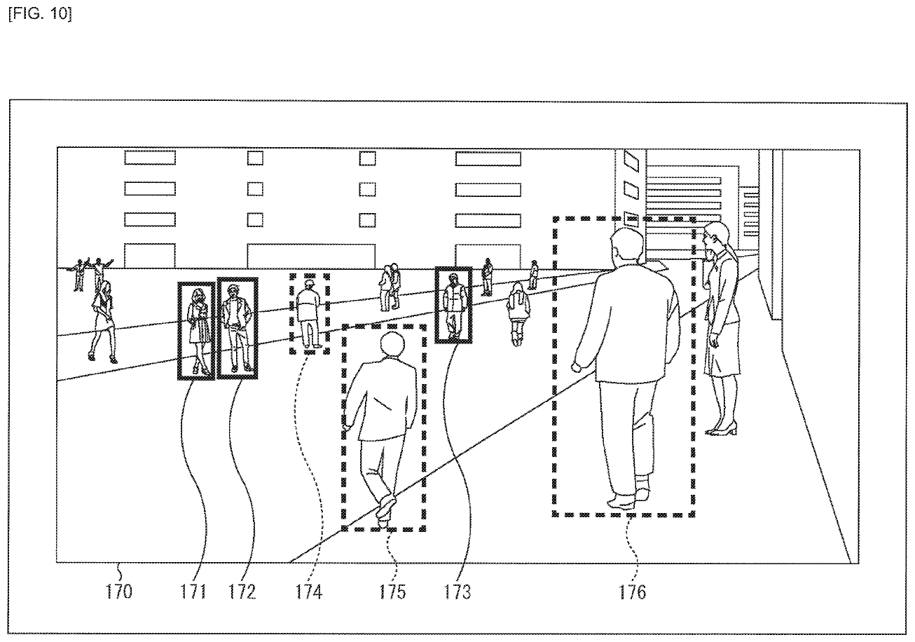

For example, the moving object may be detected by analyzing the encoding target image. For example, in a case of an image 170 illustrated in FIG. 10, a plurality of moving objects (for example, humans) are moving in respective directions. This image may be analyzed to detect moving objects (for example, humans) from this image and further detect moving directions of the respective moving objects.

In an example in FIG. 10, square frames are set to surround detected moving objects. Among the square frames, each of the moving objects surrounded by square frames 171 to 173 indicated by solid lines is a moving object that moves from the back to the front of the image. In addition, each of the moving objects surrounded by the square frames 174 to 176 indicated by dotted lines is a moving object that moves from the front to the back of the image.

The moving objects and motion directions thereof are detected by any method. For example, a person whose position changes may be detected as a moving object by analyzing images of a plurality of frames, and the moving direction of the person may be determined by a change in the size of an image of the moving object (or a square frame assigned to the moving object). For example, a moving object of which the image becomes larger with the elapse of time may be determined as a moving object that moves from the back to the front, and a moving object of which the image becomes smaller with the elapse of time may be determined as a moving object that moves from the front to the back.

In addition, for example, orientation of a person (a moving object) may be detected by face detection, thereby detecting the moving direction of the person. For example, a person (a moving object) whose face is detected may be determined as a moving object from the back to the front, and a person (a moving object) whose face is not detected may be determined as a moving object from the front to the back. The face detection may be performed on the basis of a single frame image or on the basis of a plurality of frame images.

As described above, analyzing the encoding target image and detecting the motion direction of the moving object makes it possible to adjust the quantization parameter in accordance with the encoding difficulty level varying by the motion direction of the moving object and perform quantization with use of the adjusted quantization parameter, as in the first embodiment. This makes it possible to suppress a reduction in image quality as in the first embodiment.

It is to be noted that, in the method of detecting the motion direction of the moving object with use of the motion vector described in the first embodiment, the direction of the motion vector corresponding to the difficult encoding direction or the easy encoding direction is determined depending on the angle (angle of view) of the captured image; therefore, the information of the angle of view, information that specifies the direction of the motion vector corresponding to the difficult encoding direction or the easy encoding direction, and the like are necessary. In addition, depending on the angle of view, it may be considered difficult to specify the direction of the motion vector corresponding to the difficult encoding direction or the easy encoding direction. For example, in a case where the moving object moves in an optional direction as in the image 170 in FIG. 10, the direction of the motion vector corresponding to the difficult encoding direction or the easy encoding direction is not necessarily determined to be a predetermined direction.

As described above, the encoding target image is analyzed to detect the motion direction of the moving object, which makes it possible to adjust the quantization parameter in accordance with the encoding difficulty level varying by the motion direction of the moving object without using the motion vector, and to suppress a reduction in image quality in a usage situation different from that in the first embodiment.

For example, coping with both the method of the first embodiment and the method of the present embodiment makes it possible to adjust the quantization parameter in accordance with the encoding difficulty level varying by the motion direction of the moving object in more various use situations, and to suppress a reduction in image quality.

### <Image Processing Apparatus>

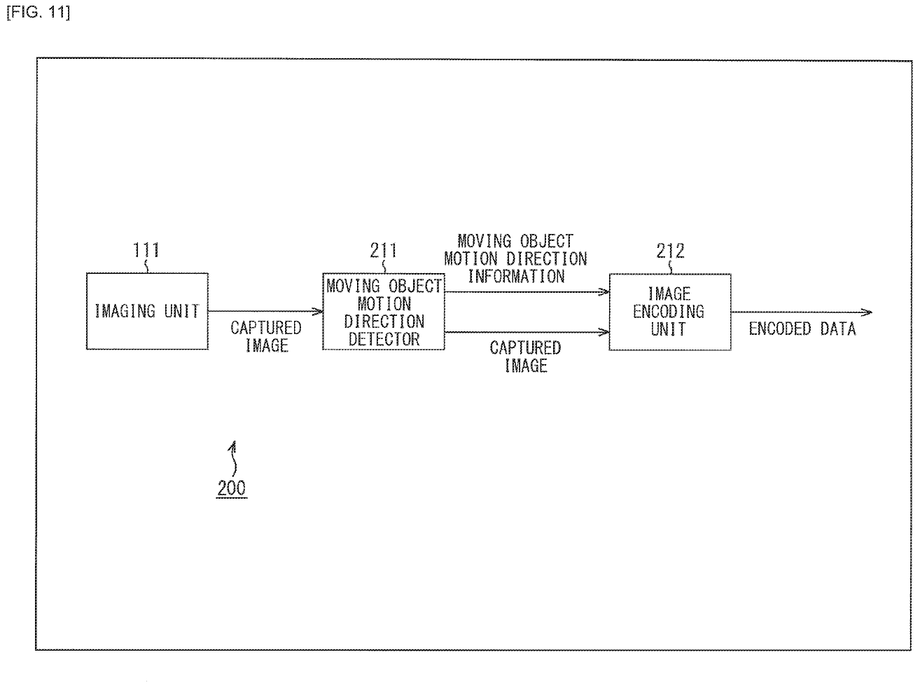

FIG. 11 is a diagram illustrating a main configuration example of an embodiment of an image processing apparatus to which the present technology is applied. An image processing apparatus 200 illustrated in FIG. 11 is an apparatus basically similar to the image processing apparatus 100, and captures an image of a subject, encodes the obtained captured image, and outputs the encoded image. Note that, in encoding, the image processing apparatus 200 performs quantization to which the present technology as described above is applied. As illustrated in FIG. 11, the image processing apparatus 200 includes an imaging unit 111, a moving object motion direction detector 211, and an image encoding unit 212.

The moving object motion direction detector 211 detects the motion direction of the moving object and generates moving object motion direction information indicating the motion direction of the moving object. For example, the moving object motion direction detector 211 analyzes the captured image obtained by the imaging unit 111, detects the motion direction of the moving object included in the image, and generates moving object motion direction information indicating the motion direction of the moving object. The moving object motion direction detector 211 supplies the generated moving object motion direction information and the captured image obtained from the imaging unit 111 to the image encoding unit 212.

The moving object motion direction detector 211 may have any configuration, and may include, for example, a CPU, a ROM, a RAM, and the like, and the CPU may load a program or data stored in the ROM and the like into the RAM and execute the program or the data, thereby performing processing.

The image encoding unit 212 is a processing unit basically similar to the image encoding unit 112, and performs similar processing. Note that the image encoding unit 212 obtains the moving object motion direction information and the captured image from the moving object motion direction detector 211. Then, the image encoding unit 212 adjusts the quantization parameter on the basis of the motion direction of the moving object indicated by the moving object motion direction information. Then, the image encoding unit 212 performs quantization with use of the quantization parameter in encoding of the captured image.

Accordingly, it is possible for the image encoding unit 212 to adjust the quantization parameter in accordance with the encoding difficulty level varying by the motion direction of the moving object without using the motion vector. This makes it possible for the image encoding unit 212 to suppress a reduction in image quality in a usage situation different from a usage situation applicable in a case where the quantization parameter is adjusted with use of the motion vector.

The image encoding unit 212 outputs the thus-generated encoded data (the bit stream) to outside of the image processing apparatus 200.

The image encoding unit 212 may have any configuration, and may include, for example, a CPU, a ROM, a RAM, and the like, and the CPU may load a program and data stored in the ROM and the like into the RAM and execute the program and the data, thereby performing processing.

### <Moving Object Motion Direction Detector>

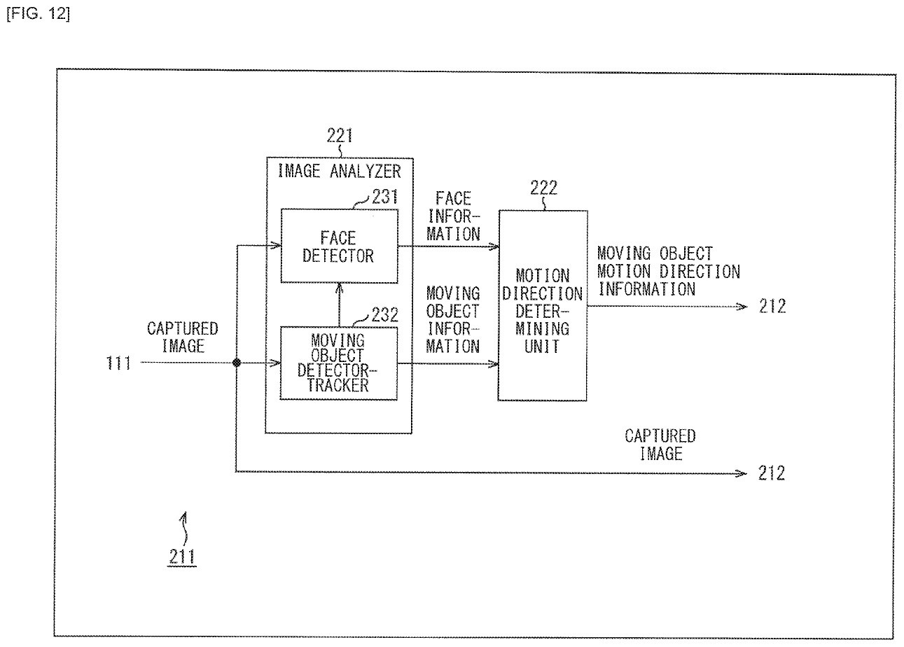

FIG. 12 is a block diagram illustrating a main configuration example of the moving object motion direction detector 211 in FIG. 11. As illustrated in FIG. 12, the moving object motion direction detector 211 includes an image analyzer 221 and a motion direction determining unit 222.

The image analyzer 221 analyzes the captured image supplied from the imaging unit 111. Such analysis is performed by any method. For example, the image analyzer 221 includes a face detector 231 and a moving object detector-tracker 232.

The face detector 231 detects an image of a face of a person included in the captured image. Such face detection is performed by any method. The face detector 231 supplies a result of the detection (face information) to the motion direction determining unit 222.

The moving object detector-tracker 232 detects a moving object included in the captured image, and further performs processing of tracking the moving object. For example, the moving object detector-tracker 232 sets a frame (having any shape) or the like for the detected moving object as in the image 170 in FIG. 10, and adjusts a position of the frame to track the moving object that is moving (to continue to surround the moving object even if the moving object moves). The moving object detector-tracker 232 supplies, to the motion direction determining unit 222, moving object information indicating a result of detection of the moving object and a result of tracking of the moving object.

The motion direction determining unit 222 determines the motion direction of the moving object on the basis of these information (at least one of the face information or the moving object information). The motion direction determining unit 222 generates moving object motion direction information, which is information indicating a result of such determination, that is, the motion direction of the moving object, and supplies the moving object motion direction information to the image encoding unit 212.

That is, for example, the moving object motion direction detector 211 detects an image of a face of a person included in the encoding target image (the captured image), and detects the motion direction of the moving object by the detected orientation of the face. This makes it possible for the moving object motion direction detector 211 to easily determine the motion direction of the moving object included in the captured image from the captured image (without any other information).

In addition, for example, the moving object motion direction detector 211 detects the motion direction of the moving object by tracking the moving object in the encoding target image (the captured image). This makes it possible for the moving object motion direction detector 211 to easily determine the motion direction of the moving object included in the captured image from the captured image (without any other information).

It is to be noted that the captured image inputted to the moving object motion direction detector 211 is also supplied to the image encoding unit 212.

### <Image Encoding Unit>

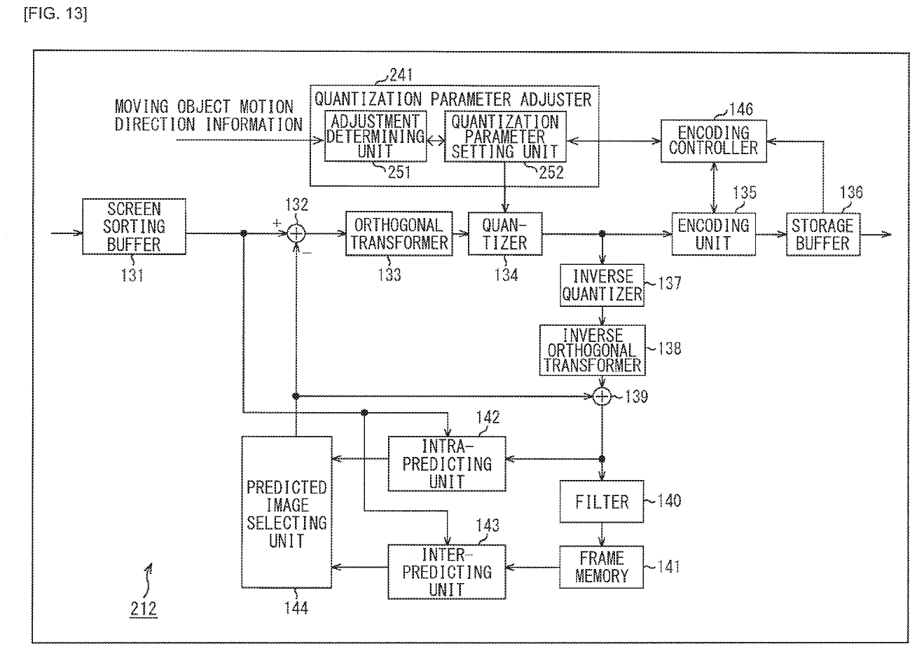

FIG. 13 is a block diagram illustrating a main configuration example of the image encoding unit 212 in FIG. 11. As illustrated in FIG. 13, the image encoding unit 212 has a configuration basically similar to the image encoding unit 112 (FIG. 4) and performs similar processing. Description of portions common to these image encoding units is omitted.

The image encoding unit 212 includes a quantization parameter adjuster 241 instead of the quantization parameter adjuster 145 of the image encoding unit 112.

The quantization parameter adjuster 241 sets the quantization parameter on the basis of the moving object motion direction information that is information relating to the motion direction of moving object in the encoding target image. That is, the quantization parameter adjuster 241 differs from the quantization parameter adjuster 145 in that the quantization parameter adjuster 241 does not obtain the motion vector from the inter-predicting unit 143 (does not use the motion vector). In other words, the quantization parameter adjuster 241 performs processing basically similar to that in the quantization parameter adjuster 145, except that the moving object motion direction information is used instead of the motion vector.

For example, the quantization parameter adjuster 241 adjusts (sets) the quantization parameter used by the quantizer 134 and the inverse quantizer 137 on the basis of the moving object motion direction information (the encoding difficulty level varying by the motion direction of the moving object in the encoding target image specified by the moving object motion direction information).

It is to be noted that it is also possible for the quantization parameter adjuster 241 to obtain information relating to the buffering amount of the storage buffer 136, and the like through the encoding controller 146, adjust (set) the quantization parameter on the basis of the information, and perform rate control of the bit stream outputted from the image encoding unit 112. In addition, the quantization parameter adjuster 145 supplies information relating to the set quantization parameter to the encoding controller 146.

As illustrated in FIG. 13, the quantization parameter adjuster 241 includes an adjustment determining unit 251 and a quantization parameter setting unit 252. The adjustment determining unit 251 determines whether or not to adjust the quantization parameter, on the basis of the moving object motion direction information (the motion direction of the moving object) supplied from the moving object motion direction detector 211. The adjustment determining unit 251 supplies information indicating a result of such determination and the moving object motion direction information to the quantization parameter setting unit 252.

In a case where the adjustment determining unit 251 determines to adjust the quantization parameter, the quantization parameter setting unit 252 adjusts (sets) the quantization parameter in accordance with the direction of the motion vector. For example, the quantization parameter setting unit 252 adjusts an initial quantization parameter set for each picture or each slice in accordance with the moving object motion direction information (the encoding difficulty level varying by the motion direction of the moving object specified on the basis of the moving object motion direction information). In addition, for example, in accordance with the encoding difficulty level varying by the motion direction of the moving object specified on the basis of the direction of the motion vector, the quantization parameter setting unit 252 further adjusts the quantization parameter that has been adjusted in accordance with the rate control and the like.

In a case where the adjustment determining unit 251 determines not to adjust the quantization parameter, the quantization parameter setting unit 252 omits (skips) the adjustment (setting) of the quantization parameter in accordance with such moving object motion direction information. That is, the value of quantization parameter in this case is an initial value set for each picture or each slice, or a value adjusted in accordance with rate control and the like.

The quantization parameter setting unit 252 supplies the set quantization parameter to the quantizer 134. The quantizer 134 performs quantization with use of the quantization parameter. That is, the quantizer 134 quantizes the image of the moving object included in the encoding target image with use of the quantization parameter corresponding to the encoding difficulty level varying by the motion direction of the moving object specified on the basis of the moving object motion direction information. It is to be noted that it is also possible for the quantization parameter setting unit 252 to obtain information relating to the buffering amount of the storage buffer 136, and the like through the encoding controller 146 and adjust (set) the quantization parameter as the rate control of the bit stream on the basis of the information. In addition, the quantization parameter setting unit 252 supplies information relating to the set quantization parameter to the encoding controller 146.

### <Operation Relating to Quantization Processing>

In the image encoding unit 212 having a configuration as described above, it is possible for the quantization parameter adjuster 241 and the quantizer 134 to basically perform processing similar to processing described above in <1. Control of Quantization>. Note that the quantization parameter adjuster 145 sets the quantization parameter on the basis of the motion direction of the moving object in the encoding target image specified on the basis of the moving object motion direction information. In addition, the quantizer 134 quantizes the image of the moving object with use of the quantization parameter set by the quantization parameter adjuster 241.

For example, in a case where the motion direction of the moving object indicated by the moving object motion direction information is in the direction in which the encoding difficulty level is high, the quantization parameter adjuster 241 decreases the quantization parameter for the image of the moving object (sets the quantization parameter to a smaller value than a value in a case other than the case).

Doing so makes it possible for the quantization parameter adjuster 241 to suppress a reduction in image quality of the image of the moving object that moves in the direction in which the encoding difficulty level is high on the basis of the moving object motion direction information. In particular, it is possible to adjust (set) the quantization parameter on the basis of the motion direction of the moving object without using the motion vector, which makes it possible for the quantization parameter adjuster 241 to suppress a reduction in image quality of the image of the moving object that moves in the direction in which the encoding difficulty level is high regardless of the angle of view (angle). Accordingly, it is possible to suppress a reduction in image quality in a usage situation different from that in the first embodiment.

It is to be noted that, instead of decreasing the quantization parameter for the image of the moving object that moves in the direction in which the encoding difficulty level is high, the quantization parameter adjuster 241 may increase the quantization parameter for another image. Alternatively, the quantization parameter adjuster 241 may increase the quantization parameter for another image while decreasing the quantization parameter for the image of the moving object that moves in the direction in which the encoding difficulty level is high. Even in these cases, it is possible to achieve effects similar to those in a case where the quantization parameter for the image of the moving object that moves in the direction in which the encoding difficulty level is high is decreased. In addition, control of the quantization parameter for another image makes it possible to suppress a difficulty in rate control using the target bit rate by such control of the quantization parameter.

In addition, for example, in a case where the motion direction of the moving object is in the direction in which the encoding difficulty level is low, the quantization parameter adjuster 241 may increase the quantization parameter (may set the quantization parameter to a larger value than a value in a case other than the case). Doing so makes it possible for the quantization parameter adjuster 241 to reduce image quality of the image of the moving object that moves in the direction in which the encoding difficulty level is low on the basis of the moving object motion direction information. Accordingly, for example, in a case where an image includes a plurality of moving objects that move in directions different from each other, it is possible to suppress variations in image quality in the image, suppress a sense of discomfort caused by the variations in image quality, and suppress a reduction in subjective image quality of the entire image. In particular, it is possible to adjust (set) the quantization parameter on the basis of the motion direction of the moving object without using the motion vector, which makes it possible for the quantization parameter adjuster 241 to reduce image quality of the image of the moving object that moves in the direction in which the encoding difficulty level is low regardless of the angle of view (angle). Accordingly, it is possible to suppress a reduction in image quality in a usage situation different from that in the first embodiment.

It is to be noted that, instead of increasing the quantization parameter for the image of the moving object that moves in the direction in which the encoding difficulty level is low, the quantization parameter adjuster 241 may decrease the quantization parameter for another image. Alternatively, the quantization parameter adjuster 241 may decrease the quantization parameter for another image while increasing the quantization parameter for the image of the moving object that moves in the direction in which the encoding difficulty level is low. Even in these cases, it is possible to achieve effects similar to those in a case where the quantization parameter for the image of the moving object that moves in the direction in which the encoding difficulty level is low is increased. In addition, control of the quantization parameter for another image makes it possible to suppress a difficulty in rate control using the target bit rate by such control of the quantization parameter.

Further, for example, the quantization parameter adjuster 145 may decrease the quantization parameter in a case where the motion direction of the moving object is in the direction in which the encoding difficulty level is high, and may increase the quantization parameter in a case where the motion direction of the moving object is in the direction in which the encoding difficulty level is low.

Doing so makes it possible to suppress variations in image quality in the image, suppress a sense of discomfort by the variations in image quality, and suppress a reduction in subjective image quality of the entire image. In addition, it is possible to assign, to the image of the moving object that moves in the direction in which the encoding difficulty level is high, a bit rate assigned to the image of the moving object that moves in the direction in which the encoding difficulty level is low. This makes it possible to suppress a difficulty in rate control using the target bit rate by such control of the quantization parameter.

It is needless to say that, even in this case, the quantization parameter adjuster 241 may further increase the adjustment amount of the quantization parameter with an increase in magnitude of motion of the moving object. Doing so makes it possible to further suppress a reduction in subjective image quality of the entire image.

The quantization parameter setting unit 252 performs each processing described above as processing by the quantization parameter adjuster 241, which makes it possible to set the quantization parameter in accordance with the encoding difficulty level varying by the motion direction of the moving object specified on the basis of the direction of the motion vector of the image of the moving object, and to achieve effects similar to those described above in a case of the quantization parameter adjuster 241.

### <Adjustment Control of Encoding Parameter>

In addition, for example, the quantization parameter adjuster 241 may determine whether to adjust the quantization parameter in accordance with the moving object motion direction information. Such determination may be performed under any condition. For example, the quantization parameter adjuster 241 may determine to perform (or permit) adjustment of the quantization parameter with use of the moving object motion direction information in a case where each of the number of moving objects that move toward the direction in which the encoding difficulty level is high (also referred to as the difficult encoding direction) and the number of moving objects that move toward the direction in which the encoding difficulty level is low (also referred to as the easy encoding direction) are equal to or greater than a predetermined number.

Doing so makes it possible to perform adjustment of the quantization parameter for an image only in a case where a sufficient effect is achieved by adjusting the quantization parameter, and to suppress an increase in load on unnecessary processing.

In addition, in other words, for example, the quantization parameter adjuster 145 may determine to prohibit adjustment of the quantization parameter with use of the moving object motion direction information in a case where the number of moving objects toward the direction in which the encoding difficulty level is high (also referred to as difficult encoding direction) or the number of moving objects toward the direction in which the encoding difficulty level is low (also referred to as easy encoding direction) is smaller than the predetermined number.

Doing so makes it possible to prevent adjustment of the quantization parameter for an image from being performed in a case where a sufficient effect is not achieved by adjusting the quantization parameter, and to suppress an increase in load on unnecessary processing.

The adjustment determining unit 251 performs processing described above as processing by the quantization parameter adjuster 241, which makes it possible to suppress an increase in load on unnecessary processing by adjustment of the quantization parameter corresponding to the encoding difficulty level varying by the motion direction of the moving object specified on the basis of the moving object motion direction information.

### <Flow of Image Processing>

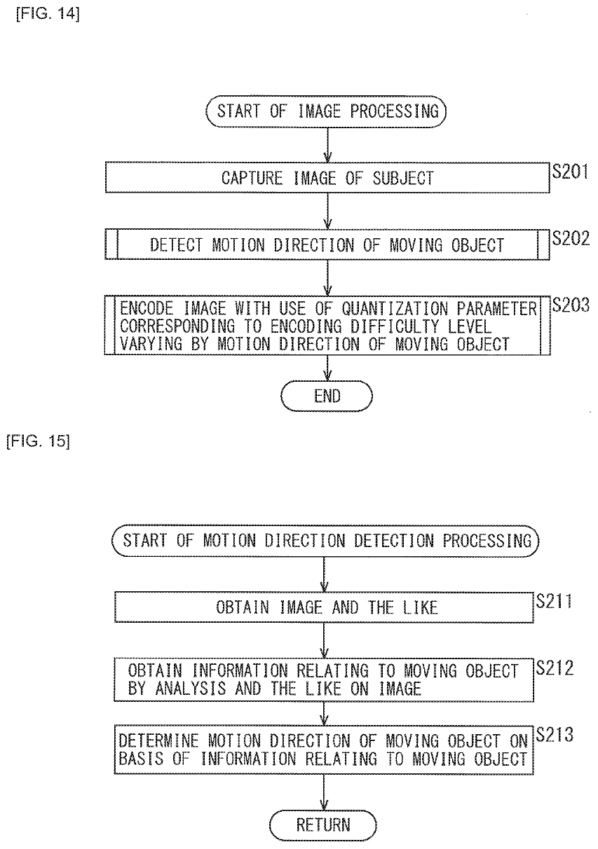

Next, description is given of processing executed by the image processing apparatus 200 as described above. An example of a flow of image processing executed by the image processing apparatus 200 is described with reference to a flow chart in FIG. 14.

When the image processing starts, the imaging unit 111 (FIG. 11) of the image processing apparatus 200 captures an image of a subject to obtain a captured image in step S201.

In step S202, the moving object motion direction detector 211 performs motion direction detection processing to detect the motion direction of the moving object.

In step S203, the image encoding unit 212 performs image encoding processing, and encodes the captured image obtained by the processing in the step S201 with use of the quantization parameter corresponding to the encoding difficulty level varying by the motion direction of the moving object detected by the processing in the step S202 to generate encoded data (a bit stream). The image encoding unit 212 outputs the generated bit stream to outside of the image processing apparatus 200. The bit stream outputted from the image processing apparatus 200 is transmitted to a decoder through, for example, an optional transmission path. In addition, the bit stream may be stored in an optional storage medium, for example.

When the processing in the step S203 ends, the image processing ends.

### <Flow of Motion Direction Detection Processing>

Next, an example of a flow of the motion direction detection processing executed in the step S202 of FIG. 14 is described with reference to a flow chart in FIG. 15.

When the motion direction detection processing starts, the image analyzer 221 (FIG. 12) of the moving object motion direction detector 211 obtains necessary information such as the captured image in step S211.

In step S212, the image analyzer 221 performs analysis and the like on the captured image obtained by the processing in the step S211 to obtain information relating to the moving object, such as face information and moving object information, for example.

In step S213, the motion direction determining unit 222 determines the motion direction of the moving object on the basis of the information relating to the moving object obtained by the processing in the step S212, and generates the moving object motion direction information.

When processing in the step S213 ends, the motion direction detection processing ends, and the processing returns to FIG. 14.

### <Flow of Image Encoding Processing>

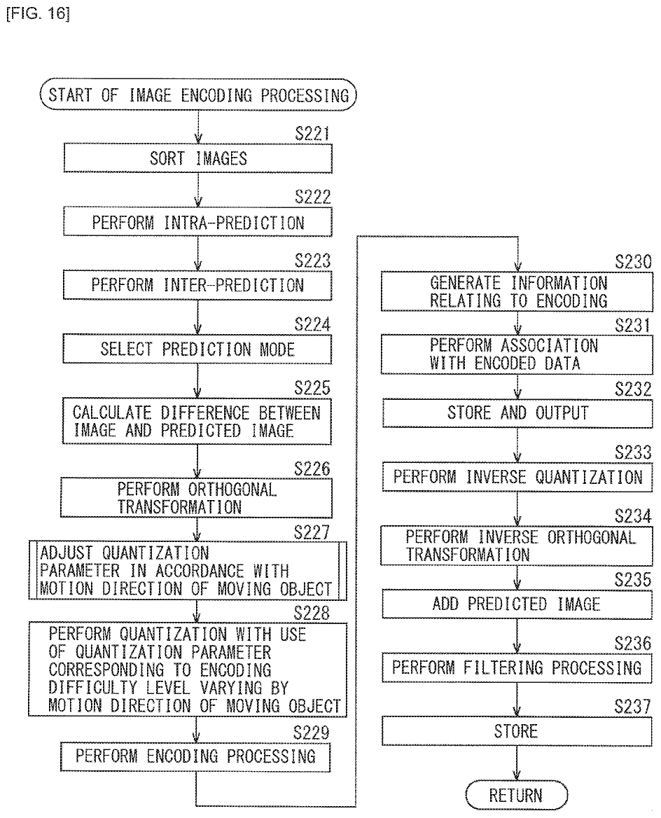

Next, an example of a flow of the image encoding processing executed in the step S203 of FIG. 14 is described with reference to a flow chart in FIG. 16.

When the image encoding processing starts, the screen sorting buffer 131 (FIG. 13) of the image encoding unit 212 sorts the order of the frame images from display order to the encoding order in step S221. In addition, at this time, the screen sorting buffer 131 also performs processing such as block division setting.

In step S222, the intra-predicting unit 142 performs intra-prediction to generate a predicted image in the intra-prediction mode. In step S223, the inter-predicting unit 143 performs inter-prediction processing to generate a predicted image in the inter-prediction mode. In step S224, the predicted image selecting unit 144 calculates a cost function for the predicted image in each of the prediction modes, and selects an optimal prediction mode (the predicted image in the optimal prediction mode) on the basis of the cost function.

In step S225, the operating unit 132 calculates a difference between the input image obtained by the processing in the step S221 and the predicted image selected by the processing in the step S224. In step S226, the orthogonal transformer 133 performs orthogonal transformation on residual data obtained by processing in the step S225. In step S227, the quantization parameter adjuster 241 performs quantization control processing, and adjusts the quantization parameter in accordance with the encoding difficulty level varying by the motion direction of the moving object indicated by the moving object motion direction information.

In step S228, the quantizer 134 quantizes the orthogonal transformation coefficient obtained by processing in the step S226 with use of the quantization parameter, obtained by the processing in the step S227, corresponding to the encoding difficulty level varying by the motion direction of the moving object. In step S229, the encoding unit 135 encodes the quantization coefficient obtained by processing in the step S228 to generate encoded data.

In step S230, the encoding controller 146 obtains necessary information from respective processing units and uses the information to generate information relating to encoding as metadata. In step S231, the encoding unit 135 associates the metadata (the information relating to encoding) obtained by processing in the step S230 with the encoded data obtained by processing in the step S229. In step S232, the storage buffer 136 stores the encoded data (the bit stream) with which the metadata is associated by processing in the step S231, and outputs the encoded data at a predetermined timing.

In step S233, the inverse quantizer 137 inversely quantizes the quantization coefficient obtained by processing in the step S228 by a method corresponding to quantization in the step S228. In step S234, the inverse orthogonal transformer 138 performs inverse orthogonal transformation on the orthogonal transformation coefficient obtained by processing in the step S233 by a method corresponding to orthogonal transformation in the step S226. In step S235, the operating unit 139 adds residual data obtained by processing in the step S234 and the predicted image selected by processing in the step S224.

In step S236, the filter 140 performs predetermined filtering processing (for example, deblocking filtering, sample adaptive offset, and the like) on a reconstructed images obtained by processing in the step S235. In step S237, the frame memory 141 stores a decoded image obtained by processing in the step S236. This decoded image may be usable for intra-prediction or inter-prediction as a reference image in encoding of other blocks.

When the processing in the step S237 ends, the image encoding processing ends, and the processing returns to FIG. 14.

### <Flow of Quantization Control Processing>

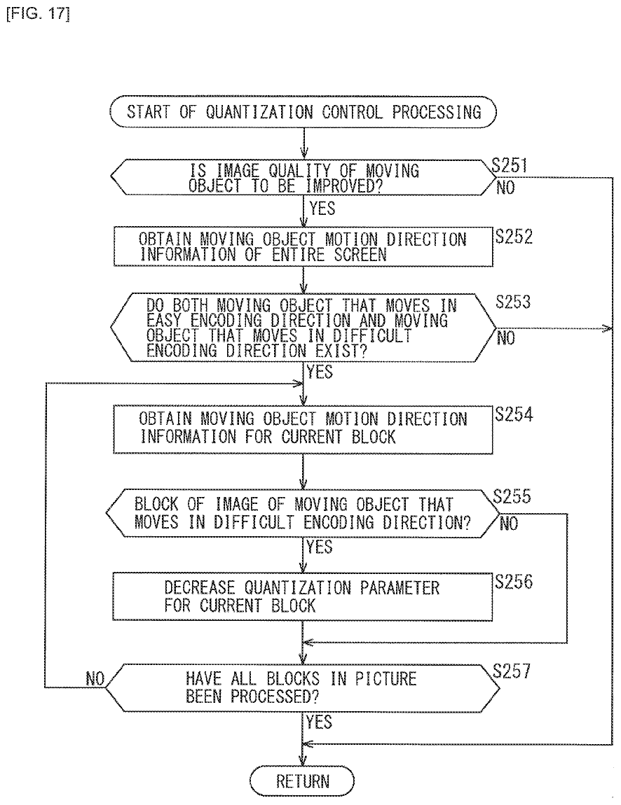

Next, an example of a flow of the quantization control processing executed in the step S227 of FIG. 16 is described with reference to a flow chart in FIG. 17.

When the quantization control processing starts, the adjustment determining unit 251 (FIG. 13) of the quantization parameter adjuster 241 determines whether or not to improve image quality of the moving object in step S251. For example, in a case of a mode in which adjustment of the quantization parameter is performed (for example, in a case where adjustment of the quantization parameter is permitted (or specified) by a control flag or the like), the image quality of the moving object is determined to be improved, and the processing proceeds to step S252.

In the step S252, the adjustment determining unit 251 obtains the moving object motion direction information of the entire screen from the inter-predicting unit 143.

In step S253, the adjustment determining unit 251 determines, on the basis of the obtained moving object motion direction information of the entire screen, whether or not both the moving object that moves in the easy encoding direction and the moving object that moves in the difficult encoding the direction (a predetermined number or more of moving objects) exist. In a case where it is determined that both the moving object that moves in the easy encoding direction and the moving object that moves in the difficult encoding direction (the predetermined number or more of moving objects) exist, the processing proceeds to step S254. In other words, in this case, it is determined to perform adjustment of the quantization parameter.

In the step S254, the quantization parameter setting unit 252 obtains the moving object motion direction information corresponding to a current block (a processing target TU). That is, in a case where an image of a moving object including the current block exists, the quantization parameter setting unit 252 obtains the moving object motion direction information indicating the motion direction of the moving object (the moving object motion direction information corresponding to the current block).

In step S255, the quantization parameter setting unit 252 determines, with use of the moving object motion direction information obtained in the step S254, whether or not the current block is a block of an image of a moving object that moves in the difficult encoding direction. In a case where it is determined from the moving object motion direction information that the current block is the block of the image of the moving object that moves in the difficult encoding direction, the processing proceeds to step S256.

In the step S256, the quantization parameter setting unit 252 decreases the quantization parameter for the current block (sets the quantization parameter for the current block to a lower value). When processing in the step S256 ends, the processing proceeds to step S257. In addition, in the step S255 in a case where it is determined from the moving object motion direction information that the current block is not the block of the image of the moving object that moves in the difficult encoding direction, the processing proceeds to the step S257.

In the step S257, the quantization parameter setting unit 252 determines whether or not all blocks in the picture have been processed. In a case where it is determined that an unprocessed block for which the quantization parameter has not been adjusted exists, the processing returns to the step S254, and subsequent processing is repeated.

In addition, in the step S257, in a case where it is determined that all the blocks in the picture have been processed, the quantization control processing ends, and the processing returns to FIG. 16.

In addition, in the step S251, in a case where it is determined that the mode is not the mode in which the adjustment of the quantization parameter is performed (for example, in a case where adjustment of the quantization parameter is prohibited by the control flag or the like), the image quality of the moving object is determined not to be improved, and the quantization control processing ends. The processing returns to FIG. 16.

In addition, in the step S253, in a case where it is determined that both the motion vector in the easy encoding direction and the motion vector in the difficult encoding direction (the predetermined number or more of motion vectors) do not exist, the quantization control processing ends, and the processing returns to FIG. 16.

Executing the processing as described above makes it possible for the image processing apparatus 100 to quantize the image of the moving object included in the encoding target image with use of the quantization parameter corresponding to the encoding difficulty level varying by the motion direction of the moving object in the encoding target image without using the motion vector.

Doing so makes it possible to make the image quality of the moving object independent of the motion direction of the moving object. This makes it possible to more appropriately assign the bit rate, and suppress a reduction in the subjective image quality of the entire image with respect to the target bit rate (a reduction in encoding efficiency with respect to the subjective image quality of the entire image). In addition, in a case where the image includes a plurality of moving objects that move in directions different from each other, it is possible to suppress variations in image quality in the image, suppress a sense of discomfort caused by the variations in image quality, and suppress a reduction in subjective image quality of the entire image.

### 4. Third Embodiment

### <Configuration for Detection of Motion Direction of Moving Object>

In the second embodiment, description has been given of an example in which the motion direction of the moving object is detected by analyzing the encoding target image, but the motion direction of the moving object is detected without using the motion vector by any method, and the method is not limited to this example.

For example, the motion direction of the moving object may be detected on the basis of a plurality of images.

### <Configuration Example 1 of Image Processing Apparatus>

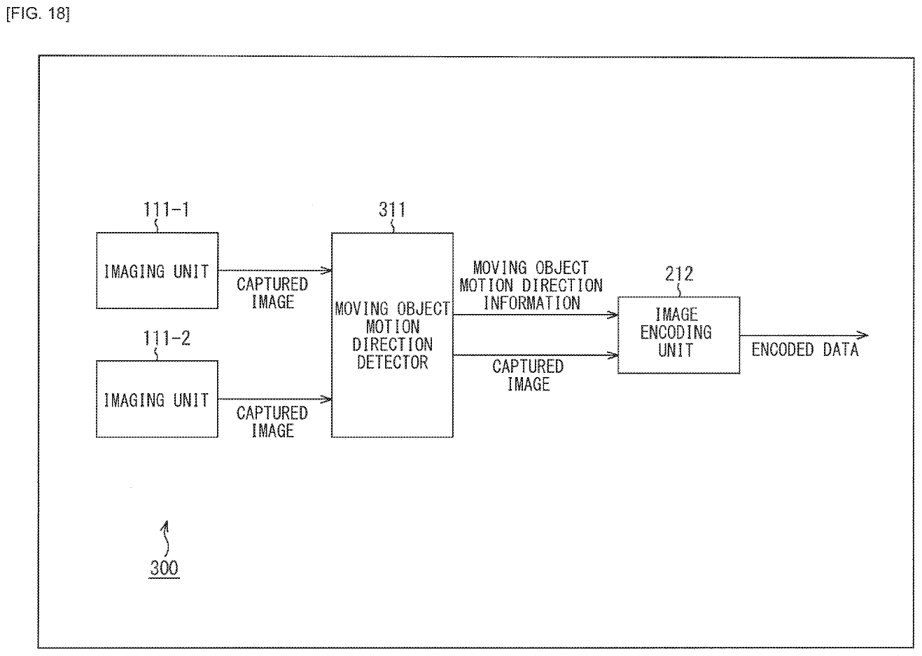

FIG. 18 is a diagram illustrating a main configuration example of an embodiment of an image processing apparatus to which the present technology is applied. An image processing apparatus 300 illustrated in FIG. 18 is an apparatus basically similar to the image processing apparatus 200, and captures an image of a subject, detects the motion direction of the moving object from the obtained captured image, and performs quantization in encoding of the captured image with use of the quantization parameter corresponding to the encoding difficulty level varying by the motion direction.

Note that the image processing apparatus 300 has a plurality of imaging units, and detects the motion direction on the basis of a plurality of captured images obtained by the plurality of imaging units. As illustrated in FIG. 18, the image processing apparatus 300 includes an imaging unit 111-1, an imaging unit 111-2, a moving object motion direction detector 311, and the image encoding unit 212. Each of the imaging unit 111-1 and the imaging unit 111-2 is an imaging unit similar to the imaging unit 111, and captures an image of a subject to obtain a captured image. Each of the imaging unit 111-1 and the imaging unit 111-2 supplies the obtained captured image to the moving object motion direction detector 311.

The moving object motion direction detector 311 detects a moving object included in the captured image supplied from the imaging unit 111-1 and the captured image supplied from the imaging unit 111-2 on the basis of these captured images, and further detects the motion direction of the detected moving object. The moving object and the motion direction thereof are detected by any method.

For example, the moving object motion direction detector 311 may obtain depth information of the subject with use of disparity between the captured images obtained by the imaging unit 111-1 and the imaging unit 111-2, and may detect the moving object and the motion direction thereof on the basis of a change in the depth information.

In addition, for example, the imaging unit 111-1 and the imaging unit 111-2 may capture images of a target space from positions different from each other in directions different from each other, detect the moving object and the motion direction thereof in the target space in respective captured images, and detect the motion direction of the moving object in the target space on the basis of results of such detection.

Even in this case, the moving object motion direction detector 311 generates the moving object motion direction information for each moving object and supplies the moving object motion direction information together with the captured images to the image encoding unit 212. The image encoding unit 212 performs image encoding as in the second embodiment.

As in the second embodiment, doing so makes it possible to perform quantization with use of the quantization parameter corresponding to the encoding difficulty level varying by the motion direction of the moving object without using the motion vector. This makes it possible to achieve effects similar to those in the second embodiment.

It is to be noted that, in the above description, the number of the imaging units 111 is two, but it is sufficient if the number of the imaging units 111 is plural, and the number of the imaging units 11 may be, for example, three or more. In addition, the captured image as an encoding target may include captured images obtained by all the imaging units 111 (all captured images), or may include captured images obtained by some of the imaging units 111 (some of the captured images).

### <Configuration Example 2 of Image Processing Apparatus>

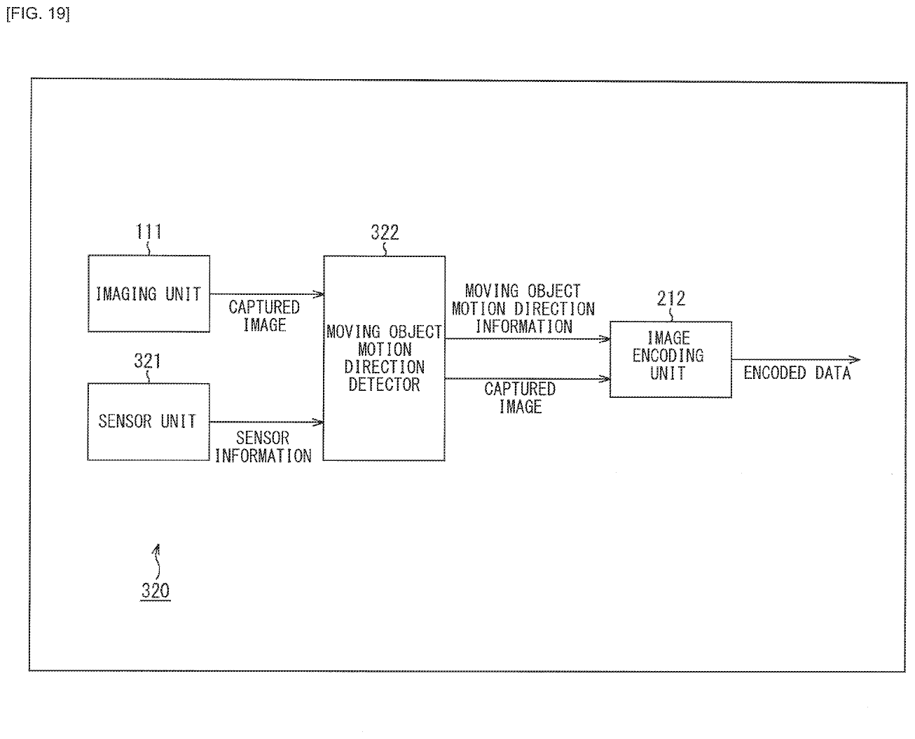

In addition, the motion direction may be detected on the basis of information other than an image. FIG. 19 is a diagram illustrating a main configuration example of an embodiment of an image processing apparatus to which the present technology is applied. An image processing apparatus 320 illustrated in FIG. 19 is an apparatus basically similar to the image processing apparatus 300, and captures an image of a subject, detects a motion direction of a moving object from the obtained captured image, and performs quantization in encoding of the captured image with use of the quantization parameter corresponding to the encoding difficulty level varying by the motion direction.

Note that the image processing apparatus 320 includes a sensor unit 321 instead of the imaging unit 111-2. The sensor unit 321 is any sensor that is allowed to detect information that is information other than the captured image and contributes to detecting the motion direction of the moving object. For example, the sensor unit 321 may be a distance measuring sensor or the like that specifies a depth position of an object (a moving object).

For example, the sensor unit 321 generates sensor information for specifying the depth position of the moving object on the basis of a result of detection, and supplies the sensor information to the moving object motion direction detector 322.

In addition, the image processing apparatus 320 includes a moving object motion direction detector 322 instead of the moving object motion direction detector 311. The moving object motion direction detector 322 detects the motion direction of the moving object included in the captured image supplied from the imaging unit 111 with use of the sensor information supplied from the sensor unit 321. For example, the moving object motion direction detector 322 detects the motion direction of the moving object from a change in the depth information of the moving object included in the captured image supplied from the imaging unit 111.

The moving object motion direction detector 322 generates moving object motion direction information indicating the detected motion direction of the moving object, and supplies the moving object motion direction information together with the captured image to the image encoding unit 212. The image encoding unit 212 encodes the captured image as in the second embodiment.

Doing so makes it possible for the moving object motion direction detector 322 to detect the motion direction of the moving object on the basis of information (for example, the sensor information) other than the image. Accordingly, the present technology is applicable to more various apparatuses and systems.

It is to be noted that, even in a case of the image processing apparatus 320, each of the number of the imaging units 111 and the number of the sensor units 321 is any number, and may be two or more.

Although the image processing apparatus 300 and the image processing apparatus 320 have been described as a single apparatus in the above description, each of the image processing apparatus 300 and the image processing apparatus 320 may be configured as a system including a plurality of apparatuses. For example, the imaging unit 111-1 and the imaging unit 111-2 of the image processing apparatus 300 may be configured as independent apparatuses formed separately from the moving object motion direction detector 311 and the image encoding unit 212. Doing so makes it possible to improve flexibility in installation positions and orientation of the imaging unit 111-1 and the imaging unit 111-2.

Similarly, even in the image processing apparatus 320, the imaging unit 111-1 and the sensor unit 321 may be configured as independent apparatuses formed separately from the moving object motion direction detector 322 and the image encoding unit 212. Doing so makes it possible to improve flexibility in installation position and orientation of the imaging unit 111-1 and the sensor unit 321.

It is needless to say that it is possible to configure each of the image encoding unit 212, the moving object motion direction detector 311, and the moving object motion direction detector 322 as an independent apparatus.

As described above, the motion direction of the moving object may be detected on the basis of single piece of information (for example, a single captured image), or may be detected on the basis of a plurality of pieces of information (for example, a plurality of captured images, a plurality of types of information such as a captured image and sensor information). Generally, using more information makes it possible to more accurately detect the motion direction of the moving object. However, less information makes it possible to further suppress an increase in load on detection processing.

It is to be noted that any information is used for detection of the motion direction of the moving object, and the information is not limited to the examples described above. For example, position information of the subject may be determined with use of a GPS (Global Positioning System).

Even in either case, as in the second embodiment, it is possible for the image encoding unit 212 to adjust the quantization parameter corresponding to the encoding difficulty level varying by the motion direction of the moving object and perform quantization. This makes it possible to achieve similar effects.

### 5. Fourth Embodiment

### <Application Examples of Present Technology>

Although description has been given of a case where the present technology is applied to an image processing apparatus or system that captures an image of a subject, the present technology is applicable to any apparatus that processes an image. For example, the present technology is applicable to various electronic apparatuses such as transmitters and receivers in satellite broadcasting, wired broadcasting such as cable TV, distribution on the Internet, distribution to a terminal by cellular communication, and the like, a recording apparatus that records an image on a medium such as an optical disk, a magnetic disk, and a flash memory, and a reproducing apparatus that reproduces an image from any of these storage media.

### <Television Receiver>

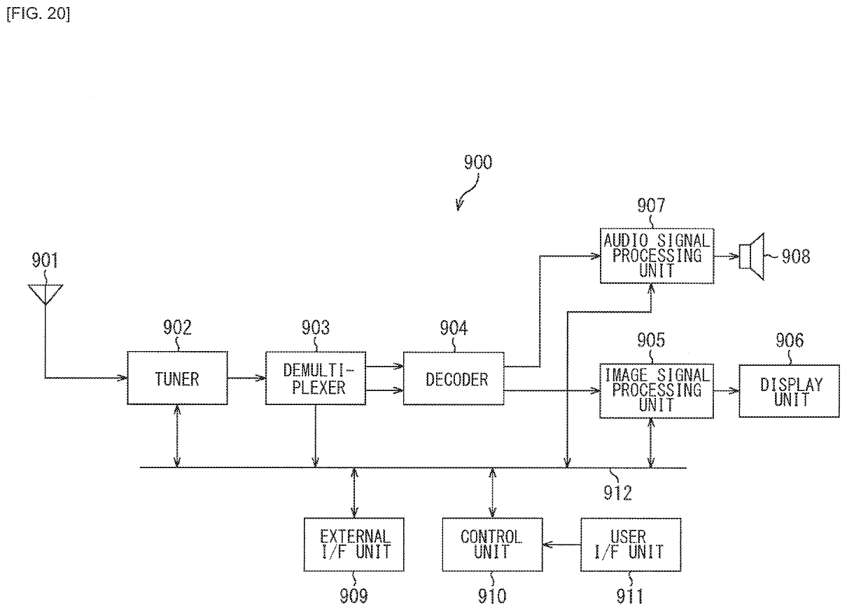

FIG. 20 illustrates an example of a schematic configuration of a television apparatus to which any of the embodiments described above is applied. A television apparatus 900 includes an antenna 901, a tuner 902, a demultiplexer 903, a decoder 904, an image signal processing unit 905, a display unit 906, an audio signal processing unit 907, a speaker 908, an external interface (I/F) unit 909, a control unit 910, a user interface (I/F) unit 911, and a bus 912.

The tuner 902 extracts a signal of a desired channel from a broadcast signal received through the antenna 901, and demodulates the extracted signal. Then, the tuner 902 outputs an encoded bit stream obtained by demodulating to the demultiplexer 903. That is, the tuner 902 serves, in the television apparatus 900, as a transmitting unit that receives an encoded stream in which an image is encoded.

The demultiplexer 903 separates an image stream and an audio stream of a program to be viewed from the encoded bit stream, and outputs each of the separated streams to the decoder 904. In addition, the demultiplexer 903 extracts auxiliary data such as EPG (Electronic Program Guide) from the encoded bit stream, and supplies the extracted data to the control unit 910. It is to be noted that in a case where the encoded bit stream is scrambled, the demultiplexer 903 may descramble the encoded bit stream.

The decoder 904 decodes the image stream and the audio stream inputted from the demultiplexer 903. Then, the decoder 904 outputs image data generated by decoding processing to the image signal processing unit 905. In addition, the decoder 904 outputs audio data generated by the decoding processing to the audio signal processing unit 907.

The image signal processing unit 905 reproduces the image data inputted from the decoder 904, and displays the image data on the display unit 906. In addition, the image signal processing unit 905 may display, on the display unit 906, an application screen supplied through a network. In addition, the image signal processing unit 905 may perform additional processing such as denoising, for example, on the image in accordance with setting. Further, the image signal processing unit 905 may generate, for example, a GUI (Graphical User Interface) image such as a menu, a button, and a cursor, and may superimpose the generated image on an output image.

The display unit 906 is driven by a drive signal supplied from the image signal processing unit 905, and displays a picture or an image on an image surface of a display device (for example, a liquid crystal display, a plasma display, an OELD (Organic ElectroLuminescence Display) (organic electroluminescence display), and the like).

The audio signal processing unit 907 performs reproduction processing such as D/A conversion and amplification on audio data inputted from the decoder 904, and outputs an audio from the speaker 908. In addition, the audio signal processing unit 907 may also perform, on the audio data, additional processing such as denoising.

The external interface unit 909 is an interface for coupling between the television apparatus 900 and an external apparatus or a network. For example, an image stream or an audio stream received through the external interface unit 909 may be decoded by the decoder 904. That is, the external interface unit 909 also serves, in the television apparatus 900, as a transmitting unit that receives the encoded stream in which an image is encoded.

The control unit 910 includes a processor such as a CPU, and a memory such as a RAM and a ROM. The memory stores a program to be executed by the CPU, program data, EPG data, data obtained through a network, and the like. The program stored in the memory is read and executed by the CPU, for example, upon startup of the television apparatus 900. The CPU executes the program to control an operation of the television apparatus 900 in accordance with an operation signal inputted from the user interface unit 911, for example.

The user interface unit 911 is coupled to the control unit 910. The user interface unit 911 includes, for example, a button and a switch for a user to operate the television apparatus 900, a receiving unit for a remote control signal, and the like. The user interface unit 911 detects an operation by the user through these components, generates an operation signal, and outputs the generated operation signal to the control unit 910.

The bus 912 couples the tuner 902, the demultiplexer 903, the decoder 904, the image signal processing unit 905, the audio signal processing unit 907, the external interface unit 909, and the control unit 910 to one another.

In the television apparatus 900 configured as described above, the image signal processing unit 905 may be allowed to encode, for example, image data supplied from the decoder 904 and output the obtained encoded data to outside of the television apparatus 900 through the external interface unit 909. Then, in the encoding, the image signal processing unit 905 may quantize and encode the image data supplied from the decoder 904 by the method described in any of the respective embodiments described above. For example, the image signal processing unit 905 may have a function of the quantizer 134, and may quantize an image supplied from the decoder 904 with use of the quantization parameter corresponding to an encoding difficulty level varying by a motion direction of a moving object in the image. Doing so make it possible for the television apparatus 900 to achieve effects similar to as those of any of the respective embodiments described above.

### <Mobile Phone>

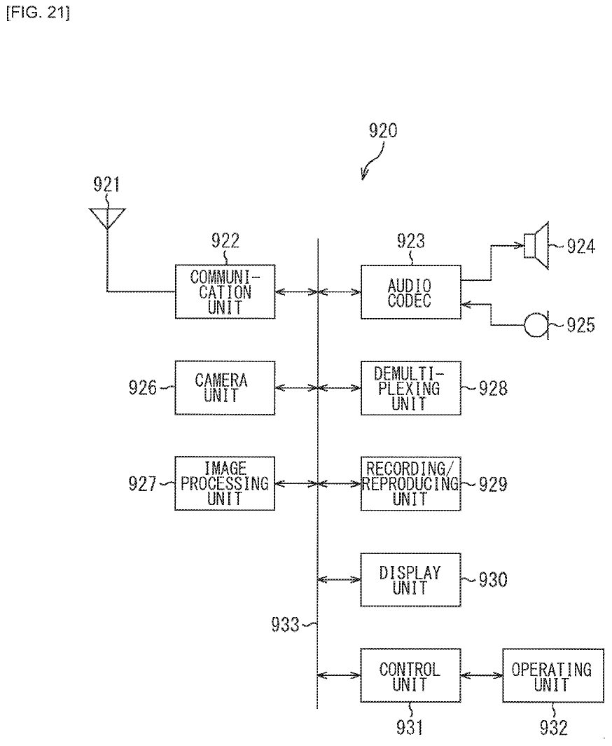

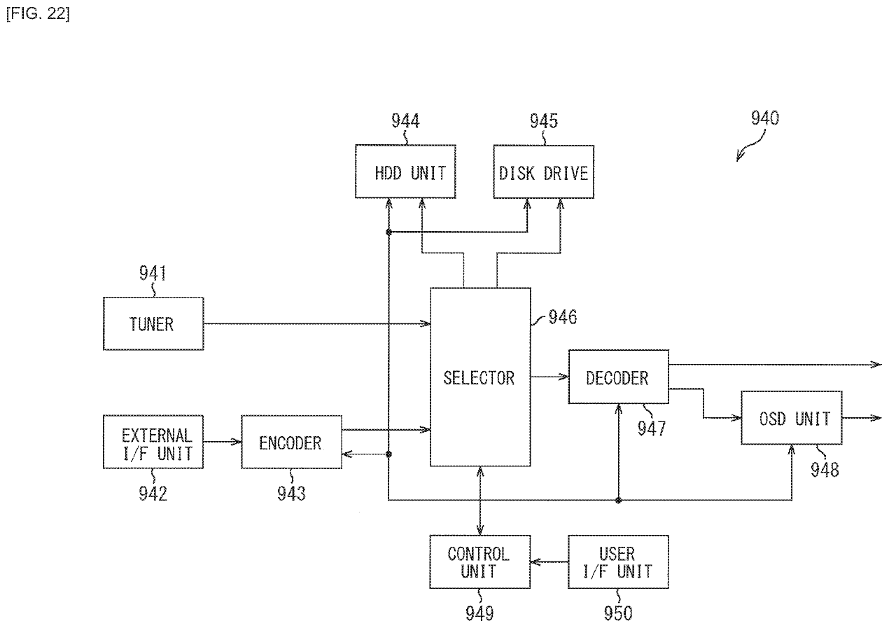

FIG. 21 illustrates an example of a schematic configuration of a mobile phone to which any of the embodiments described above is applied. The mobile phone 920 includes an antenna 921, a communication unit 922, an audio codec 923, a speaker 924, a microphone 925, a camera unit 926, an image processing unit 927, a demultiplexing unit 928, a recording/reproducing unit 929, a display unit 930, a control unit 931, an operating unit 932, and a bus 933.

The antenna 921 is coupled to the communication unit 922. The speaker 924 and the microphone 925 are coupled to the audio codec 923. The operation unit 932 is coupled to the control unit 931. The bus 933 couples the communication unit 922, the audio codec 923, the camera unit 926, the image processing unit 927, the demultiplexing unit 928, the recording/reproducing unit 929, the display unit 930, and the control unit 931 to one another.

The mobile phone 920 performs operations such as transmission and reception of audio signals, transmission and reception of electronic mails or image data, capturing of images, and recording of data in various operation modes including an audio communication mode, a data communication mode, a shooting mode, and a videophone mode.

In the audio communication mode, an analog audio signal generated by the microphone 925 is supplied to the audio codec 923. The audio codec 923 converts the analog audio signal into audio data, performs A/D conversion on the converted audio data, and compresses the converted audio data. Then, the audio codec 923 outputs the compressed audio data to the communication unit 922. The communication unit 922 encodes and modulates the audio data to generate a transmission signal. Then, the communication unit 922 transmits the generated transmission signal to a base station (not illustrated) through the antenna 921. Further, the communication unit 922 amplifies a wireless signal received through the antenna 921 and converts a frequency of the wireless signal to obtain a reception signal. Then, the communication unit 922 demodulates and decodes the reception signal to generate audio data, and outputs the generated audio data to the audio codec 923. The audio codec 923 decompresses the audio data and performs D/A conversion on the audio data to generate an analog audio signal. Then, the audio codec 923 supplies the generated audio signal to the speaker 924, causing the speaker 924 to output an audio.

Further, in response to an operation by a user through the operation unit 932, the control unit 931 generates, for example, text data included in an electronic mail in the data communication mode. Further, the control unit 931 causes text to be displayed on the display unit 930. Further, the control unit 931 generates electronic mail data and outputs the generated electronic mail data to the communication unit 922 in response to a transmission instruction from the user through the operation unit 932. The communication unit 922 encodes and modulates the electronic mail data to generate a transmission signal. Then, the communication unit 922 transmits the generated transmission signal to the base station (not illustrated) through the antenna 921. Further, the communication unit 922 amplifies a wireless signal received through the antenna 921 and converts a frequency of the wireless signal to obtain a reception signal. Then, the communication unit 922 demodulates and decodes the reception signal to restore the electronic mail data, and outputs the restored electronic mail data to the control unit 931. The control unit 931 causes the display unit 930 to display contents of the electronic mail, while supplying the electronic mail data to the recording/reproducing unit 929 to cause the electronic mail data to be written in a storage medium of the recording/reproducing unit 929.

The recording/reproducing unit 929 includes any readable and writable storage medium. For example, the storage medium may be a built-in storage medium such as a RAM and a flash memory or may be an externally mounted storage medium such as a hard disk, a magnetic disk, a magneto-optical disk, an optical disk, a USB (Universal Serial Bus) memory, and a memory card.

Further, in the shooting mode, the camera unit 926 captures an image of a subject to generate image data, and outputs the generated image data to the image processing unit 927, for example. The image processing unit 927 encodes the image data inputted from the camera unit 926, and supplies the encoded stream to the recording/reproducing unit 929 to cause the encoded stream to be written in the storage medium of the recording/reproducing unit 929.

In addition, in an image display mode, the recording/reproducing unit 929 reads the encoded stream recorded in the storage medium and outputs the encoded stream to the image processing unit 927. The image processing unit 927 decodes the encoded stream inputted from the recording/reproducing unit 929, supplies the image data to the display unit 930 to cause an image of the image data to be displayed.

Further, in the videophone mode, the demultiplexing unit 928 multiplexes an image stream encoded by the image processing unit 927 and an audio stream inputted from the audio codec 923, and outputs the multiplexed stream to the communication unit 922, for example. The communication unit 922 encodes and modulates the stream to generate a transmission signal. Then, the communication unit 922 transmits the generated transmission signal to the base station (not illustrated) through the antenna 921. Further, the communication unit 922 amplifies a wireless signal received through the antenna 921 and converts a frequency of the wireless signal to obtain a reception signal. The transmission signal and the reception signal may include an encoded bit stream. Then, the communication unit 922 demodulates and decodes the reception signal to restore the stream, and outputs the restored stream to the demultiplexing unit 928. The demultiplexing unit 928 separates the inputted stream into an image stream and an audio stream, and outputs the image stream to the image processing unit 927 and the audio stream to the audio codec 923. The image processing unit 927 decodes the image stream to generate image data. The image data is supplied to the display unit 930, and a series of images is displayed by the display unit 930. The audio codec 923 decompresses the audio stream and performs D/A conversion to generate an analog audio signal. Then, the audio codec 923 supplies the generated audio signal to the speaker 924, causing the speaker 924 to output an audio.

In the mobile phone 920 configured as described above, for example, the image processing unit 927 may be allowed to quantize and encode supplied image data by the method described in any of the respective embodiments described above. For example, the image processing unit 927 may have a function of the quantizer 134, and perform quantization with use of the quantization parameter corresponding to the encoding difficulty level varying by the motion direction of the moving object in the image. Doing so make it possible for the mobile phone 920 to achieve effects similar to as those of any of the respective embodiments described above.

### <Recording/Reproducing Apparatus>

FIG. 22 illustrates an example of a schematic configuration of a recording/reproducing apparatus to which any of the embodiments described above is applied. A recording/reproducing apparatus 940 encodes audio data and image data of a received broadcast program and records the encoded audio data the encoded image data on a recording medium, for example. In addition, the recording/reproducing apparatus 940 may also encode audio data and image data obtained from another apparatus and record the encoded audio data and the encoded image data on a recording medium, for example. In addition, the recording/reproducing apparatus 940 reproduces data recorded on a recording medium on a monitor and a speaker in response to an instruction from a user, for example. At this time, the recording/reproducing apparatus 940 decodes the audio data and the image data.

The recording/reproducing apparatus 940 includes a tuner 941, an external interface (I/F) unit 942, an encoder 943, an HDD (Hard Disk Drive) unit 944, a disk drive 945, a selector 946, a decoder 947, an OSD (On-Screen Display) unit 948, a control unit 949, and a user interface (I/F) unit 950.

The tuner 941 extracts a signal of a desired channel from a broadcast signal received through an antenna (not illustrated), and demodulates the extracted signal. Then, the tuner 941 outputs an encoded bit stream obtained by demodulation to the selector 946. That is, the tuner 941 serves as a transmitting unit of the recording/reproducing apparatus 940.

The external interface unit 942 is an interface for coupling the recording/reproducing apparatus 940 to an external device or a network. The external interface unit 942 may be, for example, an IEEE (Institute of Electrical and Electronic Engineers) 1394 interface, a network interface, a USB interface, a flash memory interface, or the like. For example, image data and audio data received through the external interface unit 942 are inputted to the encoder 943. That is, the external interface unit 942 serves as a transmitting unit of the recording/reproducing apparatus 940.

In a case where the image data and the audio data inputted from the external interface unit 942 are not encoded, the encoder 943 encodes the image data and the audio data. Then, the encoder 943 outputs an encoded bit stream to the selector 946.

The HDD unit 944 records an encoded bit stream in which content data such as an image and an audio is compressed, various programs, and other data on an internal hard disk. In addition, the HDD unit 944 reads these data from the hard disk upon reproducing the image and the audio.

The disk drive 945 records and reads data onto and from an attached recording medium. The recording medium attached to the disk drive 945 may be, for example, a DVD (Digital Versatile Disc) disk (a DVD-Video or a DVD-RAM (DVD-Random Access Memory), a DVD-R (DVD-Recordable), a DVD-RW (DVD-Rewritable), a DVD+R (DVD+Recordable), a DVD+RW (DVD+Rewritable), or the like), a Blu-ray (registered trademark) disk, or the like.

Upon recording the image and the audio, the selector 946 selects an encoded bit stream inputted from the tuner 941 or the encoder 943, and outputs the selected encoded bit stream to the HDD unit 944 or the disk drive 945. In addition, upon reproducing the image and the audio, the selector 946 outputs an encoded bit stream inputted from the HDD unit 944 or the disk drive 945 to the decoder 947

The decoder 947 decodes the encoded bit stream to generate image data and audio data. Then, the decoder 947 outputs the generated image data to the OSD unit 948. In addition, the decoder 947 outputs the generated audio data to an external speaker.

The OSD unit 948 reproduces the image data inputted from the decoder 947 to display an image. In addition, the OSD unit 948 may superimpose a GUI image such as a menu, a button, or a cursor on the displayed image.

The control unit 949 includes a processor such as a CPU, and a memory such as a RAM and a ROM. The memory stores a program to be executed by the CPU, program data, and the like. The program stored in the memory is read and executed by the CPU, for example, upon startup of the recording/reproducing apparatus 940. The CPU executes the program to control an operation of the recording/reproducing apparatus 940 in accordance with an operation signal inputted from the user interface unit 950, for example.

The user interface unit 950 is coupled to the control unit 949. The user interface unit 950 includes, for example, a button and a switch used by a user to operate the recording/reproducing apparatus 940, and a remote control signal receiving unit. The user interface unit 950 detects an operation by the user through these components to generate an operation signal, and outputs the generated operation signal to the control unit 949.

In the recording/reproducing apparatus 940 configured as described above, for example, the encoder 943 may have a function of the image processing apparatus 100 described above. That is, the encoder 943 may quantize and encode the supplied image data by any of the methods described in the respective embodiments described above. For example, the encoder 943 may have a function of the quantizer 134, and may quantize the supplied image with use of the quantization parameter corresponding to the encoding difficulty level varying by the motion direction of the moving object in the image. Doing so makes it possible for the recording/reproducing apparatus 940 to achieve effects similar to those of any of the respective embodiments described above.

### <Imaging Apparatus>

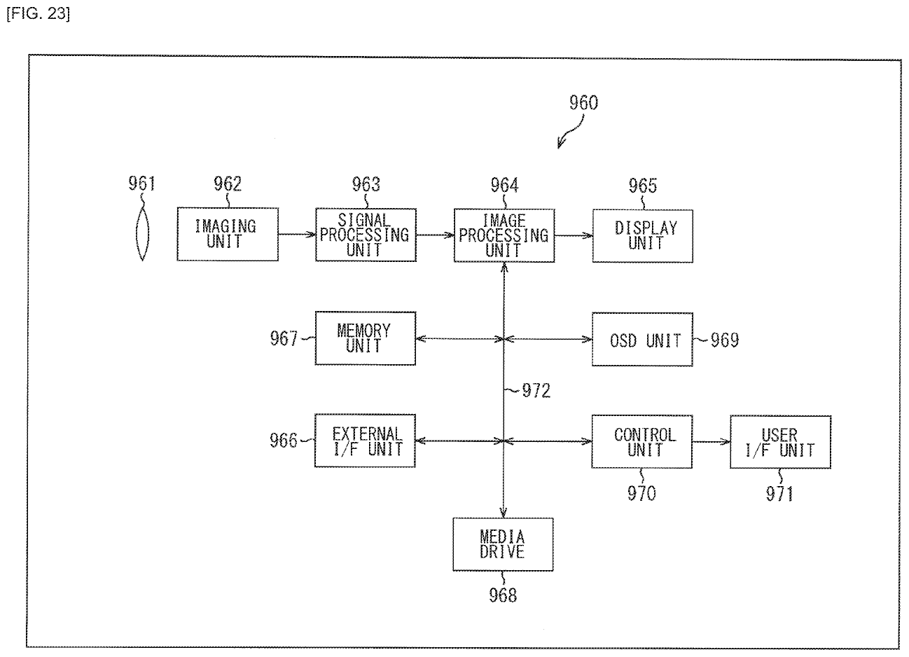

FIG. 23 illustrates an example of a schematic configuration of an imaging apparatus to which any of the embodiments described above is applied. An imaging apparatus 960 captures an image of a subject to generate an image, encodes image data, and records the encoded image data on a recording medium.

The imaging apparatus 960 includes an optical block 961, an imaging unit 962, a signal processing unit 963, an image processing unit 964, a display unit 965, an external interface (I/F) unit 966, a memory unit 967, a media drive 968, an OSD unit 969, a control unit 970, a user interface (I/F) unit 971, and a bus 972.

The optical block 961 are coupled to the imaging unit 962. The imaging unit 962 is coupled to the signal processing unit 963. The display unit 965 is coupled to the image processing unit 964. The user interface unit 971 is coupled to the control unit 970. The bus 972 couples the image processing unit 964, the external interface unit 966, the memory unit 967, the media drive 968, the OSD unit 969, and the control unit 970 to one another.

The optical block 961 includes a focus lens, a diaphragm mechanism, and the like. The optical block 961 forms an optical image of a subject on an imaging surface of the imaging unit 962. The imaging unit 962 includes an image sensor such as a CCD (Charge Coupled Device) or a CMOS (Complementary Metal Oxide Semiconductor), and photoelectrically converts the optical image formed on the imaging surface into an image signal as an electric signal. Then, the imaging unit 962 outputs the image signal to the signal processing unit 963.

The signal processing unit 963 performs various camera signal processing such as knee correction, gamma correction, and color correction on the image signal inputted from the imaging unit 962. The signal processing unit 963 outputs, to the image processing unit 964, image data having been subjected to the camera signal processing.

The image processing unit 964 encodes the image data inputted from the signal processing unit 963 to generate encoded data. Then, the image processing unit 964 outputs the generated encoded data to the external interface unit 966 or the media drive 968. In addition, the image processing unit 964 decodes encoded data inputted from the external interface unit 966 or the media drive 968 to generate image data. Then, the image processing unit 964 outputs the generated image data to the display unit 965. In addition, the image processing unit 964 may output image data inputted from the signal processing unit 963 to the display unit 965, causing the display unit 965 to display an image. In addition, the image processing unit 964 may superimpose display data obtained from the OSD unit 969 on an image to be outputted to the display unit 965.

The OSD unit 969 generates a GUI image such as a menu, a button, or a cursor, and outputs the generated image to the image processing unit 964.

The external interface unit 966 is configured as, for example, a USB input/output terminal. The external interface unit 966 couples the imaging apparatus 960 to a printer, for example, upon printing an image. In addition, a drive is coupled to the external interface unit 966 as necessary. For example, a removable medium such as a magnetic disk or an optical disk is mounted into the drive, and it is possible to install a program read from the removable medium into the imaging apparatus 960. Further, the external interface unit 966 may be configured as a network interface coupled to a network such as a LAN or the Internet. That is, the external interface unit 966 serves as a transmitting unit of the imaging apparatus 960.

A recording medium to be mounted into the media drive 968 may be an any readable and writable removable medium such as, for example, a magnetic disk, a magneto-optical disk, an optical disk, and a semiconductor memory. In addition, a recording medium may be fixedly mounted in the media drive 968 to configure a non-portable storage unit such as, for example, a built-in hard disk drive and an SSD (Solid State Drive).

The control unit 970 includes a processor such as a CPU, and a memory such as a RAMs and a ROM. The memory stores a program to be executed by the CPU, program data, and the like. The program stored in the memory is read and executed by the CPU, for example, upon startup of the imaging apparatus 960. The CPU executes the program to control an operation of the imaging apparatus 960 in accordance with an operation signal inputted from the user interface unit 971, for example.

The user interface unit 971 is coupled to the control unit 970. The user interface unit 971 includes, for example, a button and a switch used for a user to operate the imaging apparatus 960. The user interface unit 971 detects an operation by the user through these components to generate an operation signal, and outputs the generated operation signal to the control unit 970.

In the imaging apparatus 960 configured as described above, for example, the image processing unit 964 may quantize and encode the supplied image data by any of the methods described in the respective embodiment described above. For example, the image processing unit 964 may have a function of the quantizer 134, and may quantize the supplied image with use of the quantization parameter corresponding to the encoding difficulty level varying by the motion direction of the moving object in the image. Doing so makes it possible for the imaging apparatus 960 to achieve effects similar to those of any of the respective embodiments described above.

### <Video Set>

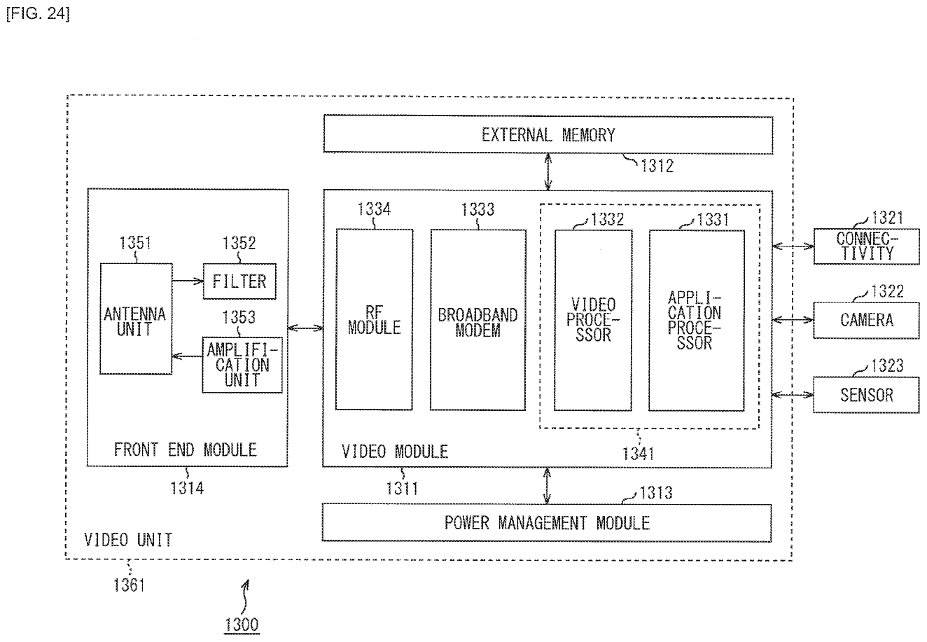

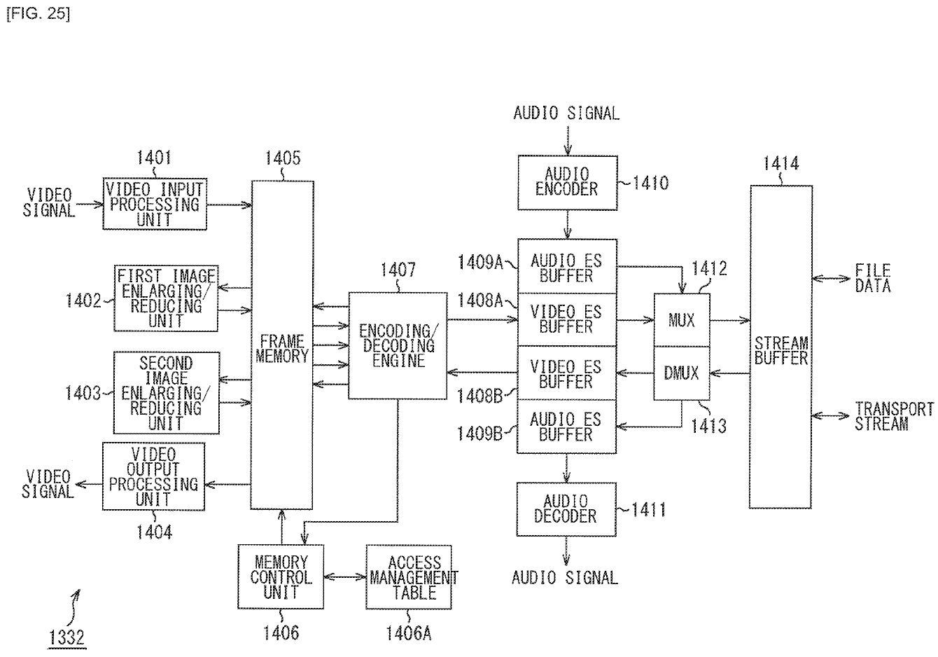

Further, it is also possible to implement the present technology as any configuration mounted in any apparatus or any apparatus included in a system (that is, it is possible to implement the present technology as a portion of the configuration of the apparatus). Examples of the configuration include a processor serving as a system LSI (Large Scale Integration) or the like, a module using a plurality of processors and the like, a unit using a plurality of modules and the like, and a set adding other functions to the unit. FIG. 24 illustrates an example of a schematic configuration of a video set to which the present technology is applied.

In recent years, more and more electronic apparatuses have become multifunctional. In development and manufacturing of such electronic apparatuses, there are cases where a portion of the configuration is implemented for sale, provision, or the like, in addition to a case where a configuration having a single function is implemented, there are many cases where a plurality of configurations having related functions are combined and implemented as a single set having a plurality of functions.

A video set 1300 illustrated in FIG. 24 has such a multi-functionalized configuration. The video set 1300 is a combination of a device having a function relating to image encoding and decoding (either one or both are possible) and a device having another function relating to the function.

As illustrated in FIG. 24, the video set 1300 includes a group of modules, and devices having related functions. The group of modules includes a video module 1311, an external memory 1312, a power management module 1313, and a front end module 1314. The devices include a connectivity 1321, a camera 1322, and a sensor 1323.

A module is a component having integrated functions in which several mutually related component functions are integrated. The module has any specific physical configuration. As one possible example, a plurality of processors having respective functions, electronic circuit elements such as a resistor and a capacitor, other devices, and the like may be arranged and integrated on a wiring board or the like. Further, as another possible example, a combination of one module and another module, a processor, and the like may be provided as a new module.

In the case of the example in FIG. 24, the video module 1311 is a combination of configurations having functions relating to image processing. The video module 1311 includes an application processor, a video processor, a broadband modem 1333, and an RF module 1334.

A processor is formed by integrating a configuration having predetermined functions onto a semiconductor chip as a SoC (System On a Chip). Some processors are called a system LSI (Large Scale Integration) or the like, for example. The configuration having the predetermined functions may be a logical circuit (a hardware configuration), may be a CPU, a ROM, a RAM, and the like and a program executed by using the CPU, the ROM, the RAM, and the like (a software configuration), or may be a combination of both the configurations. For example, a processor may include a logical circuit, a CPU, a ROM, a RAM, and the like, and some of the functions may be implemented by the logical circuit (the hardware configuration), while the other functions may be implemented by the program (the software configuration) executed by the CPU.

An application processor 1331 in FIG. 24 is a processor that executes an application relating to image processing. In order to implement a predetermined function, it is possible for the application to be executed by the application processor 1331 not only to perform arithmetic processing, but also to control configurations inside and outside the video module 1311, such as, for example, the video processor 1332, as necessary.

The video processor 1332 is a processor having a function relating to (either one or both of) image encoding and decoding.

The broadband modem 1333 converts data (a digital signal) into an analog signal through digital modulation or the like. The data is to be transmitted through wired or wireless (or both wired and wireless) broadband communication that is performed through a broadband line such as the Internet and a public telephone line network. The broadband modem 1333 also demodulates and converts an analog signal received through the broadband communication into data (a digital signal). The broadband modem 1333 processes any information such as, for example, image data to be processed by the video processor 1332, a stream in which image data has been encoded, an application program, and setting data.

The RF module 1334 is a module that performs frequency conversion, modulation/demodulation, amplification, filtering processing, and the like on RF (Radio Frequency) signals to be transmitted and received through an antenna. For example, the RF module 1334 generates an RF signal by conversion of a frequency of a base band signal generated by the broadband modem 1333, or the like. In addition, for example, the RF module 1334 generates a base band signal by conversion of a frequency of an RF signal received through the front end module 1314, or the like.

It is noted that as indicated by a dotted line 1341 in FIG. 24, the application processor 1331 and the video processor 1332 may be integrated and configured as one processor.

The external memory 1312 is a module including a storage device used by the video module 1311. The external memory 1312 is provided outside the video module 1311. This storage device of the external memory 1312 may be implemented by any physical configuration. In general, the storage device is often used for storing a large amount of data such as image data in units of frames. Therefore, it is desirable to implement the storage device by a relatively inexpensive, large-capacity semiconductor memory such as, for example, a DRAM (Dynamic Random Access Memory).

The power management module 1313 manages and controls power supply to the video module 1311 (each configuration inside the video module 1311).

The front end module 1314 is a module that provides the RF module 1334 with a front end function (a circuit at a transmission/reception end on an antenna side). As illustrated in FIG. 24, the front end module 1314 includes, for example, an antenna unit 1351, a filter 1352, and an amplification unit 1353.

The antenna unit 1351 includes an antenna and its peripheral configuration that transmits and receives wireless signals. The antenna unit 1351 transmits a signal supplied from the amplification unit 1353 as a wireless signal and supplies a received wireless signal to the filter 1352 as an electric signal (an RF signal). The filter 1352 performs filtering processing and the like on the RF signal received through the antenna unit 1351 and supplies the processed RF signal to the RF module 1334. The amplification unit 1353 amplifies an RF signal supplied from the RF module 1334 and supplies the RF signal to the antenna unit 1351.

The connectivity 1321 is a module having a function relating to external coupling. The connectivity 1321 has any physical configuration. For example, the connectivity 1321 includes a configuration having a communication function other than a communication standard supported by the broadband modem 1333, external input/output terminals, and the like.

For example, the connectivity 1321 may include a module having a communication function conforming to a wireless communication standard such as Bluetooth (registered trademark), IEEE 802.11 (for example, Wi-Fi (Wireless Fidelity, registered trademark)), NFC (Near Field Communication), and IrDa (InfraRed Data Association), an antenna that transmits and receives signals conforming to the standard, and the like. In addition, for example, the connectivity 1321 may include a module having a communication function conforming to a wired communication standard such as USB (Universal Serial Bus) and HDMI (registered trademark) (High-Definition Multimedia Interface), and a terminal that conforms to the standard. Further, for example, the connectivity 1321 may have functions of transmitting other data (signals) such as analog input/output terminals.

It is noted that the connectivity 1321 may include a destination device to which data (signals) are transmitted. For example, the connectivity 1321 may include a drive that reads and writes data from and onto a recording medium such as a magnetic disk, an optical disk, a magneto-optical disk, and a semiconductor memory (the drive includes not only a drive of a removable medium, but also drives of a hard disk, an SSD (Solid State Drive), a Network Attached Storage (NAS), and the like). In addition, the connectivity 1321 may include devices that output images and audio (a monitor, a speaker, and the like).

The camera 1322 is a module having a function of capturing an image of a subject and obtaining image data of the subject. Image data obtained by imaging of the camera 1322 is supplied to the video processor 1332, and then encoded, for example.

The sensor 1323 is a module having a function of any sensor such as, for example, an audio sensor, an ultrasonic sensor, an optical sensor, an illuminance sensor, an infrared sensor, an image sensor, a rotation sensor, an angle sensor, an angular velocity sensor, a speed sensor, an acceleration sensor, a tilt sensor, a magnetic identification sensor, a shock sensor, and a temperature sensor. Data detected by the sensor 1323 is supplied to the application processor 1331 and used by an application and the like, for example.

The configurations described above as the modules may be implemented as processors. Conversely, the configurations described above as the processors may be implemented as modules.

In the video set 1300 having a configuration as described above, the present technology is applicable to the video processor 1332 as described later. Accordingly, it is possible to implement the video set 1300 as a set to which the present technology is applied.

### <Configuration Example of Video Processor>

FIG. 26 illustrates an example of a schematic configuration of the video processor 1332 (FIG. 24) to which the present technology is applied.

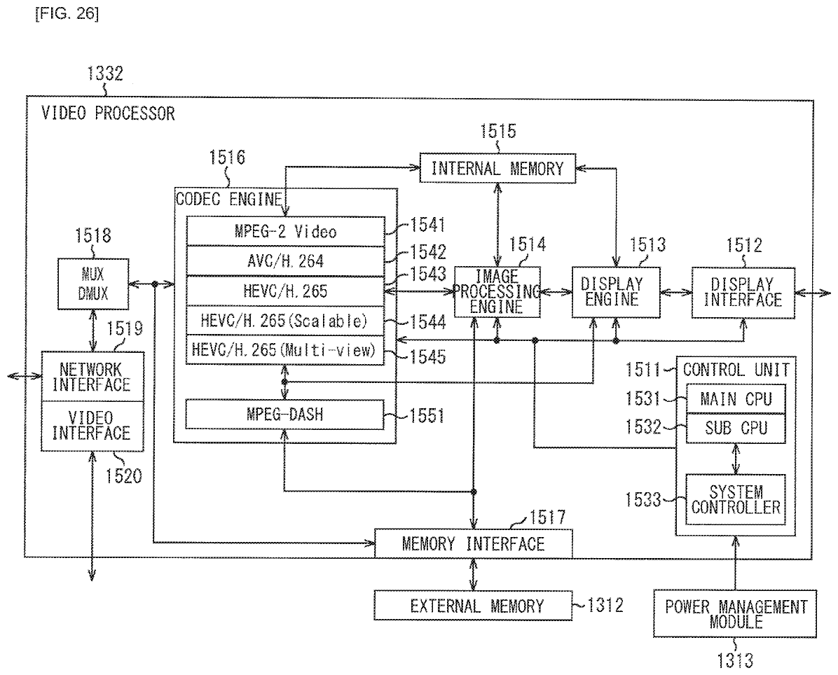

In the case of the example in FIG. 25, the video processor 1332 has a function of receiving input of a video signal and an audio signal and encoding the video signal and the audio signal using a predetermined system, and a function of decoding encoded video data and encoded audio data and reproducing and outputting a video signal and an audio signal.

As illustrated in FIG. 25, the video processor 1332 includes a video input processing unit 1401, a first image enlarging/reducing unit 1402, a second image enlarging/reducing unit 1403, a video output processing unit 1404, a frame memory 1405, and a memory control unit 1406. In addition, the video processor 1332 includes an encoding/decoding engine 1407, video ES (Elementary Stream) buffers 1408A and 1408B, and audio ES buffers 1409A and 1409B. Further, the video processor 1332 includes an audio encoder 1410, an audio decoder 1411, a multiplexing unit (MUX (Multiplexer)) 1412, a demultiplexing unit (DMUX (Demultiplexer)) 1413, and a stream buffer 1414.

The video input processing unit 1401 obtains, for example, a video signal inputted from the connectivity 1321 (FIG. 24) and converts the video signal into digital image data. The first image enlarging/reducing unit 1402 performs, on the image data, processing such as format conversion and image enlargement/reduction processing. The second image enlarging/reducing unit 1403 performs, on the image data, processing such as image enlargement/reduction processing in accordance with a format at a destination to which the image is outputted through the video output processing unit 1404. The second image enlarging/reducing unit 1403 also performs, on the image data, processing such as format conversion and image enlargement/reduction processing, similarly to the first image enlarging/reducing unit 1402. The video output processing unit 1404 performs, on the image data, processing such as format conversion and conversion into an analog signal, and then outputs the processed image data as a reproduced video signal, to the connectivity 1321 and the like, for example.

The frame memory 1405 is a memory for image data shared among the video input processing unit 1401, the first image enlarging/reducing unit 1402, the second image enlarging/reducing unit 1403, the video output processing unit 1404, and the encoding/decoding engine 1407. The frame memory 1405 is implemented as a semiconductor memory such as, for example, a DRAM.

The memory control unit 1406 receives a synchronization signal from the encoding/decoding engine 1407 and controls writing and reading access to the frame memory 1405 in accordance with a schedule of access to the frame memory 1405 written on an access management table 1406A. The access management table 1406A is updated by the memory control unit 1406 in accordance with processing executed by the encoding/decoding engine 1407, the first image enlarging/reducing unit 1402, the second image enlarging/reducing unit 1403, and the like.

The encoding/decoding engine 1407 performs encoding processing on image data and performs decoding processing on a video stream. The video stream is data in which image data has been encoded. For example, the encoding/decoding engine 1407 encodes image data read from the frame memory 1405 and sequentially writes the encoded image data onto the video ES buffer 1408A as a video stream. In addition, for example, the encoding/decoding engine 1407 decodes a video stream sequentially read from the video ES buffer 1408B and sequentially writes the decoded video stream onto the frame memory 1405 as image data. In the encoding and the decoding, the encoding/decoding engine 1407 uses the frame memory 1405 as a work area. Further, the encoding/decoding engine 1407 outputs a synchronization signal to the memory control unit 1406 at a timing of, for example, starting processing for each macroblock.

The video ES buffer 1408A buffers a video stream generated by the encoding/decoding engine 1407 and supplies the video stream to the multiplexing unit (MUX) 1412. The video ES buffer 1408B buffers a video stream supplied from the demultiplexing unit (DMUX) 1413 and supplies the video stream to the encoding/decoding engine 1407.

The audio ES buffer 1409A buffers an audio stream generated by the audio encoder 1410 and supplies the audio stream to the multiplexing unit 1412. The audio ES buffer 1409B buffers an audio stream supplied from the DMUX 1413 and supplies the audio stream to the audio decoder 1411.

The audio encoder 1410 performs, for example, digital conversion on an audio signal inputted from, for example, the connectivity 1321 or the like, and encodes the audio signal using a predetermined system such as, for example, an MPEG audio system and an AC3 (AudioCode number 3) system. The audio encoder 1410 sequentially writes an audio stream onto the audio ES buffer 1409A. The audio stream is data in which the audio signal has been encoded. The audio decoder 1411 decodes an audio stream supplied from the audio ES buffer 1409B and perform, for example, conversion or the like of the audio stream into an analog signal. The audio decoder 1411 then supplies the analog signal to, for example, the connectivity 1321 or the like as a reproduced audio signal.

The multiplexing unit (MUX) 1412 multiplexes a video stream and an audio stream. This multiplexing is performed any method (that is, any format of a bit stream generated by multiplexing). In addition, upon the multiplexing, it is also possible for the multiplexing unit (MUX) 1412 to add predetermined header information and the like to a bit stream. That is, it is possible for the multiplexing unit (MUX) 1412 to convert a format of a stream by multiplexing. For example, the multiplexing unit (MUX) 1412 multiplexes a video stream and an audio stream to convert the video stream and the audio stream into a transport stream. The transport stream is a bit stream in a transfer format. In addition, for example, the multiplexing unit (MUX) 1412 multiplexes the video stream and the audio stream to convert the video stream and the audio stream into data (file data) in a recording file format.

With use of a method corresponding to multiplexing by the multiplexing unit (MUX) 1412, the demultiplexing unit (DMUX) 1413 demultiplexes a bit stream in which a video stream and an audio stream have been multiplexed. That is, the demultiplexing unit (DMUX) 1413 extracts the video stream and the audio stream from the bit stream read from the stream buffer 1414 (separates the video stream and the audio stream from each other). That is, it is possible for the demultiplexing unit (DMUX) 1413 to convert the format of the stream by demultiplexing (to perform inverse conversion of the conversion performed by the multiplexing unit (MUX) 1412). For example, the demultiplexing unit (DMUX) 1413 obtains a transport stream supplied from, for example, the connectivity 1321, the broadband modem 1333, or the like through the stream buffer 1414, and demultiplexes the transport stream, which makes it possible to convert the transport stream into a video stream and an audio stream. In addition, for example, the demultiplexing unit (DMUX) 1413 obtains file data read from various recording media by, for example, the connectivity 1321 through the stream buffer 1414 and demultiplexes the file data, which makes it possible to convert the file data into a video stream and an audio stream.

The stream buffer 1414 buffers a bit stream. For example, the stream buffer 1414 buffers a transport stream supplied from the multiplexing unit (MUX) 1412 and supplies the transport stream to, for example, the connectivity 1321, the broadband modem 1333, or the like at a predetermined timing or on the basis of a request or the like from outside.

In addition, for example, the stream buffer 1414 buffers file data supplied from the multiplexing unit (MUX) 1412 and supplies the file data to, for example, the connectivity 1321 or the like at a predetermined timing or on the basis of a request or the like from outside to cause the file data to be recorded onto various recording media.

Further, the stream buffer 1414 buffers a transport stream obtained through, for example, the connectivity 1321, the broadband modem 1333, or the like and supplies the transport stream to the demultiplexing unit (DMUX) 1413 at a predetermined timing or on the basis of a request or the like from outside.

In addition, the stream buffer 1414 buffers file data read from various recording media by, for example, the connectivity 1321 or the like, and supplies the file data to the demultiplexing unit (DMUX) 1413 at a predetermined timing or on the basis of a request or the like from outside.

Next, description is given of an example of the operation of the video processor 1332 configured as above. For example, a video signal is inputted into the video processor 1332 from the connectivity 1321 or the like. The video input processing unit 1401 converts the video signal into digital image data in a predetermined system such as a 4:2:2Y/Cb/Cr system, and sequentially writes the digital image data onto the frame memory 1405. This digital image data is read by the first image enlarging/reducing unit 1402 or the second image enlarging/reducing unit 1403 to be converted into a format in a predetermined system such as a 4:2:0Y/Cb/Cr system and to be subjected to enlargement/reduction processing. The digital image data is then written onto the frame memory 1405 again. This image data is encoded by the encoding/decoding engine 1407 and written onto the video ES buffer 1408A as a video stream.

In addition, an audio signal inputted into the video processor 1332 from the connectivity 1321 or the like is encoded by the audio encoder 1410 and written onto the audio ES buffer 1409A as an audio stream.

The video stream in the video ES buffer 1408A and the audio stream in the audio ES buffer 1409A are read and multiplexed by the multiplexing unit (MUX) 1412 and converted into a transport stream, file data, or the like. The transport stream generated by the multiplexing unit (MUX) 1412 is buffered by the stream buffer 1414, and then outputted to an external network through, for example, the connectivity 1321, the broadband modem 1333, or the like. In addition, the file data generated by the multiplexing unit (MUX) 1412 is buffered by the stream buffer 1414, and then outputted to, for example, the connectivity 1321 or the like to be recorded onto various recording media.

In addition, the transport stream inputted into the video processor 1332 from the external network through, for example, the connectivity 1321, the broadband modem 1333, or the like is buffered by the stream buffer 1414, and then demultiplexed by the demultiplexing unit (DMUX) 1413. In addition, the file data, which has been read from the various recording media by, for example, the connectivity 1321 or the like and inputted into the video processor 1332, is buffered by the stream buffer 1414, and then demultiplexed by the demultiplexing unit (DMUX) 1413. That is, the transport stream or the file data inputted into the video processor 1332 is separated into a video stream and an audio stream by the demultiplexing unit (DMUX) 1413.

The audio stream is supplied to the audio decoder 1411 through the audio ES buffer 1409B and decoded. Thus, an audio signal is reproduced. In addition, after the video stream is written onto the video ES buffer 1408B, the video stream is sequentially read and decoded by the encoding/decoding engine 1407 and then written onto the frame memory 1405. The decoded image data is subjected to enlargement/reduction processing by the second image enlarging/reducing unit 1403 and written onto the frame memory 1405. Then, the decoded image data is read by the video output processing unit 1404, converted into a format in a predetermined system such as the 4:2:2Y/Cb/Cr system, and then converted into an analog signal. Thus, a video signal is reproduced and outputted.

In a case where the present technology is applied to the video processor 1332 configured as described above, it is sufficient if the present technology according to each of the respective embodiments described above is applied to the encoding/decoding engine 1407. That is, the encoding/decoding engine 1407 may have the function of the quantizer 134, and may quantize a supplied image with use of the quantization parameter corresponding to the encoding difficulty level varying by the motion direction of the moving object in the image. Doing so makes it possible for the video processor 1332 to achieve effects similar to those of any of the respective embodiments described above.

It is to be noted that, in the encoding/decoding engine 1407, the present technology (that is, the functions of the image processing apparatus 100) may be implemented by hardware such as a logical circuit or by software such as an incorporated program, or may be implemented by both thereof.

### <Another Configuration Example of Video Processor>

FIG. 26 illustrates another example of the schematic configuration of the video processor 1332 to which the present technology is applied. In the case of the example in FIG. 26, the video processor 1332 has a function of encoding and decoding video data in a predetermined system.

More specifically, as illustrated in FIG. 26, the video processor 1332 includes a control unit 1511, a display interface 1512, a display engine 1513, an image processing engine 1514, and an internal memory 1515. In addition, the video processor 1332 includes a codec engine 1516, a memory interface 1517, a multiplexing/demultiplexing unit (MUX DMUX) 1518, a network interface 1519, and a video interface 1520.

The control unit 1511 controls operations of respective processing unit inside the video processor 1332, such as the display interface 1512, the display engine 1513, the image processing engine 1514, and the codec engine 1516.

As illustrated in FIG. 26, the control unit 1511 includes, for example, a main CPU 1531, a sub CPU 1532, and a system controller 1533. The main CPU 1531 executes a program and the like for controlling the operation of each of the processing units inside the video processor 1332. The main CPU 1531 generates a control signal in accordance with the program and the like and supplies the control signal to each of the processing units (that is, the main CPU 1531 controls the operation of each of the processing units). The sub CPU 1532 serves to assist the main CPU 1531. For example, the sub CPU 1532 executes a child process, a subroutine, and the like of the program and the like executed by the main CPU 1531. The system controller 1533 controls operations of the main CPU 1531 and the sub CPU 1532, such as specifying a program executed by the main CPU 1531 and the sub CPU 1532.

Under the control by the control unit 1511, the display interface 1512 outputs image data to, for example, the connectivity 1321 or the like. For example, the display interface 1512 converts image data, which is digital data, into an analog signal, and outputs the analog signal to a monitor device or the like of the connectivity 1321 as a reproduced video signal, or outputs the image data as it is, which is digital data, to the monitor device or the like of the connectivity 1321.

Under the control by the control unit 1511, the display engine 1513 performs various conversion processing such as format conversion, size conversion, and color gamut conversion on the image data to conform to the hardware specification of the monitor device or the like that displays that image.

Under the control by the control unit 1511, the image processing engine 1514 performs predetermined image processing on the image data such as, for example, filtering processing for improving image quality.

The internal memory 1515 is a memory provided inside the video processor 1332, which is shared among the display engine 1513, the image processing engine 1514, and the codec engine 1516. The internal memory 1515 is, for example, used to transmit and receive data among the display engine 1513, the image processing engine 1514, and the codec engine 1516. For example, the internal memory 1515 stores data supplied from the display engine 1513, the image processing engine 1514, or the codec engine 1516 and supplies the data to the display engine 1513, the image processing engine 1514, or the codec engine 1516 as necessary (for example, on a request basis). The internal memory 1515 may be implemented by any storage device. In general, the internal memory 1515 is often used to store a small amount of data such as image data in units of blocks and parameters. Accordingly, it is desirable to implement the internal memory 1515 by a semiconductor memory such as, for example, an SRAM (Static Random Access Memory), which has a relatively smaller capacity but achieves a higher response speed (in comparison with, for example, the external memory 1312).

The codec engine 1516 performs processing relating to encoding and decoding of image data. Any encoding/decoding system is supported by the codec engine 1516. The codec engine 1516 may support a single system or a plurality of systems. For example, the codec engine 1516 may have a codec function using a plurality of encoding/decoding systems and may encode image data or decode encoded data using a system selected from the plurality of encoding/decoding systems.

In the example illustrated in FIG. 26, the codec engine 1516 includes, for example, an MPEG-2 Video 1541, an AVC/H.264 1542, an HEVC/H.265 1543, an HEVC/H.265 (Scalable) 1544, an HEVC/H.265 (Multi-view) 1545, and an MPEG-DASH 1551 as functional blocks for codec-related processing.

The MPEG-2 Video 1541 is a functional block that encodes and decodes image data using an MPEG-2 system. The AVC/H.264 1542 is a functional block that encodes and decodes image data using an AVC system. The HEVC/H.265 1543 is a functional block that encodes and decodes image data using an HEVC system. The HEVC/H.265 (Scalable) 1544 is a functional block that performs scalable encoding and scalable decoding on image data using the HEVC system. The HEVC/H.265 (Multi-view) 1545 is a functional block that performs multi-view encoding and multi-view decoding on image data using the HEVC system.

The MPEG-DASH 1551 is a functional block that transmits and receives image data using an MPEG-DASH (MPEG-Dynamic Adaptive Streaming over HTTP) system. The MPEG-DASH is technology for video streaming using an HTTP (HyperText Transfer Protocol). One characteristic of the MPEG-DASH is that appropriate encoded data is selected and transmitted per segment unit among a plurality of encoded data having mutually different resolutions and the like, which are prepared in advance. The MPEG-DASH 1551 performs generation of a stream conforming to a standard, control of transmission of the stream, and the like. Blocks from the above-described MPEG-2 Video 1541 to HEVC/H.265 (Multi-view) 1545 are used to encode or decode image data.

The memory interface 1517 is an interface for the external memory 1312. Data supplied from the image processing engine 1514 or the codec engine 1516 is supplied to the external memory 1312 through the memory interface 1517. In addition, the data read from the external memory 1312 is supplied to the video processor 1332 (the image processing engine 1514 or the codec engine 1516) through the memory interface 1517.

The multiplexing/demultiplexing unit (MUX DMUX) 1518 multiplexes and demultiplexes various data relating to an image such as a bit stream, image data, and a video signal of encoded data. The multiplexing and the demultiplexing are performed by any method. For example, upon multiplexing, it is possible for the multiplexing/demultiplexing unit (MUX DMUX) 1518 not only to combine a plurality of pieces of data into one piece of data, but also to add predetermined header information and the like to that data. In addition, upon demultiplexing, it is possible for the multiplexing/demultiplexing unit (MUX DMUX) 1518 not only to divide one piece of data into a plurality of pieces of data, but also to add predetermined header information and the like to each of the divided pieces of data. That is, it is possible for the multiplexing/demultiplexing unit (MUX DMUX) 1518 to convert the format of the data by multiplexing and demultiplexing. For example, it is possible for the multiplexing/demultiplexing unit (MUX DMUX) 1518 to convert a bit stream into a transport stream, which is a bit stream in a transfer format, or into data (file data) in a recording file format by multiplexing of the bit stream. It is needless to say that inverse conversion thereof is possible by demultiplexing.

The network interface 1519 is an interface for, for example, the broadband modem 1333, the connectivity 1321, and the like. The video interface 1520 is an interface for, for example, the connectivity 1321, the camera 1322, and the like.

Next, description is given of an example of the operation of the video processor 1332 described as above. For example, in a case where a transport stream is received from the external network through the connectivity 1321, the broadband modem 1333, or the like, the transport stream is supplied to the multiplexing/demultiplexing unit (MUX DMUX) 1518 through the network interface 1519 and demultiplexed. Then, the transport stream is decoded by the codec engine 1516. For example, the image processing engine 1514 performs predetermined image processing on the image data obtained by decoding by the codec engine 1516. Then, the display engine 1513 performs predetermined conversion on the image data. The image data is then supplied to, for example, the connectivity 1321 or the like through the display interface 1512, and an image of the image data is displayed on the monitor. Further, for example, the image data obtained by decoding by the codec engine 1516 is re-encoded by the codec engine 1516 and multiplexed by the multiplexing/demultiplexing unit (MUX DMUX) 1518 to be converted into file data. The file data is outputted to, for example, the connectivity 1321 or the like through the video interface 1520, and recorded onto the various recording media.

Further, file data, which is encoded data including encoded image data, is read from an unillustrated recording medium by, for example, the connectivity 1321 or the like, and supplied to the multiplexing/demultiplexing unit (MUX DMUX) 1518 through the video interface 1520. The file data is then demultiplexed by the multiplexing/demultiplexing unit (MUX DMUX) 1518 and decoded by the codec engine 1516. The image processing engine 1514 performs predetermined image processing on the image data obtained by decoding by the codec engine 1516. Then, the display engine 1513 performs predetermined conversion on the image data. The image data is then supplied to, for example, the connectivity 1321 or the like through the display interface 1512, and an image of the image data is displayed on the monitor. In addition, for example, the image data obtained by decoding by the codec engine 1516 is re-encoded by the codec engine 1516 and multiplexed by the multiplexing/demultiplexing unit (MUX DMUX) 1518 to be converted into a transport stream. The transport stream is supplied to, for example, the connectivity 1321, the broadband modem 1333, or the like through the network interface 1519, and transmitted to another unillustrated apparatus.

It is noted that the processing units inside the video processor 1332 transmit and receive image data and other data to and from each other using, for example, the internal memory 1515 and the external memory 1312. In addition, the power management module 1313 controls power supply to, for example, the control unit 1511.

In a case where the present technology is applied to the video processor 1332 configured as described above, it is sufficient if the present technology according to each of the embodiments described above is applied to the codec engine 1516. That is, the codec engine 1516 may have the function of the quantizer 134, and may quantize a supplied image with use of the quantization parameter corresponding to the encoding difficulty level varying by the motion direction of the moving object in the image. Doing so makes it possible for the video processor 1332 to achieve effects similar to those of any of the respective embodiments described above.

It is noted that in the codec engine 1516, the present technology (i.e., the functions of the image processing apparatus 100) may be implemented by hardware such as a logical circuit or by software such as an incorporated program, or may be implemented by both thereof.

Hereinabove, the two examples have been described as the configuration of the video processor 1332. However, the video processor 1332 may have any configuration, and may have a configuration other than the above-described two examples. In addition, while the video processor 1332 may be configured as a single semiconductor chip, the video processor 1332 may be configured as a plurality of semiconductor chips. For example, the video processor 1332 may be a three-dimensional stacked LSI in which a plurality of semiconductors is stacked. In addition, the video processor 1332 may be implemented by a plurality of LSIs.

### <Application Examples to Apparatus>

It is possible to incorporate the video set 1300 into various apparatuses that process image data. For example, it is possible to incorporate the video set 1300 into the television apparatus 900 (FIG. 20), the mobile phone 920 (FIG. 21), the recording/reproducing apparatus 940 (FIG. 22), the imaging apparatus 960 (FIG. 23), and the like. Incorporating the video set 1300 into an apparatus makes it possible for the apparatus to achieve effects similar to those of each of the embodiments described above.

It is noted that as long as the video processor 1332 is included, it is possible to implement even a part of the configurations of the above-described video set 1300 as a configuration to which the present technology is applied. For example, it is possible to implement only the video processor 1332 as a video processor to which the present technology is applied. In addition, for example, it is possible to implement the processors indicated by the dotted line 1341, the video module 1311, and the like as processors, a module, and the like to which the present technology is applied, as described above. Further, for example, it is possible to implement a combination of the video module 1311, the external memory 1312, the power management module 1313, and the front end module 1314 as a video unit 1361 to which the present technology is applied. With any of the configurations, it is possible to achieve effects similar to those of each of the embodiments described above.

That is, as in the case of the video set 1300, it is possible to incorporate any configuration including the video processor 1332 into various apparatuses that process image data. For example, it is possible to incorporate the video processor 1332, the processors indicated by the dotted line 1341, the video module 1311, or the video unit 1361 into the television apparatus 900 (FIG. 20), the mobile phone 920 (FIG. 21), the recording/reproducing apparatus 940 (FIG. 22), the imaging apparatus 960 (FIG. 2), and the like. Incorporating any of the configurations to which the present technology is applied into an apparatus makes it possible for the apparatus to achieve effects similar to those of each of the respective embodiments described above, as in the case of the video set 1300.

### <Network System>

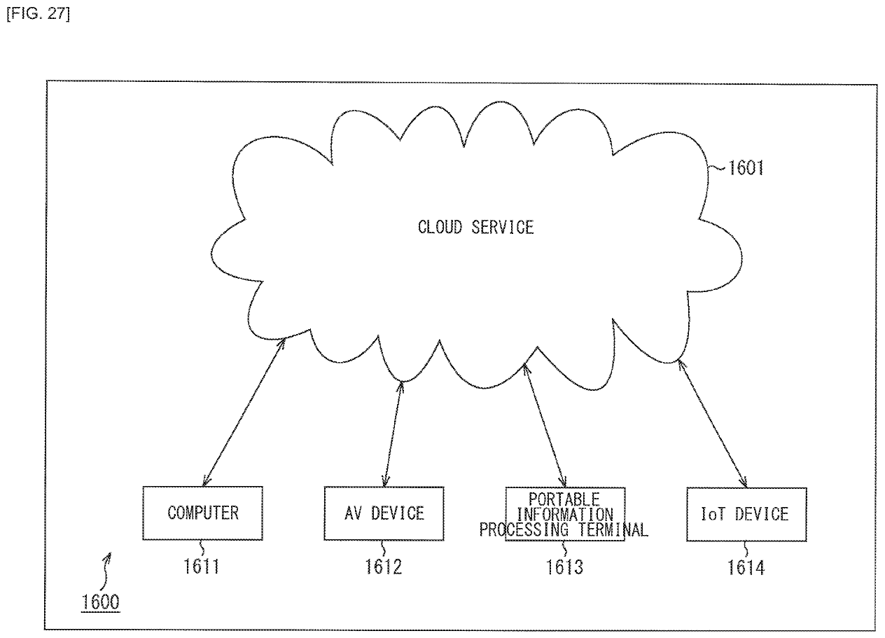

In addition, the present technology is also applicable to a network system including a plurality of apparatuses. FIG. 27 illustrates an example of a schematic configuration of a network system to which the present technology is applied.

A network system 1600 illustrated in FIG. 27 is a system in which devices transmit and receive information relating to images (moving images) to and from each other through a network. A cloud service 1601 in the network system 1600 is a system that provides a service relating to an image (a moving image) to terminals such as a computer 1611, an AV (Audio Visual) device 1612, a portable information processing terminal 1613, and an IoT (Internet of Things) device 1614, which are communicably coupled to the cloud service 1601 itself. For example, the cloud service 1601 provides an image (moving image) content supply service such as so-called moving image distribution (on-demand or live distribution) to the terminals. In addition, for example, the cloud service 1601 provides a backup service for receiving image (moving image) contents from the terminals and storing the image (moving image) contents. In addition, for example, the cloud service 1601 provides a service for mediating transmission and reception of an image (moving image) contents between the terminals.

The cloud service 1601 has any physical configuration. For example, the cloud service 1601 may include various servers and any network such as the Internet and LAN. The various servers include a server that stores and manages moving images, a server that distributes moving images to the terminals, a server that obtains moving images from the terminals, a server that manages users (the terminals) and billing, and the like.

The computer 1611 includes information processing apparatuses such as, for example, a personal computer, a server, and a workstation. The AV device 1612 includes image processing apparatuses such as, for example, a television receiver, a hard disk recorder, a game device, and a camera. The portable information processing terminal 1613 includes portable information processing apparatuses such as, for example, a notebook personal computer, a tablet terminal, a mobile phone, and a smartphone. The IoT device 1614 includes any objects that perform processing relating to an image such as, for example, a machine, a house appliance, furniture, other objects, an IC tag, and a card-type device. Each of these terminals has a communication function, enabling the terminal to couple to the cloud service 1601 (establish a session) and transmit and receive information (that is, perform communication) to and from the cloud service 1601. In addition, each of the terminals is also enabled to communicate with another terminal. Communication between the terminals may be performed through the cloud service 1601 or may be performed without the cloud service 1601.

In a case where the present technology is applied to the network system 1600 as described above and image (moving image) data is transmitted and received between the terminals or between the terminals and the cloud service 1601, the image data may be encoded as described above in each of the respective embodiments. That is, each of the terminals (from the computer 1611 to the IoT device 1614) and the cloud service 1601 may have the function of the quantizer 134 described above, and may quantize the supplied image with use of the quantization parameter corresponding to the encoding difficulty level varying by the motion direction of the moving object in the image. Doing so makes it possible for the terminals (from the computer 1611 to IoT devices 1614) and the cloud services 1601 that transmit and receive image data to achieve effects similar to those of each of the respective embodiments described above.

### 6. Others

### <Encoding/Decoding System>

Although the HEVC has been exemplified above, the present technology is applicable to any image encoding/decoding for moving images.

### <Fields of Application of Present Technology>

Systems, apparatuses, processing units, and the like to which the present technology is applied are usable in any fields such as, for example, traffic, medical care, crime prevention, agriculture, livestock industry, mining industry, beauty, factories, home appliances, weather, and natural surveillance

For example, the present technology is also applicable to systems and devices that transmit images provided for viewing. In addition, for example, the present technology is also applicable to systems and devices used for traffic. Further, for example, the present technology is also applicable to systems and devices used for security. In addition, for example, the present technology is also applicable to systems and devices used for sports. Further, for example, the present technology is also applicable to systems and devices used for agriculture. In addition, for example, the present technology is also applicable to systems and devices used for the livestock industry. Further, for example, the present technology is also applicable to systems and devices used for monitoring the state of nature such as volcanoes, forests, and oceans. In addition, for example, the present technology is also applicable to weather observation systems and weather observation apparatuses that observe weather, temperature, humidity, wind speed, daylight hours, and the like. Further, for example, the present technology is also applicable to systems, devices, and the like that observe the ecology of wildlife such as birds, fish, reptiles, amphibians, mammals, insects, and plants.

### <Application to Multi-View Image Encoding System>

The series of processing described above is applicable to a multi-view image encoding system that encodes multi-view images including images with a plurality of viewpoints (views). In this case, it is sufficient if the present technology is applied to encoding in each of the viewpoints (views).

### <Application to Hierarchical Image Encoding System>

In addition, the series of processing described above is applicable to a hierarchical image encoding (scalable encoding) system that encodes hierarchical images. The hierarchical images are multi-layered (hierarchized) to have a scalability function for a predetermined parameter. In this case, it is sufficient if the present technology is applied to encoding in each hierarchy (layer).

### <Computer>

It is possible to execute the series of processing described above by hardware or software. In a case where the series of processing is executed by software, a program included in the software is installed in a computer. The computer herein includes a computer that is incorporated in dedicated hardware, or, for example, a general-purpose personal computer that is able to execute various functions by having various programs installed therein, and the like.

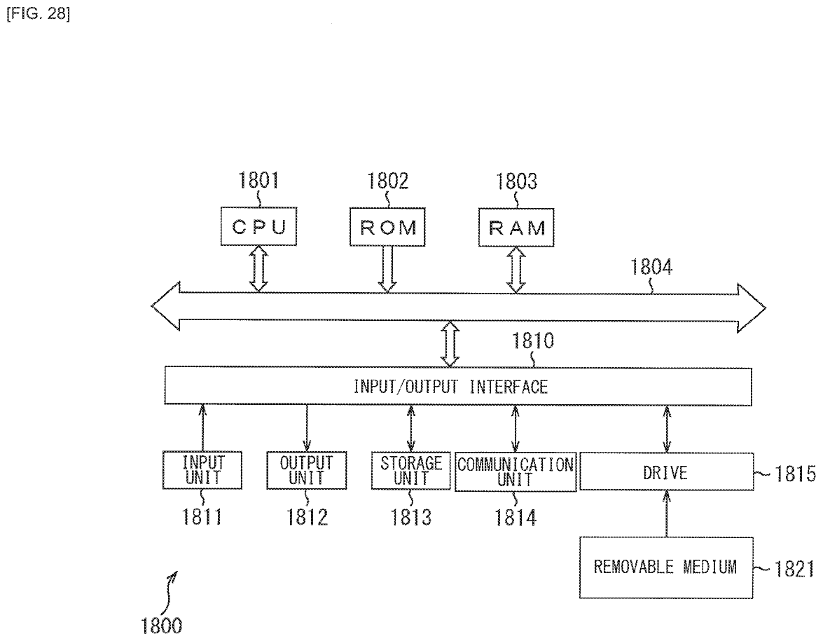

FIG. 28 is a block diagram illustrating a configuration example of hardware of a computer that executes the series of processing described above with a program.

In a computer 1800 illustrated in FIG. 28, a CPU (Central Processing Unit) 1801, a ROM (Read Only Memory) 1802, and a RAM (Random Access Memory) 1803 are coupled to each other by a bus 1804.

An input/output interface 1810 is further coupled to the bus 1804. An input unit 1811, an output unit 1812, a storage unit 1813, a communication unit 1814, and a drive 1815 are coupled to the input/output interface 1810.

The input unit 1811 includes, for example, a keyboard, a mouse, a microphone, a touch panel, an input terminal, and the like. The output unit 1812 includes, for example, a display, a speaker, an output terminal, and the like. The storage unit 1813 includes, for example, a hard disk, a RAM disk, a nonvolatile memory, and the like. The communication unit 1814 includes, for example, a network interface. The drive 1815 drives a removable medium 1821 such as a magnetic disk, an optical disk, a magneto-optical disk, or a semiconductor memory.

In the computer configured as described above, the CPU 1801 loads a program stored, for example, in the storage unit 1813 onto the RAM 1803 through the input/output interface 1810 and the bus 1804, and executes the program, thereby performing the series of processing described above. The RAM 1803 also stores data and the like that are necessary for the CPU 1801 to execute various kinds of processing as appropriate.

For example, it is possible to record a program to be executed by the computer (the CPU 1801) onto the removable medium 1821 as a package medium or the like and apply the program. In this case, mounting the removable medium 1821 onto the drive 1815 makes it possible to install the program in the storage unit 1813 through the input/output interface 180.

In addition, it is possible to provide this program through a wired or wireless transmission medium such as a local area network, the Internet, or digital satellite broadcasting. In this case, it is possible to receive the program in the communication unit 1814 and install the program in the storage unit 1813.

In addition, this program may be installed in advance in the ROM 1802 or the storage unit 1813.

### <Others>

It is noted that various types of information relating to encoded data (bit stream) may be multiplexed in the encoded data and then transmitted or recorded, or may be transmitted or recorded as separate data associated with the encoded data without being multiplexed in the encoded data. The term “associate” here means, for example, that in a case where one piece of data is processed, another piece of data is made usable (made linkable). That is, pieces of data associated with each other may be brought together as one piece of data, or may be individual pieces of data. For example, the information associated with the encoded data (an image) may be transmitted through a transmission path other than a transmission path of the encoded data (the image). In addition, for example, the information associated with the encoded data (the image) may be recorded on a recording medium different from a recording medium on which the encoded data (the image) is recorded (or in a different recording region of the same recording medium). It is to be noted that the “association” may be performed on a portion of data instead of the entirety of the data. For example, data may be associated with each other in any unit such as a plurality of frames, one frame, or a portion in a frame.

In addition, as described above, in the present specification, the terms such as “synthesize,” “multiplex,” “add,” “integrate,” “include,” “store,” “install,” “embed,” and “insert” mean that a plurality of objects is combined into one; for example, encoded data and metadata are combined into one piece of data. These terms mean one of methods for the above-described “association.”

In addition, embodiments of the present technology are not limited to the embodiments described above, and may be modified in variety of ways in a scope without departing from the gist of the present technology.

For example, a “system” in this specification means a group of a plurality of components (such as apparatuses and modules (parts)) regardless of whether or not all of the components are in the same housing. Accordingly, a plurality of apparatuses that are accommodated in separate housings and coupled to each other through a network, and a single apparatus including a plurality of modules accommodated in one housing are both regarded as the system.

In addition, for example, a configuration described as a single apparatus (or a processing unit) may be divided and configured as a plurality of apparatuses (or processing units). On the contrary, configurations described above as a plurality of apparatuses (or processing units) may be integrated and configured as a single apparatus (or processing unit). In addition, it is needless to say that a configuration other than those described above may be added to the configuration of each apparatus (or each processing unit). Further, as long as the configuration and an operation of the entire system are substantially the same, a portion of the configuration of a certain apparatus (or processing unit) may be included in the configuration of another apparatus (or another processing unit).

In addition, for example, it is possible for the present technology to adopt a configuration of cloud computing in which one function is distributed to a plurality of apparatuses through a network and processed in cooperation.

Further, for example, it is possible to execute the program described above in any apparatus. In this case, it is sufficient if the apparatus have a necessary function (a functional block or the like) and is able to obtain necessary information.

In addition, for example, it is possible to execute the respective steps described in the flow charts described above with one apparatus, and it is also possible to distribute the respective steps to a plurality of apparatuses for execution. Further, in a case where a plurality of processing is included in one step, it is possible to execute the plurality of processing included in the one step with one apparatus, and it is also possible to distribute the plurality of processing to a plurality of apparatuses for execution.

It is to be noted that, in a program executed by a computer, processing of steps describing the program may be executed chronologically in the order described herein or may be executed in parallel or individually at necessary timings such as when the processing is invoked. Further, the processing of the steps describing this program may be executed in parallel with processing of another program, or may be executed in combination with processing of another program.

It is to be noted that each of a plurality of present technologies described herein may be implemented as a single technology independently as long as no contradiction arises. Needless to say, any number of the present technologies may be implemented in combination. For example, the present technology described in any of the embodiments may be implemented in combination with the present technology described in another embodiment. In addition, any of the technologies described above may be implemented in combination with another technology not described above.

It is to be noted that the present technology may also be configured as below.

(1)

An image processing apparatus including:

a quantizer that quantizes an encoding target image, and quantizes an image of a moving object included in the encoding target image with use of a quantization parameter corresponding to an encoding difficulty level varying by a motion direction of the moving object in the encoding target image; and

an encoding unit that encodes the encoding target image quantized by the quantizer to generate a bit stream.

(2)

The image processing apparatus according to (1), in which the quantizer quantizes the image of the moving object that moves in a direction in which the encoding difficulty level is high with use of a quantization parameter smaller than a quantization parameter in a case where the moving object moves in another direction.

(3)

The image processing apparatus according to (2), in which the direction in which the direction in which the encoding difficulty level is high is a direction from back to front of an image.

(4)

The image processing apparatus according to any one of (1) to (3), further including a quantization parameter setting unit that sets the quantization parameter corresponding to the encoding difficulty level varying by the motion direction of the moving object, in which

the quantizer quantizes the image of the moving object with use of the quantization parameter set by the quantization parameter setting unit.

(5)

The image processing apparatus according to (4), in which, in a case where the motion direction of the moving object is in a direction in which the encoding difficulty level is high, the quantization parameter setting unit decreases the quantization parameter to a smaller value than in a case where the moving object moves in another direction.

(6)

The image processing apparatus according to (4) or (5), in which, in a case where the motion direction of the moving object is in a direction in which the encoding difficulty level is low, the quantization parameter setting unit increases the quantization parameter to a larger value than in a case where the moving object moves in another direction.

(7)

The image processing apparatus according to any one of (4) to (6), in which the quantization parameter setting unit increases an adjustment amount of the quantization parameter with an increase in magnitude of motion of the moving object.

(8)

The image processing apparatus according to (4) to (7), in which the quantization parameter setting unit sets the quantization parameter on the basis of the motion direction of the moving object specified on the basis of a direction of a motion vector of the image of the moving object in the encoding target image.

(9)

The image processing apparatus according to (8), in which the quantization parameter setting unit decreases the quantization parameter in a case where the direction of the motion vector of the image of the moving object is a predetermined direction corresponding to the motion direction of the moving object that moves in a direction in which the encoding difficulty level is high.

(10)

The image processing apparatus according to (8) or (9), in which the quantization parameter setting unit increases the quantization parameter in a case where the direction of the motion vector of the image of the moving object is a predetermined direction corresponding to the motion direction of the moving object that moves in a direction in which the encoding difficulty level is low.

(11)

The image processing apparatus according to any one of (8) to (10), further including a motion detector that detects motion of the moving object in the encoding target image and calculates the motion vector of the image of the moving object, in which

the quantization parameter setting unit is configured to set the quantization parameter on the basis of the motion direction of the moving object specified on the basis of the direction of the motion vector of the image of the moving object calculated by the motion detector.

(12)

The image processing apparatus according to any one of (4) to (11), in which the quantization parameter setting unit sets the quantization parameter on the basis of moving object motion direction information, the moving object motion direction information including information relating to the motion direction of the moving object in the encoding target image.

(13)

The image processing apparatus according to (12), further including a moving object motion direction detector that detects the motion direction of the moving object to generate the moving object motion direction information, in which

the quantization parameter setting unit is configured to set the quantization parameter on the basis of the moving object motion direction information generated by the moving object motion direction detector.

(14)

The image processing apparatus according to (13), in which the moving object motion direction detector detects an image of a face of a person included in the encoding target image, and detects the motion direction of the moving object on the basis of orientation of the detected face.

(15)

The image processing apparatus according to (13) or (14), in which the moving object motion direction detector detects the motion direction of the moving object by tracking the moving object in the encoding target image.

(16)

The image processing apparatus according to any one of (13) to (15), in which the moving object motion direction detector detects the motion direction of the moving object with use of a plurality of images.

(17)

The image processing apparatus according to any one of (13) to (16), in which the moving object motion direction detector detects the motion direction of the moving object with use of the encoding target image and sensor information for specifying a depth position of the moving object.

(18)

The image processing apparatus according to any one of (4) to (17), further including an adjustment determining unit that determines whether or not to set the quantization parameter, in which

in a case where the adjustment determining unit determines to set the quantization parameter, the quantization parameter setting unit sets the quantization parameter in accordance with the encoding difficulty level varying by the motion direction of the moving object.

(19)

The image processing apparatus according to (18), in which, in a case where the encoding target image includes a moving object that moves in a direction in which the encoding difficulty level is high and a moving object that moves in another direction, the adjustment determining unit determines to set the quantization parameter.

(20)

An image processing method that is performed by an image processing apparatus, the method including:

quantizing an encoding target image, and quantizing an image of a moving object included in the encoding target image with use of a quantization parameter corresponding to an encoding difficulty level varying by a motion direction of the moving object in the encoding target image; and

encoding the quantized encoding target image to generate a bit stream.

### REFERENCE SIGNS LIST

100: image processing apparatus
111: imaging unit
112: image encoding unit
131: screen sorting buffer
132: operating unit
133: orthogonal transformer
134: quantizer
135: encoding unit
136: storage buffer
137: inverse quantizer
138: inverse orthogonal transformer
139: operating unit
140: filter
141: frame memory
142: intra-predicting unit
143: inter-predicting unit
144: predicted image selecting unit
145: quantization parameter adjuster
146: encoding controller
151: adjustment determining unit
152: quantization parameter setting unit
161: motion predicting unit
162: motion compensating unit
200: image processing apparatus
211: moving object motion direction detector
212: image encoding unit
221: image analyzer
222: motion direction determining unit
231: face detector
232: moving object detector-tracker
241: quantization parameter adjuster
251: adjustment determining unit
252: quantization parameter setting unit
300: image processing apparatus
311: moving object motion direction detector
320: image processing apparatus
321: sensor unit
322: moving object motion direction detector

1. An image processing apparatus comprising:
a quantizer that quantizes an encoding target image, and quantizes an image of a moving object included in the encoding target image with use of a quantization parameter corresponding to an encoding difficulty level varying by a motion direction of the moving object in the encoding target image; and
an encoding unit that encodes the encoding target image quantized by the quantizer to generate a bit stream.

2. The image processing apparatus according to claim 1, wherein the quantizer quantizes the image of the moving object that moves in a direction in which the encoding difficulty level is high with use of a quantization parameter smaller than a quantization parameter in a case where the moving object moves in another direction.

3. The image processing apparatus according to claim 2, wherein the direction in which the encoding difficulty level is high is a direction from back to front of an image.

4. The image processing apparatus according to claim 1, further comprising a quantization parameter setting unit that sets the quantization parameter corresponding to the encoding difficulty level varying by the motion direction of the moving object, wherein
the quantizer quantizes the image of the moving object with use of the quantization parameter set by the quantization parameter setting unit.

5. The image processing apparatus according to claim 4, wherein, in a case where the motion direction of the moving object is in a direction in which the encoding difficulty level is high, the quantization parameter setting unit decreases the quantization parameter to a smaller value than in a case where the moving object moves in another direction.

6. The image processing apparatus according to claim 4, wherein, in a case where the motion direction of the moving object is in a direction in which the encoding difficulty level is low, the quantization parameter setting unit increases the quantization parameter to a larger value than in a case where the moving object moves in another direction.

7. The image processing apparatus according to claim 4, wherein the quantization parameter setting unit increases an adjustment amount of the quantization parameter with an increase in magnitude of motion of the moving object.

8. The image processing apparatus according to claim 4, wherein the quantization parameter setting unit sets the quantization parameter on a basis of the motion direction of the moving object specified on a basis of a direction of a motion vector of the image of the moving object in the encoding target image.

9. The image processing apparatus according to claim 8, wherein the quantization parameter setting unit decreases the quantization parameter in a case where the direction of the motion vector of the image of the moving object is a predetermined direction corresponding to the motion direction of the moving object that moves in a direction in which the encoding difficulty level is high.

10. The image processing apparatus according to claim 8, wherein the quantization parameter setting unit increases the quantization parameter in a case where the direction of the motion vector of the image of the moving object is a predetermined direction corresponding to the motion direction of the moving object that moves in a direction in which the encoding difficulty level is low.

11. The image processing apparatus according to claim 8, further comprising a motion detector that detects motion of the moving object in the encoding target image and calculates the motion vector of the image of the moving object, wherein
the quantization parameter setting unit is configured to set the quantization parameter on a basis of the motion direction of the moving object specified on a basis of the direction of the motion vector of the image of the moving object calculated by the motion detector.

12. The image processing apparatus according to claim 4, wherein the quantization parameter setting unit sets the quantization parameter on a basis of moving object motion direction information, the moving object motion direction information comprising information relating to the motion direction of the moving object in the encoding target image.

13. The image processing apparatus according to claim 12, further comprising a moving object motion direction detector that detects the motion direction of the moving object to generate the moving object motion direction information, wherein
the quantization parameter setting unit is configured to set the quantization parameter on a basis of the moving object motion direction information generated by the moving object motion direction detector.

14. The image processing apparatus according to claim 13, wherein the moving object motion direction detector detects an image of a face of a person included in the encoding target image, and detects the motion direction of the moving object on a basis of orientation of the detected face.

15. The image processing apparatus according to claim 13, wherein the moving object motion direction detector detects the motion direction of the moving object by tracking the moving object in the encoding target image.

16. The image processing apparatus according to claim 13, wherein the moving object motion direction detector detects the motion direction of the moving object with use of a plurality of images.

17. The image processing apparatus according to claim 13, wherein the moving object motion direction detector detects the motion direction of the moving object with use of the encoding target image and sensor information for specifying a depth position of the moving object.

18. The image processing apparatus according to claim 4, further comprising an adjustment determining unit that determines whether or not to set the quantization parameter, wherein
in a case where the adjustment determining unit determines to set the quantization parameter, the quantization parameter setting unit sets the quantization parameter in accordance with the encoding difficulty level varying by the motion direction of the moving object.

19. The image processing apparatus according to claim 18, wherein, in a case where the encoding target image includes a moving object that moves in a direction in which the encoding difficulty level is high and a moving object that moves in another direction, the adjustment determining unit determines to set the quantization parameter.

20. An image processing method that is performed by an image processing apparatus, the method comprising:
quantizing an encoding target image, and quantizing an image of a moving object included in the encoding target image with use of a quantization parameter corresponding to an encoding difficulty level varying by a motion direction of the moving object in the encoding target image; and
encoding the quantized encoding target image to generate a bit stream.
